(19) United States
(12) Patent Application Publication
(10) Pub. No.: US 2025/0383096 A1
(43) Pub. Date: Dec. 18, 2025

(54) GRILL CARTS INCLUDING MODULAR BASE ASSEMBLIES

(71) Applicant: Weber-Stephen Products LLC, Palatine, IL (US)

(72) Inventors: Mark S. Latocha, Algonquin, IL (US); Timothy M. Bentz, Bartlett, IL (US); David A. Larson, Ingleside, IL (US); Karol Polaczek, JR., Hickory Hills, IL (US); Eric Bedard, St. Charles, IL (US); Brian C. Donnelly, Naperville, IL (US)

(21) Appl. No.: 19/032,563

(22) Filed: Jan. 21, 2025

Related U.S. Application Data
(60) Provisional application No. 63/659,743, filed on Jun. 13, 2024.

(51) Int. Cl. F24C 15/08; A47J 37/07; B60B 33/00

(52) U.S. Cl. CPC F24C 15/08; A47J 37/0786; B60B 33/0078; B60B 33/0002

(57) ABSTRACT

Grill carts including modular base assemblies are disclosed. An example base assembly for a cart of a grill includes a base and a base attachment. The base includes a groove. The base attachment is removably couplable to the base. The base attachment includes a tongue configured to be located within the groove of the base when the base attachment is coupled to the base.

### RELATED APPLICATIONS

This application claims priority to U.S. Provisional Patent Application No. 63/659,743, filed Jun. 13, 2024. The entirety of U.S. Provisional Patent Application No. 63/659,743 is hereby incorporated by reference herein.

### FIELD OF THE DISCLOSURE

This disclosure relates generally to grill carts and, more specifically, to grill carts including modular base assemblies.

### BACKGROUND

Grills (e.g., gas grills, electric grills, charcoal grills, pellet grills, etc.) often include a cart configured to support a cookbox of the grill above an underlying ground surface. The cart typically includes a base having a plurality of attachments coupled thereto (e.g., extending downward from the base), with such attachments being configured to engage the underlying ground surface. Some known grill carts include one or more caster(s) (e.g., one or more locking and/or non-locking caster(s)) coupled to the base of the grill cart. Other known grill carts include one or more all-terrain wheel(s) coupled to the base of the grill cart. Other known grill carts include one or more support foot/feet coupled to the base of the grill cart.

### BRIEF DESCRIPTION OF THE DRAWINGS

FIG. 1 is a first perspective view of an example base constructed in accordance with the teachings of this disclosure, and configured for use with and/or installation on a cart of a grill.

FIG. 2 is a second perspective view of the base of FIG. 1.

FIG. 3 is a top view of the base of FIGS. 1 and 2.

FIG. 4 is a bottom view of the base of FIGS. 1-3.

FIG. 5 is a front view of the base of FIGS. 1-4.

FIG. 6 is a rear view of the base of FIGS. 1-5.

FIG. 7 is a right side view of the base of FIGS. 1-6.

FIG. 8 is a left side view of the base of FIGS. 1-7.

FIG. 9 is a cross-sectional view of the base of FIGS. 1-8, taken along section A-A of FIG. 3.

FIG. 10 is a cross-sectional view of the base of FIGS. 1-9, taken along section B-B of FIG. 3.

FIG. 11 is a first perspective view of an example base attachment configured for use with and/or installation on the base of FIGS. 1-10.

FIG. 12 is a second perspective view of the base attachment of FIG. 11.

FIG. 13 is a top view of the base attachment of FIGS. 11 and 12.

FIG. 14 is a bottom view of the base attachment of FIGS. 11-13.

FIG. 15 is a first perspective view of an example first caster assembly including the base attachment of FIGS. 11-14, and configured for use with and/or installation on the base of FIGS. 1-10.

FIG. 16 is a second perspective view of the first caster assembly of FIG. 15.

FIG. 17 is a first perspective view of an example second caster assembly including the base attachment of FIGS. 11-14, and configured for use with and/or installation on the base of FIGS. 1-10.

FIG. 18 is a second perspective view of the second caster assembly of FIG. 17.

FIG. 19 is a first perspective view of an example support foot including an example base attachment configured for use with and/or installation on the base of FIGS. 1-10.

FIG. 20 is a second perspective view of the support foot of FIG. 19.

FIG. 21 is a top view of the support foot of FIGS. 19 and 20.

FIG. 22 is a bottom view of the support foot of FIGS. 19-21.

FIG. 23 is a first perspective view of an example first axle mount of a wheel assembly configured for use with and/or installation on the base of FIGS. 1-10.

FIG. 24 is a second perspective view of the first axle mount of FIG. 23.

FIG. 25 is a top view of the first axle mount of FIGS. 23 and 24.

FIG. 26 is a bottom view of the first axle mount of FIGS. 23-25.

FIG. 27 is a first perspective view of an example second axle mount of a wheel assembly configured for use with and/or installation on the base of FIGS. 1-10.

FIG. 28 is a second perspective view of the second axle mount of FIG. 27.

FIG. 29 is a top view of the second axle mount of FIGS. 27 and 28.

FIG. 30 is a bottom view of the second axle mount of FIGS. 27-29.

FIG. 31 is an exploded view of an example wheel assembly including the first axle mount of FIGS. 23-26 and the second axle mount of FIGS. 27-30, and configured for use with an/or installation on the base of FIGS. 1-10.

FIG. 32 is a perspective view of the wheel assembly of FIG. 31, with the wheel assembly shown in an assembled state.

FIG. 33 is a top view of the wheel assembly of FIG. 32.

FIG. 34 is a bottom view of the wheel assembly of FIGS. 32 and 33.

FIG. 35 provides top views of the base attachment of FIGS. 11-14, the support foot of FIGS. 19-22, the first axle mount of FIGS. 23-26, and the second axle mount of FIGS. 27-30.

FIG. 36 is a first perspective view of an example first base assembly.

FIG. 37 is a second perspective view of the first base assembly of FIG. 36.

FIG. 38 is a bottom view of the first base assembly of FIGS. 36 and 37.

FIG. 39 is a cross-sectional view of the first base assembly of FIGS. 36-38, taken along section C-C of FIG. 38.

FIG. 40 is a cross-sectional view of the first base assembly of FIGS. 36-39, taken along section D-D of FIG. 38.

FIG. 41 is a cross-sectional view of the first base assembly of FIGS. 36-40, taken along section E-E of FIG. 38.

FIG. 42 is a cross-sectional view of the first base assembly of FIGS. 36-41, taken along section F-F of FIG. 38.

FIG. 43 is a perspective view of an example cart including the first base assembly of FIGS. 36-42.

FIG. 44 is a perspective view of an example grill including the cart of FIG. 43.

FIG. 45 is a first perspective view of an example second base assembly.

FIG. 46 is a second perspective view of the second base assembly of FIG. 45.

FIG. 47 is a bottom view of the second base assembly of FIGS. 45 and 46.

FIG. 48 is a cross-sectional view of the second base assembly of FIGS. 45-47, taken along section G-G of FIG. 47.

FIG. 49 is a cross-sectional view of the second base assembly of FIGS. 45-48, taken along section H-H of FIG. 47.

FIG. 50 is a cross-sectional view of the second base assembly of FIGS. 45-49, taken along section I-I of FIG. 47.

FIG. 51 is a cross-sectional view of the second base assembly of FIGS. 45-50, taken along section J-J of FIG. 47.

FIG. 52 is a perspective view of an example cart including the second base assembly of FIGS. 45-51.

FIG. 53 is a perspective view of an example grill including the cart of FIG. 52.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for case of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Example grill carts disclosed herein include modular base assemblies. In some disclosed examples, a base assembly for a cart of a grill comprises a base and a base attachment. The base includes a groove. The base attachment is removably couplable to the base. The base attachment includes a tongue configured to be located within the groove of the base when the base attachment is coupled to the base.

In some disclosed examples, the groove extends through an upper surface of the base. The groove includes a depressed upper surface that is lowered relative to the upper surface of the base. The tongue includes a lower surface configured to be supported by the depressed upper surface of the groove when the base attachment is coupled to the base. In some disclosed examples, the base attachment has an octagonal shape defined by eight faces of the base attachment. The tongue projects outwardly from at least one of the eight faces of the base attachment. In some disclosed examples, the base attachment further includes a lip. The lip projects outwardly from at least one of the eight faces of the base attachment. The lip includes an upper surface configured to face toward and/or abut a lower rim of a peripheral edge of the base when the base attachment is coupled to the base.

In some disclosed examples, the groove is associated with a corner of the base. The groove is spaced inwardly from a peripheral edge of the corner. The corner includes a first peripheral opening and a second peripheral opening extending through the peripheral edge of the corner. The base attachment includes a first peripheral opening and a second peripheral opening formed in corresponding ones of a first face and a second face of the base attachment. The second face is perpendicular to the first face. In some disclosed examples, the base assembly further includes a first fastener and a second fastener. The first fastener is configured to be inserted through the first peripheral opening of the corner and into the first peripheral opening of the base attachment. The second fastener is configured to be inserted through the second peripheral opening of the corner and into the second peripheral opening of the base attachment.

In some disclosed examples, the base attachment is part of a caster assembly that includes a caster. In some disclosed examples, the base attachment is part of a wheel assembly that includes an all-terrain wheel. In some disclosed examples, the base attachment is part of a support foot.

In some disclosed examples, a base assembly for a cart of a grill comprises a base, a first base attachment, and a second base attachment. The base includes a groove. The first base attachment is removably couplable to the base. The first base attachment includes a first tongue configured to be located within the groove of the base when the first base attachment is coupled to the base. The second base attachment is removably couplable to the base. The second base attachment includes a second tongue configured to be located within the groove of the base when the second base attachment is coupled to the base. The first base attachment and the second base attachment are interchangeably removably couplable to the base.

In some disclosed examples, the groove extends through an upper surface of the base. The groove includes a depressed upper surface that is lowered relative to the upper surface of the base. The first tongue includes a first lower surface configured to be supported by the depressed upper surface of the groove when the first base attachment is coupled to the base. The second tongue includes a second lower surface configured to be supported by the depressed upper surface of the groove when the second base attachment is coupled to the base. In some disclosed examples, the first base attachment has a first octagonal shape defined by eight faces of the first base attachment. The first tongue projects outwardly from at least one of the eight faces of the first base attachment. The second base attachment has a second octagonal shape defined by eight faces of the second base attachment. The second tongue projects outwardly from at least one of the eight faces of the second base attachment. The second octagonal shape is substantially identical to the first octagonal shape. In some disclosed examples, the first base attachment further includes a first lip. The first lip projects outwardly from at least one of the eight faces of the first base attachment. The first lip includes an upper surface configured to face toward and/or abut a lower rim of a peripheral edge of the base when the first base attachment is coupled to the base. The second base attachment further includes a second lip. The second lip projects outwardly from at least one of the eight faces of the second base attachment. The second lip includes an upper surface configured to face toward and/or abut the lower rim of the peripheral edge of the base when the second base attachment is coupled to the base.

In some disclosed examples, the first base attachment is part of a first caster assembly that includes a non-locking caster, and the second base attachment is part of a second caster assembly that includes a locking caster. The locking caster includes a brake configured to lock a wheel of the locking caster. In some disclosed examples, the first base attachment is part of a wheel assembly that includes an all-terrain wheel, and the second base attachment is part of a support foot. In some disclosed examples, the first base attachment is part of a caster assembly, and the second base attachment is part of a support foot. In some disclosed examples, the first base attachment is part of a caster assembly, and the second base attachment is part of a wheel assembly that includes an all-terrain wheel.

In some disclosed examples, a base assembly for a cart of a grill comprises a base, a first base attachment, and a second base attachment. The base includes a first groove and a second groove. The second groove is spaced apart from the first groove. The first base attachment is removably couplable to the base. The first base attachment includes a first tongue configured to be interchangeably located within either the first groove or the second groove of the base when the first base attachment is coupled to the base. The second base attachment is removably couplable to the base. The second base attachment includes a second tongue configured to be interchangeably located within either the first groove or the second groove of the base when the second base attachment is coupled to the base. In some disclosed examples, the first base attachment and the second base attachment are interchangeably removably couplable to the base such that (a) the first tongue of the first base attachment is located within the first groove of the base and the second tongue of the second base attachment is located within the second groove of the base when the first base attachment and the second base attachment are both coupled to the base in a first configuration, and (b) the first tongue of the first base attachment is located within the second groove of the base and the second tongue of the second base attachment is located within the first groove of the base when the first base attachment and the second base attachment are both coupled to the base in a second configuration.

In some disclosed examples, the first groove and the second groove each extend through an upper surface of the base. The first groove and the second groove each include a depressed upper surface that is lowered relative to the upper surface of the base. The first tongue includes a first lower surface configured to be supported by the depressed upper surface of the first groove when the first base attachment is coupled to the base in the first configuration, and to be supported by the depressed upper surface of the second groove when the first base attachment is coupled to the base in the second configuration. The second tongue includes a second lower surface configured to be supported by the depressed upper surface of the second groove when the second base attachment is coupled to the base in the first configuration, and to be supported by the depressed upper surface of the first groove when the second base attachment is coupled to the base in the second configuration. In some disclosed examples, the first base attachment has a first octagonal shape defined by eight faces of the first base attachment. The first tongue projects outwardly from at least one of the eight faces of the first base attachment. The second base attachment has a second octagonal shape defined by eight faces of the second base attachment. The second tongue projects outwardly from at least one of the eight faces of the second base attachment. The second octagonal shape is substantially identical to the first octagonal shape. In some disclosed examples, the first base attachment further includes a first lip. The first lip projects outwardly from at least one of the eight faces of the first base attachment. The first lip includes an upper surface configured to face toward and/or abut a lower rim of a peripheral edge of the base when the first base attachment is coupled to the base. The second base attachment further includes a second lip. The second lip projects outwardly from at least one of the eight faces of the second base attachment. The second lip includes an upper surface configured to face toward and/or abut the lower rim of the peripheral edge of the base when the second base attachment is coupled to the base.

In some disclosed examples, the first base attachment is part of a first caster assembly that includes a non-locking caster, and the second base attachment is part of a second caster assembly that includes a locking caster. The locking caster includes a brake configured to lock a wheel of the locking caster. In some disclosed examples, the first base attachment is part of a wheel assembly that includes an all-terrain wheel, and the second base attachment is part of a support foot.

In some disclosed examples, one or more modular base assemblies including a base and different numbers and/or different combinations of a first caster assembly, a second caster assembly (e.g., different from the first caster assembly), a support foot, and/or a wheel assembly (e.g., including one or more all-terrain wheel(s)) can be formed, as further described herein. The modular and/or interchangeable nature of the aforementioned components advantageously provides a user with the ability to customize the base assembly of a cart of a grill to suit the intended use case for the grill (e.g., a cart placed on smooth pavement, a cart placed on rough and/or uneven terrain, etc.) and/or the desires of the user in relation thereto. For example, the user may desire for the cart of the grill to include a base assembly having: (a) one or more non-locking caster(s); (b) one or more locking caster(s); (c) one or more support foot/feet; and/or (d) one or more all-terrain wheel assembly/assemblies coupled to a base of the base assembly, and arranged in any configuration relative thereto.

The above-identified features as well as other advantageous features of example grill carts including modular base assemblies are further described below in connection with the figures of the application.

As used herein, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

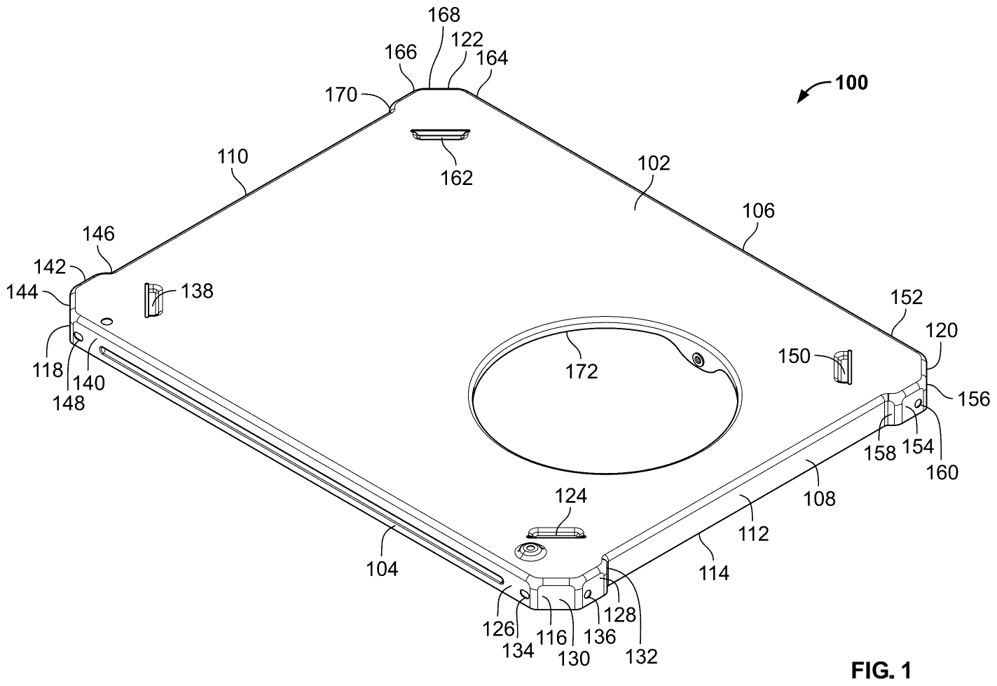

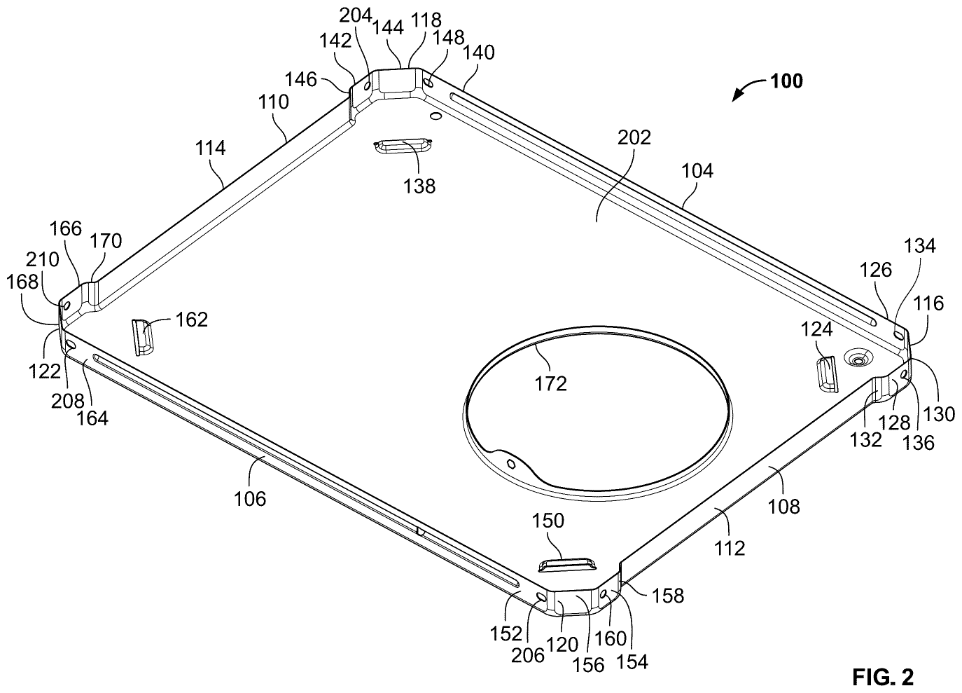

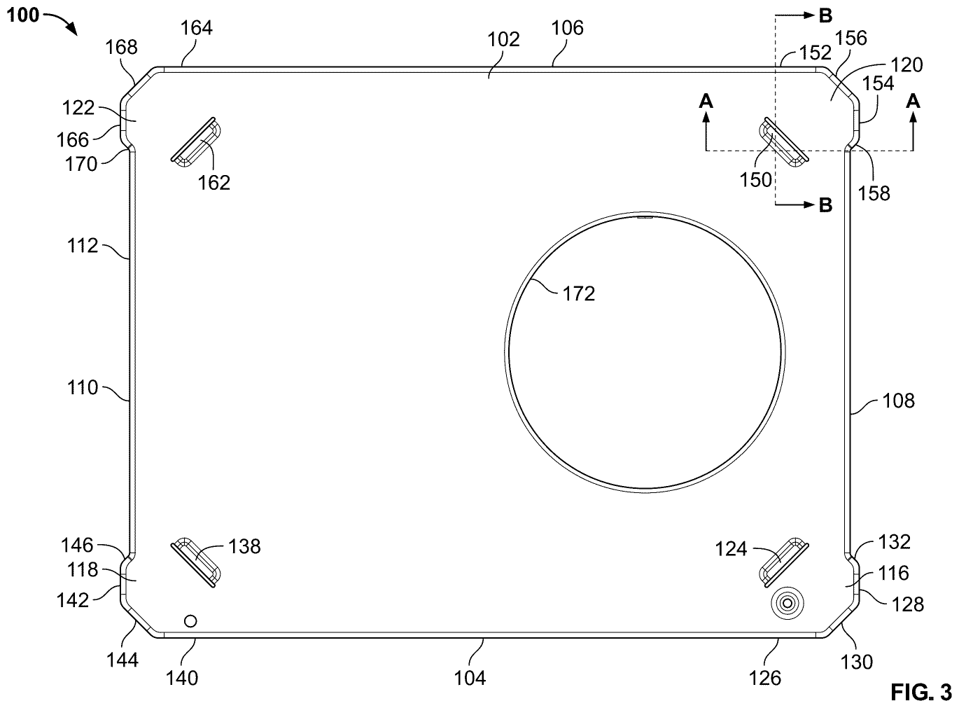

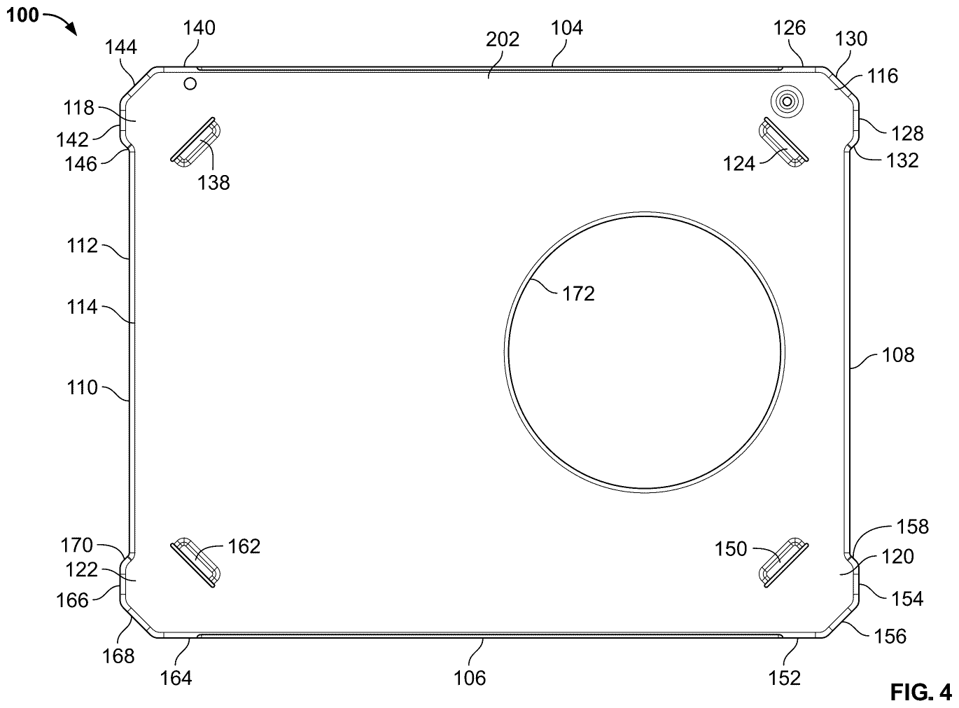

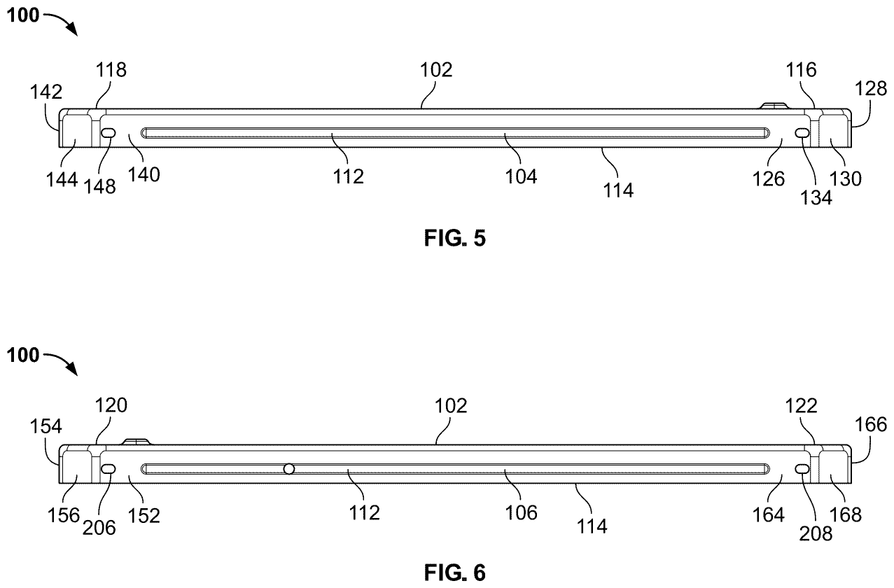

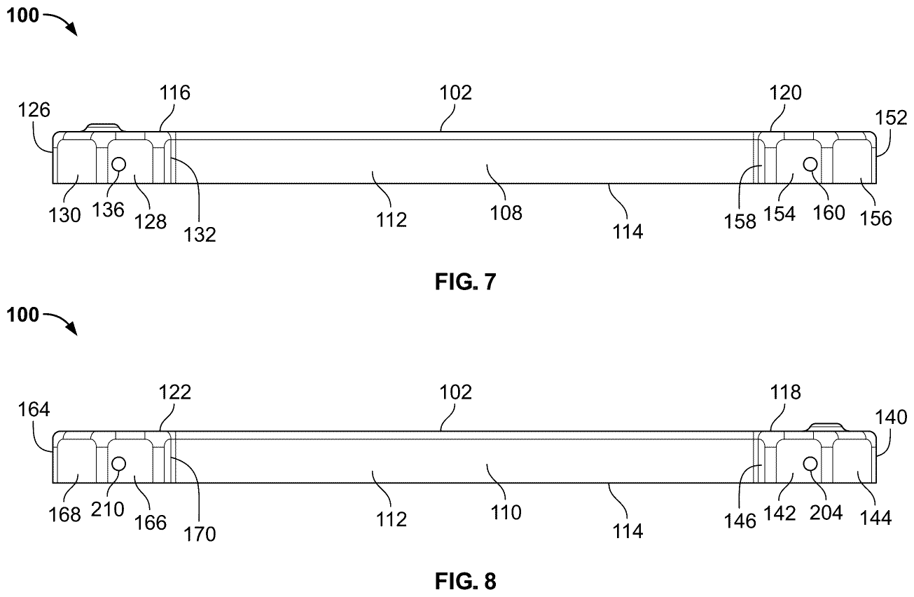

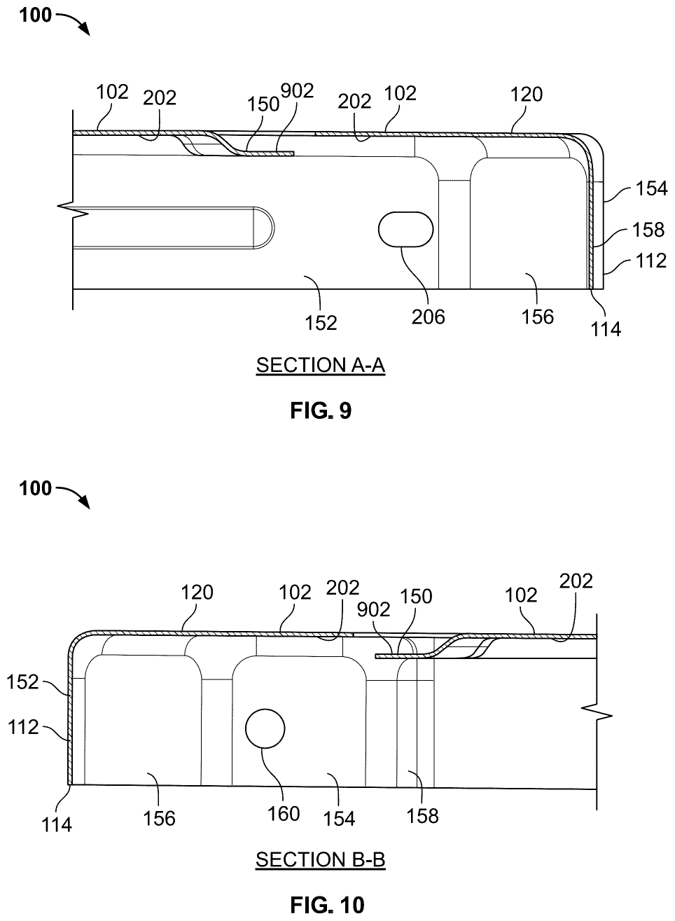

FIG. 1 is a first perspective view of an example base 100 constructed in accordance with the teachings of this disclosure, and configured for use with and/or installation on a cart of a grill. FIG. 2 is a second perspective view of the base 100 of FIG. 1. FIG. 3 is a top view of the base 100 of FIGS. 1 and 2. FIG. 4 is a bottom view of the base 100 of FIGS. 1-3. FIG. 5 is a front view of the base 100 of FIGS. 1-4. FIG. 6 is a rear view of the base 100 of FIGS. 1-5. FIG. 7 is a right side view of the base 100 of FIGS. 1-6. FIG. 8 is a left side view of the base 100 of FIGS. 1-7. FIG. 9 is a cross-sectional view of the base 100 of FIGS. 1-8, taken along section A-A of FIG. 3. FIG. 10 is a cross-sectional view of the base 100 of FIGS. 1-9, taken along section B-B of FIG. 3.

The base 100 of FIGS. 1-10 includes an example upper surface 102, an example lower surface 202, an example front surface 104, an example rear surface 106, an example right side surface 108, and an example left side surface 110. The lower surface 202 of the base 100 is located opposite to the upper surface 102 of the base 100. The upper surface 102 and the lower surface 202 of the base 100 respectively extend between the front surface 104, the rear surface 106, the right side surface 108, and the left side surface 110 of the base 100. The front surface 104 of the base 100 extends between the right side surface 108 and the left side surface 110 of the base 100. The rear surface 106 of the base 100 is spaced apart from and located opposite to the front surface 104 of the base 100, with the rear surface 106 extending between the right side surface 108 and the left side surface 110 of the base 100. The right side surface 108 of the base 100 extends between the front surface 104 and the rear surface 106 of the base 100. The left side surface 110 of the base 100 is spaced apart from and located opposite to the right side surface 108 of the base 100, with the left side surface 110 extending between the front surface 104 and the rear surface 106 of the base 100.

The front surface 104, the rear surface 106, the right side surface 108, and the left side surface 110 of the base 100 of FIGS. 1-10 collectively form and/or define an example peripheral edge 112 of the base 100. In the illustrated example of FIGS. 1-10, the peripheral edge 112 extends downward from the upper surface 102 and/or the lower surface 202 of the base 100, with the peripheral edge 112 including, forming, and/or defining an example lower rim 114 of the base 100. The base 100 of FIGS. 1-10 has a generally rectangular shape that includes an example first corner 116, an example second corner 118, an example third corner 120, and an example fourth corner 122. In the illustrated example of FIGS. 1-10, the first corner 116 is a front right corner of the base 100, the second corner 118 is a front left corner of the base 100, the third corner 120 is a rear right corner of the base 100, and the fourth corner 122 is a rear left corner of the base 100, each of which is further described herein.

The first corner 116 (e.g., the front right corner) of the base 100 of FIGS. 1-10 includes an example groove 124, an example front portion 126, an example right side portion 128, an example angled portion 130, an example stepped portion 132, an example first peripheral opening 134, and an example second peripheral opening 136. The groove 124 of the first corner 116 is formed in and/or extends through the upper surface 102 and the lower surface 202 of the base 100, with the groove 124 being spaced apart from and located inwardly relative to the front portion 126, the right side portion 128, the angled portion 130, and the stepped portion 132 of the first corner 116. In the illustrated example of FIGS. 1-10, the groove 124 of the first corner 116 is formed as a downwardly-extending depression having an opening configured to receive a tongue of a base attachment that is removably couplable to the base 100, as further described herein. The groove 124 of the first corner 116 includes a depressed upper surface that is lowered (e.g., downwardly depressed and/or downwardly recessed) relative to the upper surface 102 of the base 100, with the depressed upper surface of the groove 124 being configured to support a lower surface of the tongue of the base attachment when the base attachment is coupled to the base 100, as further described herein.

In the illustrated example of FIGS. 1-10, the front portion 126, the right side portion 128, the angled portion 130, and the stepped portion 132 of the first corner 116 form and/or define respective portions of the peripheral edge 112 of the base 100. The front portion 126 of the first corner 116 is formed by the front surface 104 of the base 100. The right side portion 128 of the first corner 116 is formed by the right side surface 108 of the base 100. In the illustrated example of FIGS. 1-10, the right side portion 128 of the first corner 116 is perpendicular relative to the front portion 126 of the first corner 116. The angled portion 130 of the first corner 116 extends between the front portion 126 and the right side portion 128 of the first corner 116, with the angled portion 130 of the first corner 116 being oriented at an angle relative to both the front portion 126 and the right side portion 128 of the first corner 116. In the illustrated example of FIGS. 1-10, the angled portion 130 of the first corner 116 is oriented at an angle of approximately forty-five degrees relative to both the front portion 126 and the right side portion 128 of the first corner 116. The stepped portion 132 of the first corner 116 extends inwardly relative to the right side portion 128 of the first corner 116 such that an inwardly-extending step and/or recess is formed along the peripheral edge 112 of the base 100 at the junction between the right side portion 128 and the stepped portion 132 of the first corner 116. In the illustrated example of FIGS. 1-10, the stepped portion 132 of the first corner 116 extends inwardly relative to the right side portion 128 of the first corner 116 at an angle of approximately forty-five degrees such that the stepped portion 132 of the first corner 116 is perpendicular relative to the angled portion 130 of the first corner 116.

In the illustrated example of FIGS. 1-10, the first peripheral opening 134 of the first corner 116 is formed in and/or extends through the front portion 126 of the first corner 116. The second peripheral opening 136 of the first corner 116 is formed in and/or extends through the right side portion 128 of the first corner 116. The first peripheral opening 134 and the second peripheral opening 136 of the first corner 116 accordingly extend through the peripheral edge 112 of the base 100. In the illustrated example of FIGS. 1-10, the first peripheral opening 134 and the second peripheral opening 136 of the first corner 116 are respectively configured to receive corresponding ones of a first fastener and a second fastener, with the first fastener and the second fastener being configured to removably couple a base attachment to the first corner 116 of the base 100, as further described herein.

The second corner 118 (e.g., the front left corner) of the base 100 of FIGS. 1-10 includes an example groove 138, an example front portion 140, an example left side portion 142, an example angled portion 144, an example stepped portion 146, an example first peripheral opening 204, and an example second peripheral opening 148. The groove 138 of the second corner 118 is formed in and/or extends through the upper surface 102 and the lower surface 202 of the base 100, with the groove 138 being spaced apart from and located inwardly relative to the front portion 140, the left side portion 142, the angled portion 144, and the stepped portion 146 of the second corner 118. In the illustrated example of FIGS. 1-10, the groove 138 of the second corner 118 is formed as a downwardly-extending depression having an opening configured to receive a tongue of a base attachment that is removably couplable to the base 100, as further described herein. The groove 138 of the second corner 118 includes a depressed upper surface that is lowered (e.g., downwardly depressed and/or downwardly recessed) relative to the upper surface 102 of the base 100, with the depressed upper surface of the groove 138 being configured to support a lower surface of the tongue of the base attachment when the base attachment is coupled to the base 100, as further described herein.

In the illustrated example of FIGS. 1-10, the front portion 140, the left side portion 142, the angled portion 144, and the stepped portion 146 of the second corner 118 form and/or define respective portions of the peripheral edge 112 of the base 100. The front portion 140 of the second corner 118 is formed by the front surface 104 of the base 100. The left side portion 142 of the second corner 118 is formed by the left side surface 110 of the base 100. In the illustrated example of FIGS. 1-10, the left side portion 142 of the second corner 118 is perpendicular relative to the front portion 140 of the second corner 118. The angled portion 144 of the second corner 118 extends between the front portion 140 and the left side portion 142 of the second corner 118, with the angled portion 144 of the second corner 118 being oriented at an angle relative to both the front portion 140 and the left side portion 142 of the second corner 118. In the illustrated example of FIGS. 1-10, the angled portion 144 of the second corner 118 is oriented at an angle of approximately forty-five degrees relative to both the front portion 140 and the left side portion 142 of the second corner 118. The stepped portion 146 of the second corner 118 extends inwardly relative to the left side portion 142 of the second corner 118 such that an inwardly-extending step and/or recess is formed along the peripheral edge 112 of the base 100 at the junction between the left side portion 142 and the stepped portion 146 of the second corner 118. In the illustrated example of FIGS. 1-10, the stepped portion 146 of the second corner 118 extends inwardly relative to the left side portion 142 of the second corner 118 at an angle of approximately forty-five degrees, such that the stepped portion 146 of the second corner 118 is perpendicular relative to the angled portion 144 of the second corner 118.

In the illustrated example of FIGS. 1-10, the first peripheral opening 204 of the second corner 118 is formed in and/or extends through the left side portion 142 of the second corner 118. The second peripheral opening 148 of the second corner 118 is formed in and/or extends through the front portion 140 of the second corner 118. The first peripheral opening 204 and the second peripheral opening 148 of the second corner 118 accordingly extend through the peripheral edge 112 of the base 100. In the illustrated example of FIGS. 1-10, the first peripheral opening 204 and the second peripheral opening 148 of the second corner 118 are respectively configured to receive corresponding ones of a first fastener and a second fastener, with the first fastener and the second fastener being configured to removably couple a base attachment to the second corner 118 of the base 100, as further described herein.

The third corner 120 (e.g., the rear right corner) of the base 100 of FIGS. 1-10 includes an example groove 150, an example rear portion 152, an example right side portion 154, an example angled portion 156, an example stepped portion 158, an example first peripheral opening 160, and an example second peripheral opening 206. The groove 150 of the third corner 120 is formed in and/or extends through the upper surface 102 and the lower surface 202 of the base 100, with the groove 150 being spaced apart from and located inwardly relative to the rear portion 152, the right side portion 154, the angled portion 156, and the stepped portion 158 of the third corner 120. In the illustrated example of FIGS. 1-10, the groove 150 of the third corner 120 is formed as a downwardly-extending depression having an opening configured to receive a tongue of a base attachment that is removably couplable to the base 100, as further described herein. The groove 150 of the third corner 120 includes a depressed upper surface that is lowered (e.g., downwardly depressed and/or downwardly recessed) relative to the upper surface 102 of the base 100, with the depressed upper surface of the groove 150 being configured to support a lower surface of the tongue of the base attachment when the base attachment is coupled to the base 100, as further described herein.

In the illustrated example of FIGS. 1-10, the rear portion 152, the right side portion 154, the angled portion 156, and the stepped portion 158 of the third corner 120 form and/or define respective portions of the peripheral edge 112 of the base 100. The rear portion 152 of the third corner 120 is formed by the rear surface 106 of the base 100. The right side portion 154 of the third corner 120 is formed by the right side surface 108 of the base 100. In the illustrated example of FIGS. 1-10, the right side portion 154 of the third corner 120 is perpendicular relative to the rear portion 152 of the third corner 120. The angled portion 156 of the third corner 120 extends between the rear portion 152 and the right side portion 154 of the third corner 120, with the angled portion 156 of the third corner 120 being oriented at an angle relative to both the rear portion 152 and the right side portion 154 of the third corner 120. In the illustrated example of FIGS. 1-10, the angled portion 156 of the third corner 120 is oriented at an angle of approximately forty-five degrees relative to both the rear portion 152 and the right side portion 154 of the third corner 120. The stepped portion 158 of the third corner 120 extends inwardly relative to the right side portion 154 of the third corner 120 such that an inwardly-extending step and/or recess is formed along the peripheral edge 112 of the base 100 at the junction between the right side portion 154 and the stepped portion 158 of the third corner 120. In the illustrated example of FIGS. 1-10, the stepped portion 158 of the third corner 120 extends inwardly relative to the right side portion 154 of the third corner 120 at an angle of approximately forty-five degrees such that the stepped portion 158 of the third corner 120 is perpendicular relative to the angled portion 156 of the third corner 120.

In the illustrated example of FIGS. 1-10, the first peripheral opening 160 of the third corner 120 is formed in and/or extends through the right side portion 154 of the third corner 120. The second peripheral opening 206 of the third corner 120 is formed in and/or extends through the rear portion 152 of the third corner 120. The first peripheral opening 160 and the second peripheral opening 206 of the third corner 120 accordingly extend through the peripheral edge 112 of the base 100. In the illustrated example of FIGS. 1-10, the first peripheral opening 160 and the second peripheral opening 206 of the third corner 120 are respectively configured to receive corresponding ones of a first fastener and a second fastener, with the first fastener and the second fastener being configured to removably couple a base attachment to the third corner 120 of the base 100, as further described herein.

The fourth corner 122 (e.g., the rear left corner) of the base 100 of FIGS. 1-10 includes an example groove 162, an example rear portion 164, an example left side portion 166, an example angled portion 168, an example stepped portion 170, an example first peripheral opening 208, and an example second peripheral opening 210. The groove 162 of the fourth corner 122 is formed in and/or extends through the upper surface 102 and the lower surface 202 of the base 100, with the groove 162 being spaced apart from and located inwardly relative to the rear portion 164, the left side portion 166, the angled portion 168, and the stepped portion 170 of the fourth corner 122. In the illustrated example of FIGS. 1-10, the groove 162 of the fourth corner 122 is formed as a downwardly-extending depression having an opening configured to receive a tongue of a base attachment that is removably couplable to the base 100, as further described herein. The groove 162 of the fourth corner 122 includes a depressed upper surface that is lowered (e.g., downwardly depressed and/or downwardly recessed) relative to the upper surface 102 of the base 100, with the depressed upper surface of the groove 162 being configured to support a lower surface of the tongue of the base attachment when the base attachment is coupled to the base 100, as further described herein.

In the illustrated example of FIGS. 1-10, the rear portion 164, the left side portion 166, the angled portion 168, and the stepped portion 170 of the fourth corner 122 form and/or define respective portions of the peripheral edge 112 of the base 100. The rear portion 164 of the fourth corner 122 is formed by the rear surface 106 of the base 100. The left side portion 166 of the fourth corner 122 is formed by the left side surface 110 of the base 100. In the illustrated example of FIGS. 1-10, the left side portion 166 of the fourth corner 122 is perpendicular relative to the rear portion 164 of the fourth corner 122. The angled portion 168 of the fourth corner 122 extends between the rear portion 164 and the left side portion 166 of the fourth corner 122, with the angled portion 168 of the fourth corner 122 being oriented at an angle relative to both the rear portion 164 and the left side portion 166 of the fourth corner 122. In the illustrated example of FIGS. 1-10, the angled portion 168 of the fourth corner 122 is oriented at an angle of approximately forty-five degrees relative to both the rear portion 164 and the left side portion 166 of the fourth corner 122. The stepped portion 170 of the fourth corner 122 extends inwardly relative to the left side portion 166 of the fourth corner 122 such that an inwardly-extending step and/or recess is formed along the peripheral edge 112 of the base 100 at the junction between the left side portion 166 and the stepped portion 170 of the fourth corner 122. In the illustrated example of FIGS. 1-10, the stepped portion 170 of the fourth corner 122 extends inwardly relative to the left side portion 166 of the fourth corner 122 at an angle of approximately forty-five degrees, such that the stepped portion 170 of the fourth corner 122 is perpendicular relative to the angled portion 168 of the fourth corner 122.

In the illustrated example of FIGS. 1-10, the first peripheral opening 208 of the fourth corner 122 is formed in and/or extends through the rear portion 164 of the fourth corner 122. The second peripheral opening 210 of the fourth corner 122 is formed in and/or extends through the left side portion 166 of the fourth corner 122. The first peripheral opening 208 and the second peripheral opening 210 of the fourth corner 122 accordingly extend through the peripheral edge 112 of the base 100. In the illustrated example of FIGS. 1-10, the first peripheral opening 208 and the second peripheral opening 210 of the fourth corner 122 are respectively configured to receive corresponding ones of a first fastener and a second fastener, with the first fastener and the second fastener being configured to removably couple a base attachment to the fourth corner 122 of the base 100, as further described herein.

In the illustrated example of FIGS. 1-10, the base 100 further includes an example fuel tank opening 172 formed in and/or extending through the upper surface 102 and the lower surface 202 of the base 100, with the fuel tank opening 172 being configured to receive a portion (e.g., a bottom or lower portion) of a fuel tank (e.g., a liquid propane cylinder). In other examples, the fuel tank opening 172 can be omitted from the base 100. In some examples, the base 100 further includes one or more additional opening(s) (e.g., in addition to the opening of the groove 124 of the first corner 116, the opening of the groove 138 of the second corner 118, the opening of the groove 150 of the third corner 120, the opening of the groove 162 of the fourth corner 122, and the fuel tank opening 172) configured to receive one or more component(s) (e.g., an access door pivot, an access door stop, a support member, a fastener, etc.) of a grill cart that includes the base 100.

As discussed above, the groove 124 of the first corner 116, the groove 138 of the second corner 118, the groove 150 of the third corner 120, and the groove 162 of the fourth corner 122 each include a depressed upper surface that is lowered (e.g., downwardly depressed and/or downwardly recessed) relative to the upper surface 102 of the base 100, with the depressed upper surface of the respective groove being configured to support a lower surface of a tongue of a base attachment when the base attachment is coupled to the base 100. For example, as shown in greater detail in FIGS. 9 and 10, the groove 150 of the third corner 120 includes an example depressed upper surface 902 that is lowered (e.g., downwardly depressed and/or downwardly recessed) relative to the upper surface 102 of the base 100, with the depressed upper surface 902 of the groove 150 being configured to support a lower surface of a tongue of a base attachment when the base attachment is coupled to the base 100. The groove 124 of the first corner 116, the groove 138 of the second corner 118, and the groove 162 of the fourth corner 122 are each configured in a substantially similar manner relative to the groove 150 of the third corner 120 as shown in FIGS. 9 and 10, including the example depressed upper surface 902 thereof. In the illustrated example of FIGS. 1-10, the first corner 116, the second corner 118, the third corner 120, and the fourth corner 122 of the base 100 are individually and collectively configured such that a base attachment that is removably couplable to the first corner 116 of the base 100 is interchangeably removably couplable to the second corner 118, the third corner 120, and/or the fourth corner 122 of the base 100, as further described herein.

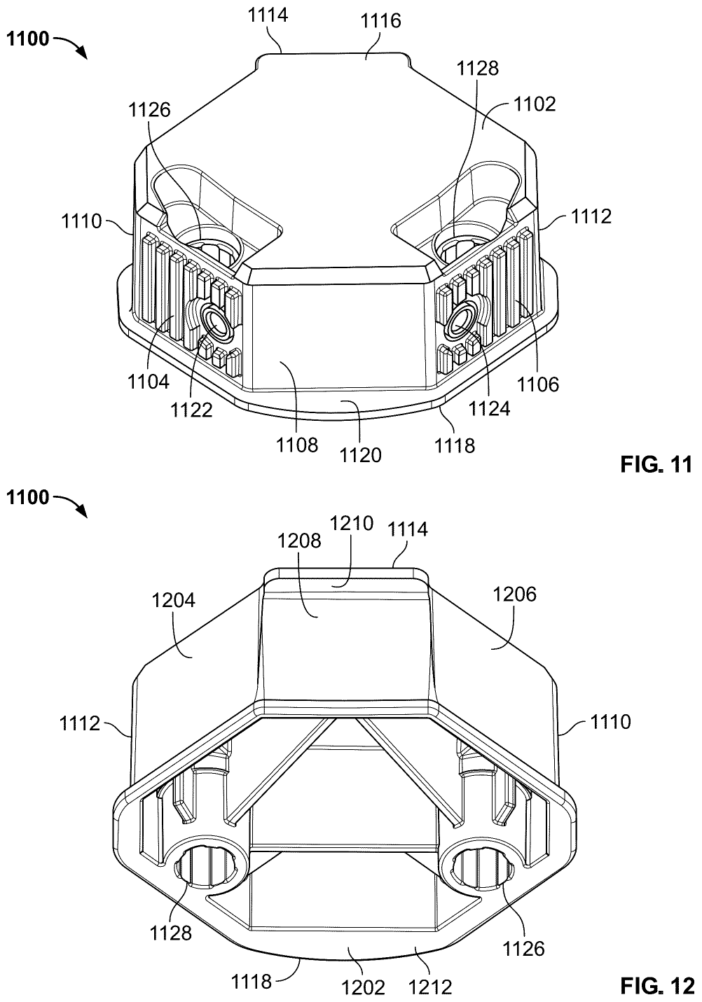

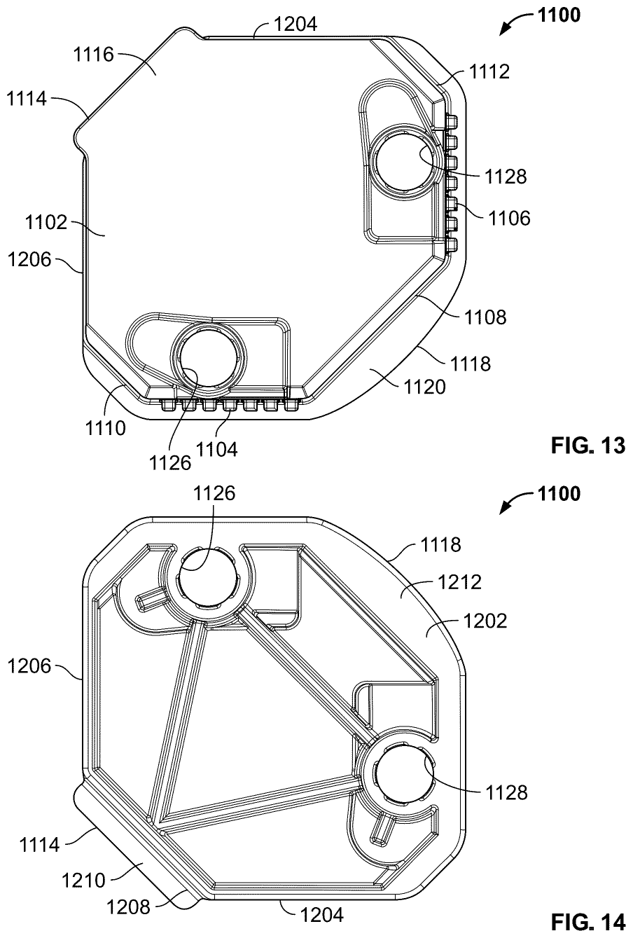

FIG. 11 is a first perspective view of an example base attachment 1100 configured for use with and/or installation on the base 100 of FIGS. 1-10. FIG. 12 is a second perspective view of the base attachment 1100 of FIG. 11. FIG. 13 is a top view of the base attachment 1100 of FIGS. 11 and 12. FIG. 14 is a bottom view of the base attachment 1100 of FIGS. 11-13. The base attachment 1100 of FIGS. 11-14 includes an example upper surface 1102, an example lower surface 1202 (e.g., a lower rim), an example first face 1104, an example second face 1106, an example third face 1204, an example fourth face 1206, an example fifth face 1108, an example sixth face 1208, an example seventh face 1110, and an example eighth face 1112. The upper surface 1102 of the base attachment 1100 of FIGS. 11-14 is configured to face toward, abut, and/or engage the lower surface 1202 of the base 100 of FIGS. 1-10 when the base attachment 1100 is coupled to the base 100, as further described herein. The lower surface 1202 of the base attachment 1100 of FIGS. 11-14 is spaced apart from and located opposite to the upper surface 1102 of the base attachment 1100.

In the illustrated example of FIGS. 11-14, the base attachment 1100 has an octagonal shape formed and/or defined by the first face 1104, the second face 1106, the third face 1204, the fourth face 1206, the fifth face 1108, the sixth face 1208, the seventh face 1110, and the eighth face 1112 of the base attachment 1100, with each such face generally extending between the upper surface 1102 and the lower surface 1202 of the base attachment 1100. In this regard, the second face 1106 of the base attachment 1100 of FIGS. 11-14 is perpendicular to the first face 1104 of the base attachment 1100. The third face 1204 of the base attachment 1100 of FIGS. 11-14 is spaced apart from and located opposite to the first face 1104 of the base attachment 1100, with the third face 1204 being parallel to the first face 1104 and perpendicular to the second face 1106 of the base attachment 1100. The fourth face 1206 of the base attachment 1100 of FIGS. 11-14 is spaced apart from and located opposite to the second face 1106 of the base attachment 1100, with the fourth face 1206 being parallel to the second face 1106 and perpendicular to both the first face 1104 and the third face 1204 of the base attachment 1100.

The fifth face 1108 of the base attachment 1100 of FIGS. 11-14 extends between the first face 1104 and the second face 1106 of the base attachment 1100, with the fifth face 1108 being oriented at an angle relative to both the first face 1104 and the second face 1106. In the illustrated example of FIGS. 11-14, the fifth face 1108 of the base attachment 1100 is oriented at an angle of approximately forty-five degrees relative to both the first face 1104 and the second face 1106 of the base attachment 1100. The sixth face 1208 of the base attachment 1100 of FIGS. 11-14 is spaced apart from and located opposite to the fifth face 1108 of the base attachment 1100, with the sixth face 1208 being parallel to the fifth face 1108. The sixth face 1208 of the base attachment 1100 extends between the third face 1204 and the fourth face 1206 of the base attachment 1100, with the sixth face 1208 being oriented at an angle relative to both the third face 1204 and the fourth face 1206. In the illustrated example of FIGS. 11-14, the sixth face 1208 of the base attachment 1100 is oriented at an angle of approximately forty-five degrees relative to both the third face 1204 and the fourth face 1206 of the base attachment 1100. The seventh face 1110 of the base attachment 1100 of FIGS. 11-14 is perpendicular to both the fifth face 1108 and the sixth face 1208 of the base attachment 1100. The seventh face 1110 of the base attachment 1100 extends between the first face 1104 and the fourth face 1206 of the base attachment 1100, with the seventh face 1110 being oriented at an angle relative to both the first face 1104 and the fourth face 1206. In the illustrated example of FIGS. 11-14, the seventh face 1110 of the base attachment 1100 is oriented at an angle of approximately forty-five degrees relative to both the first face 1104 and the fourth face 1206 of the base attachment 1100. The eighth face 1112 of the base attachment 1100 of FIGS. 11-14 is spaced apart from and located opposite to the seventh face 1110 of the base attachment 1100, with the eighth face 1112 being parallel to the seventh face 1110 and perpendicular to both the fifth face 1108 and the sixth face 1208 of the base attachment 1100. The eighth face 1112 of the base attachment 1100 extends between the second face 1106 and the third face 1204 of the base attachment 1100, with the eighth face 1112 being oriented at an angle relative to both the second face 1106 and the third face 1204. In the illustrated example of FIGS. 11-14, the eighth face 1112 of the base attachment 1100 is oriented at an angle of approximately forty-five degrees relative to both the second face 1106 and the third face 1204 of the base attachment 1100.

The base attachment 1100 of FIGS. 11-14 further includes an example tongue 1114 located at and/or adjacent to the upper surface 1102 of the base attachment 1100 along the sixth face 1208 of the base attachment 1100, with the tongue 1114 projecting and/or extending outwardly from (e.g., away from) the sixth face 1208 of the base attachment 1100. The tongue 1114 includes an example upper surface 1116 and an example lower surface 1210, with the lower surface 1210 being located opposite to the upper surface 1116. In the illustrated example of FIGS. 11-14, the upper surface 1116 and the lower surface 1210 of the tongue 1114 are both parallel to the upper surface 1102 and/or the lower surface 1202 of the base attachment 1100, and perpendicular to the sixth face 1208 of the base attachment 1100. As further shown in FIGS. 11-14, the upper surface 1116 of the tongue 1114 is coplanar with the upper surface 1102 of the base attachment 1100. The tongue 1114 of the base attachment 1100 of FIGS. 11-14 is configured to be removably received within a groove of a corner (e.g., the first corner 116, the second corner 118, the third corner 120, or the fourth corner 122) of the base 100 of FIGS. 1-10, as further described herein. The tongue 1114 of the base attachment 1100 of FIGS. 11-14 is further configured such that the lower surface 1210 of the tongue 1114 is supported by a depressed upper surface of the groove of the corner of the base 100 when the base attachment 1100 is coupled to the base 100, as further described herein.

The base attachment 1100 of FIGS. 11-14 further includes an example lip 1118 located at and/or adjacent to the lower surface 1202 of the base attachment 1100 along the first face 1104, the second face 1106, the fifth face 1108, the seventh face 1110, and the eighth face 1112 of the base attachment 1100, with the lip 1118 projecting and/or extending outwardly from (e.g., away from) each such face of the base attachment 1100. The lip 1118 includes an example upper surface 1120 and an example lower surface 1212, with the lower surface 1212 being located opposite to the upper surface 1120. In the illustrated example of FIGS. 11-14, the upper surface 1120 and the lower surface 1212 of the lip 1118 are both parallel to the upper surface 1102 and/or the lower surface 1202 of the base attachment 1100, and perpendicular to the first face 1104, the second face 1106, the fifth face 1108, the seventh face 1110, and/or the eighth face 1112 of the base attachment 1100. As further shown in FIGS. 11-14, the lower surface 1212 of the lip 1118 is coplanar with the lower surface 1202 of the base attachment 1100. The upper surface 1120 of the lip 1118 of the base attachment 1100 of FIGS. 11-14 is configured to face toward, abut, and/or engage a portion of the lower rim 114 of the base 100 of FIGS. 1-10 located at and/or along a corner (e.g., the first corner 116, the second corner 118, the third corner 120, or the fourth corner 122) of the base 100 when the base attachment 1100 is coupled to the base 100, as further described herein.

The base attachment 1100 of FIGS. 11-14 further includes an example first peripheral opening 1122 and an example second peripheral opening 1124. The first peripheral opening 1122 of the base attachment 1100 is formed in and/or extends through the first face 1104 of the base attachment 1100. The second peripheral opening 1124 of the base attachment 1100 is formed in and/or extends through the second face 1106 of the base attachment 1100. In the illustrated example of FIGS. 11-14, the first peripheral opening 1122 and the second peripheral opening 1124 of the base attachment 1100 are respectively configured to receive corresponding ones of a first fastener and a second fastener, with the first fastener and the second fastener being configured to removably couple the base attachment 1100 to a corner (e.g., the first corner 116, the second corner 118, the third corner 120, or the fourth corner 122) of the base 100 of FIGS. 1-10, as further described herein. In some examples, the first peripheral opening 1122 and the second peripheral opening 1124 of the base attachment 1100 are implemented as threaded openings configured to receive corresponding ones of a first threaded fastener (e.g., a first screw) and a second threaded fastener (e.g., a second screw).

The faces (e.g., the first face 1104, the second face 1106, the third face 1204, the fourth face 1206, the fifth face 1108, the sixth face 1208, the seventh face 1110, and the eighth face 1112), the tongue 1114, the lip 1118, the first peripheral opening 1122, and the second peripheral opening 1124 of the base attachment 1100 of FIGS. 11-14 are individually and/or collectively configured such that the base attachment 1100 can advantageously be removably coupled in an interchangeable manner to any corner (e.g., the first corner 116, the second corner 118, the third corner 120, or the fourth corner 122) of the base 100 of FIGS. 1-10.

For example, the base attachment 1100 of FIGS. 11-14 is removably couplable to the first corner 116 of the base 100 of FIGS. 1-10. When the base attachment 1100 is coupled to the first corner 116 of the base 100, the upper surface 1102 of the base attachment 1100 faces toward, abuts, and/or engages the lower surface 1202 of the base 100, the first face 1104 of the base attachment 1100 faces toward, abuts, and/or engages an interior surface of the front portion 126 of the first corner 116, the second face 1106 of the base attachment 1100 faces toward, abuts, and/or otherwise engages an interior surface of the right side portion 128 of the first corner 116, the fifth face 1108 of the base attachment 1100 faces toward, abuts, and/or engages an interior surface of the angled portion 130 of the first corner 116, and the eighth face 1112 of the base attachment 1100 faces toward, abuts, and/or engages an interior surface of the stepped portion 132 of the first corner 116. Coupling the base attachment 1100 to the first corner 116 of the base 100 further causes the tongue 1114 of the base attachment 1100 to be located within the groove 124 of the first corner 116, with lower surface 1210 of the tongue 1114 facing toward, abutting, and/or engaging a depressed upper surface (e.g., structured similar to the depressed upper surface 902 shown in FIGS. 9 and 10) of the groove 124 of the first corner 116. Coupling the base attachment 1100 to the first corner 116 of the base 100 further causes the lip 1118 of the base attachment 1100 to be located adjacent the portion of the lower rim 114 of the base 100 that extends along the first corner 116, with upper surface 1120 of the lip 1118 facing toward, abutting, and/or engaging said portion of the lower rim 114 along the first corner 116.

The base attachment 1100 of FIGS. 11-14 can be removably coupled to the first corner 116 of the base 100 of FIGS. 1-10 via a first fastener and a second fastener. When the base attachment 1100 is coupled to the first corner 116 of the base 100, the first fastener extends through the first peripheral opening 134 of the first corner 116 into the first peripheral opening 1122 of the base attachment 1100, and the second fastener extends through the second peripheral opening 136 of the first corner 116 into the second peripheral opening 1124 of the base attachment 1100. The base attachment 1100 can be coupled and/or attached to the first corner 116 of the base 100 by inserting the first and second fasteners through and/or into (and/or by securing the first and second fasteners within) the aforementioned peripheral openings once the tongue 1114 of the base attachment 1100 has been inserted into the groove 124 of the first corner 116. Conversely, the base attachment 1100 can be uncoupled and/or detached from the first corner 116 of the base 100 by removing the first and second fasteners from (and/or by unsecuring the first and second fasteners from within) the aforementioned peripheral openings, and then removing the tongue 1114 of the base attachment 1100 from the groove 124 of the first corner 116.

As another example, the base attachment 1100 of FIGS. 11-14 is removably couplable to the second corner 118 of the base 100 of FIGS. 1-10. When the base attachment 1100 is coupled to the second corner 118 of the base 100, the upper surface 1102 of the base attachment 1100 faces toward, abuts, and/or engages the lower surface 1202 of the base 100, the first face 1104 of the base attachment 1100 faces toward, abuts, and/or engages an interior surface of the left side portion 142 of the second corner 118, the second face 1106 of the base attachment 1100 faces toward, abuts, and/or otherwise engages an interior surface of the front portion 140 of the second corner 118, the fifth face 1108 of the base attachment 1100 faces toward, abuts, and/or engages an interior surface of the angled portion 144 of the second corner 118, and the seventh face 1110 of the base attachment 1100 faces toward, abuts, and/or engages an interior surface of the stepped portion 146 of the second corner 118. Coupling the base attachment 1100 to the second corner 118 of the base 100 further causes the tongue 1114 of the base attachment 1100 to be located within the groove 138 of the second corner 118, with lower surface 1210 of the tongue 1114 facing toward, abutting, and/or engaging a depressed upper surface (e.g., structured similar to the depressed upper surface 902 shown in FIGS. 9 and 10) of the groove 138 of the second corner 118. Coupling the base attachment 1100 to the second corner 118 of the base 100 further causes the lip 1118 of the base attachment 1100 to be located adjacent the portion of the lower rim 114 of the base 100 that extends along the second corner 118, with upper surface 1120 of the lip 1118 facing toward, abutting, and/or engaging said portion of the lower rim 114 along the second corner 118.

The base attachment 1100 of FIGS. 11-14 can be removably coupled to the second corner 118 of the base 100 of FIGS. 1-10 via a first fastener and a second fastener. When the base attachment 1100 is coupled to the second corner 118 of the base 100, the first fastener extends through the first peripheral opening 204 of the second corner 118 into the first peripheral opening 1122 of the base attachment 1100, and the second fastener extends through the second peripheral opening 148 of the second corner 118 into the second peripheral opening 1124 of the base attachment 1100. The base attachment 1100 can be coupled and/or attached to the second corner 118 of the base 100 by inserting the first and second fasteners through and/or into (and/or by securing the first and second fasteners within) the aforementioned peripheral openings once the tongue 1114 of the base attachment 1100 has been inserted into the groove 138 of the second corner 118. Conversely, the base attachment 1100 can be uncoupled and/or detached from the second corner 118 of the base 100 by removing the first and second fasteners from (and/or by unsecuring the first and second fasteners from within) the aforementioned peripheral openings, and then removing the tongue 1114 of the base attachment 1100 from the groove 138 of the second corner 118.

As yet another example, the base attachment 1100 of FIGS. 11-14 is removably couplable to the third corner 120 of the base 100 of FIGS. 1-10. When the base attachment 1100 is coupled to the third corner 120 of the base 100, the upper surface 1102 of the base attachment 1100 faces toward, abuts, and/or engages the lower surface 1202 of the base 100, the first face 1104 of the base attachment 1100 faces toward, abuts, and/or engages an interior surface of the right side portion 154 of the third corner 120, the second face 1106 of the base attachment 1100 faces toward, abuts, and/or otherwise engages an interior surface of the rear portion 152 of the third corner 120, the fifth face 1108 of the base attachment 1100 faces toward, abuts, and/or engages an interior surface of the angled portion 156 of the third corner 120, and the seventh face 1110 of the base attachment 1100 faces toward, abuts, and/or engages an interior surface of the stepped portion 158 of the third corner 120. Coupling the base attachment 1100 to the third corner 120 of the base 100 further causes the tongue 1114 of the base attachment 1100 to be located within the groove 150 of the third corner 120, with lower surface 1210 of the tongue 1114 facing toward, abutting, and/or engaging the depressed upper surface 902 of the groove 150 of the third corner 120. Coupling the base attachment 1100 to the third corner 120 of the base 100 further causes the lip 1118 of the base attachment 1100 to be located adjacent the portion of the lower rim 114 of the base 100 that extends along the third corner 120, with upper surface 1120 of the lip 1118 facing toward, abutting, and/or engaging said portion of the lower rim 114 along the third corner 120.

The base attachment 1100 of FIGS. 11-14 can be removably coupled to the third corner 120 of the base 100 of FIGS. 1-10 via a first fastener and a second fastener. When the base attachment 1100 is coupled to the third corner 120 of the base 100, the first fastener extends through the first peripheral opening 160 of the third corner 120 into the first peripheral opening 1122 of the base attachment 1100, and the second fastener extends through the second peripheral opening 206 of the third corner 120 into the second peripheral opening 1124 of the base attachment 1100. The base attachment 1100 can be coupled and/or attached to the third corner 120 of the base 100 by inserting the first and second fasteners through and/or into (and/or by securing the first and second fasteners within) the aforementioned peripheral openings once the tongue 1114 of the base attachment 1100 has been inserted into the groove 150 of the third corner 120. Conversely, the base attachment 1100 can be uncoupled and/or detached from the third corner 120 of the base 100 by removing the first and second fasteners from (and/or by unsecuring the first and second fasteners from within) the aforementioned peripheral openings, and then removing the tongue 1114 of the base attachment 1100 from the groove 150 of the third corner 120.

As yet another example, the base attachment 1100 of FIGS. 11-14 is removably couplable to the fourth corner 122 of the base 100 of FIGS. 1-10. When the base attachment 1100 is coupled to the fourth corner 122 of the base 100, the upper surface 1102 of the base attachment 1100 faces toward, abuts, and/or engages the lower surface 1202 of the base 100, the first face 1104 of the base attachment 1100 faces toward, abuts, and/or engages an interior surface of the rear portion 164 of the fourth corner 122, the second face 1106 of the base attachment 1100 faces toward, abuts, and/or otherwise engages an interior surface of the left side portion 166 of the fourth corner 122, the fifth face 1108 of the base attachment 1100 faces toward, abuts, and/or engages an interior surface of the angled portion 168 of the fourth corner 122, and the eighth face 1112 of the base attachment 1100 faces toward, abuts, and/or engages an interior surface of the stepped portion 170 of the fourth corner 122. Coupling the base attachment 1100 to the fourth corner 122 of the base 100 further causes the tongue 1114 of the base attachment 1100 to be located within the groove 162 of the fourth corner 122, with lower surface 1210 of the tongue 1114 facing toward, abutting, and/or engaging a depressed upper surface (e.g., structured similar to the depressed upper surface 902 shown in FIGS. 9 and 10) of the groove 162 of the fourth corner 122. Coupling the base attachment 1100 to the fourth corner 122 of the base 100 further causes the lip 1118 of the base attachment 1100 to be located adjacent the portion of the lower rim 114 of the base 100 that extends along the fourth corner 122, with upper surface 1120 of the lip 1118 facing toward, abutting, and/or engaging said portion of the lower rim 114 along the fourth corner 122.

The base attachment 1100 of FIGS. 11-14 can be removably coupled to the fourth corner 122 of the base 100 of FIGS. 1-10 via a first fastener and a second fastener. When the base attachment 1100 is coupled to the fourth corner 122 of the base 100, the first fastener extends through the first peripheral opening 208 of the fourth corner 122 into the first peripheral opening 1122 of the base attachment 1100, and the second fastener extends through the second peripheral opening 210 of the fourth corner 122 into the second peripheral opening 1124 of the base attachment 1100. The base attachment 1100 can be coupled and/or attached to the fourth corner 122 of the base 100 by inserting the first and second fasteners through and/or into (and/or by securing the first and second fasteners within) the aforementioned peripheral openings once the tongue 1114 of the base attachment 1100 has been inserted into the groove 162 of the fourth corner 122. Conversely, the base attachment 1100 can be uncoupled and/or detached from the fourth corner 122 of the base 100 by removing the first and second fasteners from (and/or by unsecuring the first and second fasteners from within) the aforementioned peripheral openings, and then removing the tongue 1114 of the base attachment 1100 from the groove 162 of the fourth corner 122.

The base attachment 1100 of FIGS. 11-14 further includes an example first shaft opening 1126 and an example second shaft opening 1128. The first shaft opening 1126 and the second shaft opening 1128 are respectively configured to selectively receive a shaft of a caster. Inserting the shaft of the caster into the first shaft opening 1126 or the second shaft opening 1128 of the base attachment 1100 forms a caster assembly, as further described herein. In the illustrated example of FIGS. 11-14, the first shaft opening 1126 and the second shaft opening 1128 extend vertically within the base attachment 1100, beginning at the lower surface 1202 of the base attachment 1100 and extending upward toward and/or through the upper surface 1102 of the base attachment 1100. The second shaft opening 1128 is spaced apart from the first shaft opening 1126. In the illustrated example of FIGS. 11-14, the first shaft opening 1126 is located adjacent an interior surface of the first face 1104 of the base attachment 1100, and the second shaft opening 1128 is located adjacent an interior surface of the second face 1106 of the base attachment 1100.

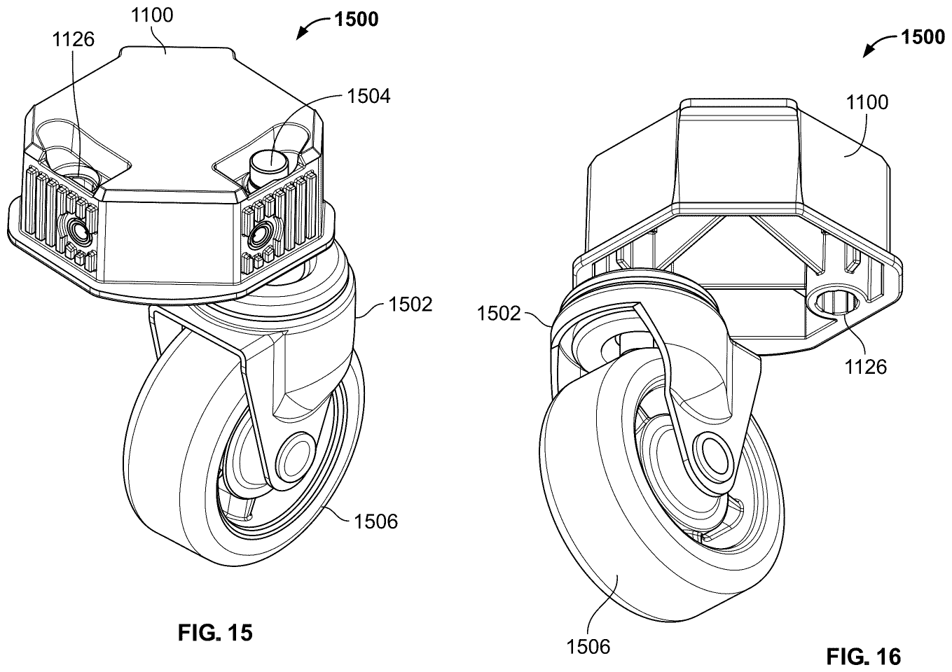

FIG. 15 is a first perspective view of an example first caster assembly 1500 including the base attachment 1100 of FIGS. 11-14, and configured for use with and/or installation on the base 100 of FIGS. 1-10. FIG. 16 is a second perspective view of the first caster assembly 1500 of FIG. 15. The first caster assembly 1500 of FIGS. 15 and 16 includes an example caster 1502 having an example shaft 1504 and an example wheel 1506. In the illustrated example of FIGS. 15 and 16, the shaft 1504 of the caster 1502 is inserted into the second shaft opening 1128 of the base attachment 1100, thereby coupling (e.g., via a friction fit) the caster 1502 to the base attachment 1100. In other examples, the shaft 1504 of the caster 1502 can instead be inserted into the first shaft opening 1126 of the base attachment 1100. In the illustrated example of FIGS. 15 and 16, the caster 1502 does not include a brake for the wheel 1506. The caster 1502 is accordingly a non-locking caster, and the first caster assembly 1500 of FIGS. 15 and 16 is accordingly a non-locking caster assembly. As discussed above, the base attachment 1100 of FIGS. 11-14 that forms part of the first caster assembly 1500 of FIGS. 15 and 16 is configured to be removably coupled in an interchangeable manner to any corner (e.g., the first corner 116, the second corner 118, the third corner 120, or the fourth corner 122) of the base 100 of FIGS. 1-10. The first caster assembly 1500 of FIGS. 15 and 16 is therefore also configured to be removably coupled in an interchangeable manner to any corner (e.g., the first corner 116, the second corner 118, the third corner 120, or the fourth corner 122) of the base 100 of FIGS. 1-10.

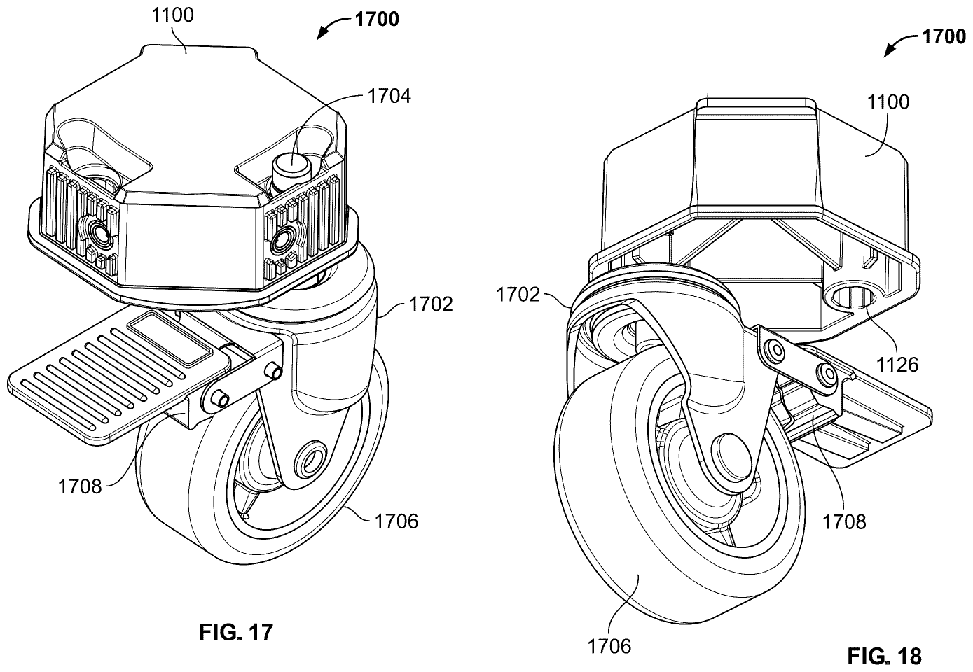

FIG. 17 is a first perspective view of an example second caster assembly 1700 including the base attachment 1100 of FIGS. 11-14, and configured for use with and/or installation on the base 100 of FIGS. 1-10. FIG. 18 is a second perspective view of the second caster assembly 1700 of FIG. 17. The second caster assembly 1700 of FIGS. 17 and 18 includes an example caster 1702 having an example shaft 1704, an example wheel 1706, and an example brake 1708. In the illustrated example of FIGS. 17 and 18, the shaft 1704 of the caster 1702 is inserted into the second shaft opening 1128 of the base attachment 1100, thereby coupling (e.g., via a friction fit) the caster 1702 to the base attachment 1100. In other examples, the shaft 1704 of the caster 1702 can instead be inserted into the first shaft opening 1126 of the base attachment 1100. In the illustrated example of FIGS. 17 and 18, the caster 1502 the brake 1708 is movable between a locked position and an unlocked position to selectively lock and/or otherwise prevent the wheel 1706 from rotating about its axis of rotation. The caster 1702 is accordingly a locking caster, and the second caster assembly 1700 of FIGS. 17 and 18 is accordingly a locking caster assembly. As discussed above, the base attachment 1100 of FIGS. 11-14 that forms part of the second caster assembly 1700 of FIGS. 17 and 18 is configured to be removably coupled in an interchangeable manner to any corner (e.g., the first corner 116, the second corner 118, the third corner 120, or the fourth corner 122) of the base 100 of FIGS. 1-10. The second caster assembly 1700 of FIGS. 17 and 18 is therefore also configured to be removably coupled in an interchangeable manner to any corner (e.g., the first corner 116, the second corner 118, the third corner 120, or the fourth corner 122) of the base 100 of FIGS. 1-10.

The second caster assembly 1700 of FIGS. 17 and 18 is further configured such that a height of the second caster assembly 1700 (e.g., measured from the top of the upper surface 1102 of the base attachment 1100 of the second caster assembly 1700 to the bottom of the wheel 1706 of the second caster assembly 1700) matches and/or is substantially equal to a height of the first caster assembly 1500 of FIGS. 15 and 16 (e.g., measured from the top of the upper surface 1102 of the base attachment 1100 of the first caster assembly 1500 to the bottom of the wheel 1506 of the first caster assembly 1500). Multiple instances and/or various combinations of the first caster assembly 1500 of FIGS. 15 and 16 and/or the second caster assembly 1700 of FIGS. 17 and 18 can therefore be coupled, concurrently, to respective ones of the first corner 116, the second corner 118, the third corner 120, and the fourth corner the base 100 of FIGS. 1-10 in a manner that causes the upper surface 102 of the base 100 to be maintained in a level state (e.g., parallel) relative to an underlying ground surface that is engaged by the respective ones of the first caster assembly 1500 and/or the second caster assembly 1700 when the corresponding base attachments of such structures are coupled to the base 100 and the resultant base assembly is placed on the underlying ground surface.

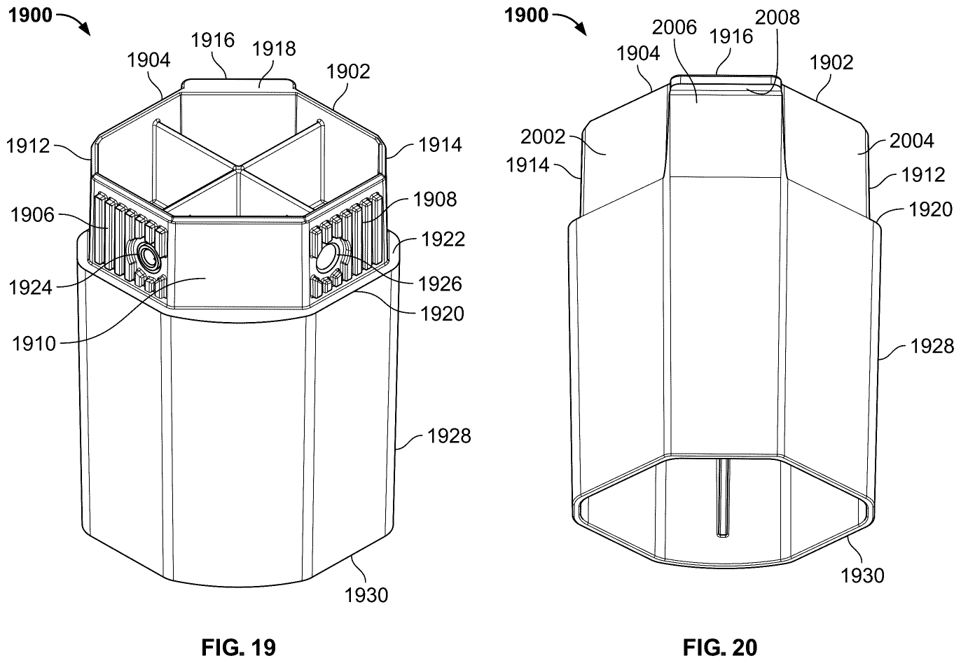

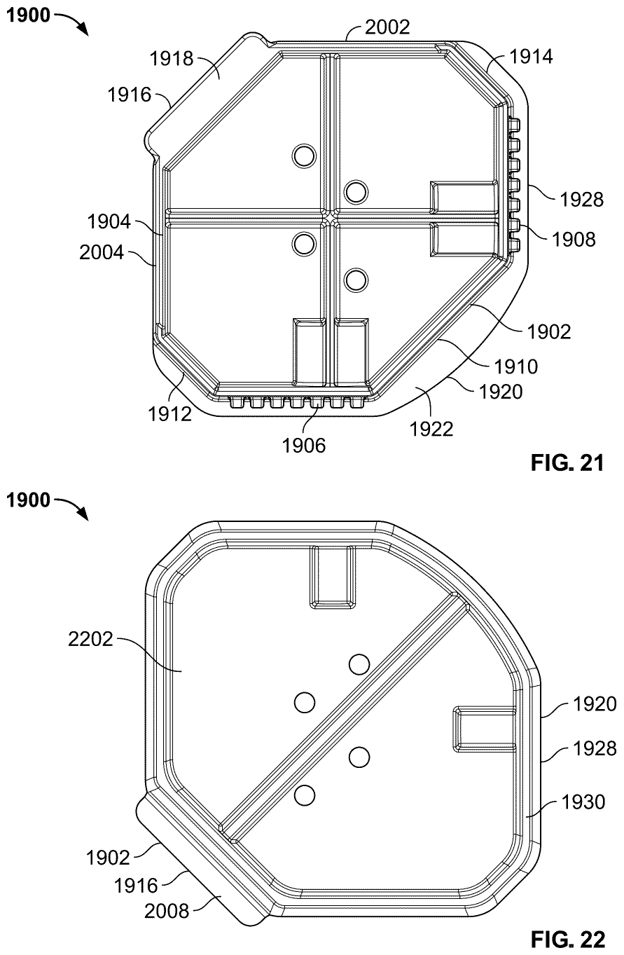

FIG. 19 is a first perspective view of an example support foot 1900 including an example base attachment 1902 configured for use with and/or installation on the base 100 of FIGS. 1-10. FIG. 20 is a second perspective view of the support foot 1900 of FIG. 19. FIG. 21 is a top view of the support foot 1900 of FIGS. 19 and 20. FIG. 22 is a bottom view of the support foot 1900 of FIGS. 19-21. The base attachment 1902 of the support foot 1900 FIGS. 19-22 includes an example upper surface 1904 (e.g., an upper rim), an example lower surface 2202, an example first face 1906, an example second face 1908, an example third face 2002, an example fourth face 2004, an example fifth face 1910, an example sixth face 2006, an example seventh face 1912, and an example eighth face 1914. The upper surface 1904 of the base attachment 1902 of FIGS. 19-22 is configured to face toward, abut, and/or engage the lower surface 1202 of the base 100 of FIGS. 1-10 when the base attachment 1902 of the support foot 1900 is coupled to the base 100, as further described herein. The lower surface 2202 of the base attachment 1902 of the support foot 1900 FIGS. 19-22 is spaced apart from and located opposite to the upper surface 1904 of the base attachment 1902.

In the illustrated example of FIGS. 19-22, the base attachment 1902 of the support foot 1900 has an octagonal shape formed and/or defined by the first face 1906, the second face 1908, the third face 2002, the fourth face 2004, the fifth face 1910, the sixth face 2006, the seventh face 1912, and the eighth face 1914 of the base attachment 1902, with each such face generally extending between the upper surface 1904 and the lower surface 2202 of the base attachment 1902. In this regard, the second face 1908 of the base attachment 1902 of FIGS. 19-22 is perpendicular to the first face 1906 of the base attachment 1902. The third face 2002 of the base attachment 1902 of FIGS. 19-22 is spaced apart from and located opposite to the first face 1906 of the base attachment 1902, with the third face 2002 being parallel to the first face 1906 and perpendicular to the second face 1908 of the base attachment 1902. The fourth face 2004 of the base attachment 1902 of FIGS. 19-22 is spaced apart from and located opposite to the second face 1908 of the base attachment 1902, with the fourth face 2004 being parallel to the second face 1908 and perpendicular to both the first face 1906 and the third face 2002 of the base attachment 1902.

The fifth face 1910 of the base attachment 1902 of FIGS. 19-22 extends between the first face 1906 and the second face 1908 of the base attachment 1902, with the fifth face 1910 being oriented at an angle relative to both the first face 1906 and the second face 1908. In the illustrated example of FIGS. 19-22, the fifth face 1910 of the base attachment 1902 is oriented at an angle of approximately forty-five degrees relative to both the first face 1906 and the second face 1908 of the base attachment 1902. The sixth face 2006 of the base attachment 1902 of FIGS. 19-22 is spaced apart from and located opposite to the fifth face 1910 of the base attachment 1902, with the sixth face 2006 being parallel to the fifth face 1910. The sixth face 2006 of the base attachment 1902 extends between the third face 2002 and the fourth face 2004 of the base attachment 1902, with the sixth face 2006 being oriented at an angle relative to both the third face 2002 and the fourth face 2004. In the illustrated example of FIGS. 19-22, the sixth face 2006 of the base attachment 1902 is oriented at an angle of approximately forty-five degrees relative to both the third face 2002 and the fourth face 2004 of the base attachment 1902. The seventh face 1912 of the base attachment 1902 of FIGS. 19-22 is perpendicular to both the fifth face 1910 and the sixth face 2006 of the base attachment 1902. The seventh face 1912 of the base attachment 1902 extends between the first face 1906 and the fourth face 2004 of the base attachment 1902, with the seventh face 1912 being oriented at an angle relative to both the first face 1906 and the fourth face 2004. In the illustrated example of FIGS. 19-22, the seventh face 1912 of the base attachment 1902 is oriented at an angle of approximately forty-five degrees relative to both the first face 1906 and the fourth face 2004 of the base attachment 1902. The eighth face 1914 of the base attachment 1902 of FIGS. 19-22 is spaced apart from and located opposite to the seventh face 1912 of the base attachment 1902, with the eighth face 1914 being parallel to the seventh face 1912 and perpendicular to both the fifth face 1910 and the sixth face 2006 of the base attachment 1902. The eighth face 1914 of the base attachment 1902 extends between the second face 1908 and the third face 2002 of the base attachment 1902, with the eighth face 1914 being oriented at an angle relative to both the second face 1908 and the third face 2002. In the illustrated example of FIGS. 19-22, the eighth face 1914 of the base attachment 1902 is oriented at an angle of approximately forty-five degrees relative to both the second face 1908 and the third face 2002 of the base attachment 1902.

The base attachment 1902 of the support foot 1900 of FIGS. 19-22 further includes an example tongue 1916 located at and/or adjacent to the upper surface 1904 of the base attachment 1902 along the sixth face 2006 of the base attachment 1902, with the tongue 1916 projecting and/or extending outwardly from (e.g., away from) the sixth face 2006 of the base attachment 1902. The tongue 1916 includes an example upper surface 1918 and an example lower surface 2008, with the lower surface 2008 being located opposite to the upper surface 1918. In the illustrated example of FIGS. 19-22, the upper surface 1918 and the lower surface 2008 of the tongue 1916 are both parallel to the upper surface 1904 of the base attachment 1902, and perpendicular to the sixth face 2006 of the base attachment 1902. As further shown in FIGS. 19-22, the upper surface 1918 of the tongue 1916 is coplanar with the upper surface 1904 of the base attachment 1902. The tongue 1916 of the base attachment 1902 of FIGS. 19-22 is configured to be removably received within a groove of a corner (e.g., the first corner 116, the second corner 118, the third corner 120, or the fourth corner 122) of the base 100 of FIGS. 1-10, as further described herein. The tongue 1916 of the base attachment 1902 of FIGS. 19-22 is further configured such that the lower surface 2008 of the tongue 1916 is supported by a depressed upper surface of the groove of the corner of the base 100 when the base attachment 1902 is coupled to the base 100, as further described herein.

The base attachment 1902 of the support foot 1900 of FIGS. 19-22 further includes an example lip 1920 located at and/or adjacent to the lower surface 2202 of the base attachment 1902 along the first face 1906, the second face 1908, the fifth face 1910, the seventh face 1912, and the eighth face 1914 of the base attachment 1902, with the lip 1920 projecting and/or extending outwardly from (e.g., away from) each such face of the base attachment 1902. The lip 1920 includes an example upper surface 1922. In the illustrated example of FIGS. 19-22, the upper surface 1922 of the lip 1920 is parallel to the upper surface 1904 of the base attachment 1902, and perpendicular to the first face 1906, the second face 1908, the fifth face 1910, the seventh face 1912, and/or the eighth face 1914 of the base attachment 1902. The upper surface 1922 of the lip 1920 of the base attachment 1902 of FIGS. 19-22 is configured to face toward, abut, and/or engage a portion of the lower rim 114 of the base 100 of FIGS. 1-10 located at and/or along a corner (e.g., the first corner 116, the second corner 118, the third corner 120, or the fourth corner 122) of the base 100 when the base attachment 1902 is coupled to the base 100, as further described herein.

The base attachment 1902 of the support foot 1900 of FIGS. 19-22 further includes an example first peripheral opening 1924 and an example second peripheral opening 1926. The first peripheral opening 1924 of the base attachment 1902 is formed in and/or extends through the first face 1906 of the base attachment 1902. The second peripheral opening 1926 of the base attachment 1902 is formed in and/or extends through the second face 1908 of the base attachment 1902. In the illustrated example of FIGS. 19-22, the first peripheral opening 1924 and the second peripheral opening 1926 of the base attachment 1902 are respectively configured to receive corresponding ones of a first fastener and a second fastener, with the first fastener and the second fastener being configured to removably couple the base attachment 1902 to a corner (e.g., the first corner 116, the second corner 118, the third corner 120, or the fourth corner 122) of the base 100 of FIGS. 1-10, as further described herein. In some examples, the first peripheral opening 1924 and the second peripheral opening 1926 of the base attachment 1902 are implemented as threaded openings configured to receive corresponding ones of a first threaded fastener (e.g., a first screw) and a second threaded fastener (e.g., a second screw).

The faces (e.g., the first face 1906, the second face 1908, the third face 2002, the fourth face 2004, the fifth face 1910, the sixth face 2006, the seventh face 1912, and the eighth face 1914), the tongue 1916, the lip 1920, the first peripheral opening 1924, and the second peripheral opening 1926 of the base attachment 1902 of the support foot 1900 of FIGS. 19-22 are individually and/or collectively configured such that the base attachment 1902 of the support foot 1900 can advantageously be removably coupled in an interchangeable manner to any corner (e.g., the first corner 116, the second corner 118, the third corner 120, or the fourth corner 122) of the base 100 of FIGS. 1-10.

For example, the base attachment 1902 of the support foot 1900 FIGS. 19-22 is removably couplable to the first corner 116 of the base 100 of FIGS. 1-10. When the base attachment 1902 is coupled to the first corner 116 of the base 100, the upper surface 1904 of the base attachment 1902 faces toward, abuts, and/or engages the lower surface 1202 of the base 100, the first face 1906 of the base attachment 1902 faces toward, abuts, and/or engages an interior surface of the front portion 126 of the first corner 116, the second face 1908 of the base attachment 1902 faces toward, abuts, and/or otherwise engages an interior surface of the right side portion 128 of the first corner 116, the fifth face 1910 of the base attachment 1902 faces toward, abuts, and/or engages an interior surface of the angled portion 130 of the first corner 116, and the eighth face 1914 of the base attachment 1902 faces toward, abuts, and/or engages an interior surface of the stepped portion 132 of the first corner 116. Coupling the base attachment 1902 to the first corner 116 of the base 100 further causes the tongue 1916 of the base attachment 1902 to be located within the groove 124 of the first corner 116, with lower surface 2008 of the tongue 1916 facing toward, abutting, and/or engaging a depressed upper surface (e.g., structured similar to the depressed upper surface 902 shown in FIGS. 9 and 10) of the groove 124 of the first corner 116. Coupling the base attachment 1902 to the first corner 116 of the base 100 further causes the lip 1920 of the base attachment 1902 to be located adjacent the portion of the lower rim 114 of the base 100 that extends along the first corner 116, with upper surface 1922 of the lip 1920 facing toward, abutting, and/or engaging said portion of the lower rim 114 along the first corner 116.

The base attachment 1902 of the support foot 1900 of FIGS. 19-22 can be removably coupled to the first corner 116 of the base 100 of FIGS. 1-10 via a first fastener and a second fastener. When the base attachment 1902 is coupled to the first corner 116 of the base 100, the first fastener extends through the first peripheral opening 134 of the first corner 116 into the first peripheral opening 1924 of the base attachment 1902, and the second fastener extends through the second peripheral opening 136 of the first corner 116 into the second peripheral opening 1926 of the base attachment 1902. The base attachment 1902 can be coupled and/or attached to the first corner 116 of the base 100 by inserting the first and second fasteners through and/or into (and/or by securing the first and second fasteners within) the aforementioned peripheral openings once the tongue 1916 of the base attachment 1902 has been inserted into the groove 124 of the first corner 116. Conversely, the base attachment 1902 can be uncoupled and/or detached from the first corner 116 of the base 100 by removing the first and second fasteners from (and/or by unsecuring the first and second fasteners from within) the aforementioned peripheral openings, and then removing the tongue 1916 of the base attachment 1902 from the groove 124 of the first corner 116.

As another example, the base attachment 1902 of the support foot 1900 of FIGS. 19-22 is removably couplable to the second corner 118 of the base 100 of FIGS. 1-10. When the base attachment 1902 is coupled to the second corner 118 of the base 100, the upper surface 1904 of the base attachment 1902 faces toward, abuts, and/or engages the lower surface 1202 of the base 100, the first face 1906 of the base attachment 1902 faces toward, abuts, and/or engages an interior surface of the left side portion 142 of the second corner 118, the second face 1908 of the base attachment 1902 faces toward, abuts, and/or otherwise engages an interior surface of the front portion 140 of the second corner 118, the fifth face 1910 of the base attachment 1902 faces toward, abuts, and/or engages an interior surface of the angled portion 144 of the second corner 118, and the seventh face 1912 of the base attachment 1902 faces toward, abuts, and/or engages an interior surface of the stepped portion 146 of the second corner 118. Coupling the base attachment 1902 to the second corner 118 of the base 100 further causes the tongue 1916 of the base attachment 1902 to be located within the groove 138 of the second corner 118, with lower surface 2008 of the tongue 1916 facing toward, abutting, and/or engaging a depressed upper surface (e.g., structured similar to the depressed upper surface 902 shown in FIGS. 9 and 10) of the groove 138 of the second corner 118. Coupling the base attachment 1902 to the second corner 118 of the base 100 further causes the lip 1920 of the base attachment 1902 to be located adjacent the portion of the lower rim 114 of the base 100 that extends along the second corner 118, with upper surface 1922 of the lip 1920 facing toward, abutting, and/or engaging said portion of the lower rim 114 along the second corner 118.

The base attachment 1902 of the support foot 1900 of FIGS. 19-22 can be removably coupled to the second corner 118 of the base 100 of FIGS. 1-10 via a first fastener and a second fastener. When the base attachment 1902 is coupled to the second corner 118 of the base 100, the first fastener extends through the first peripheral opening 204 of the second corner 118 into the first peripheral opening 1924 of the base attachment 1902, and the second fastener extends through the second peripheral opening 148 of the second corner 118 into the second peripheral opening 1926 of the base attachment 1902. The base attachment 1902 can be coupled and/or attached to the second corner 118 of the base 100 by inserting the first and second fasteners through and/or into (and/or by securing the first and second fasteners within) the aforementioned peripheral openings once the tongue 1916 of the base attachment 1902 has been inserted into the groove 138 of the second corner 118. Conversely, the base attachment 1902 can be uncoupled and/or detached from the second corner 118 of the base 100 by removing the first and second fasteners from (and/or by unsecuring the first and second fasteners from within) the aforementioned peripheral openings, and then removing the tongue 1916 of the base attachment 1902 from the groove 138 of the second corner 118.

As yet another example, the base attachment 1902 of the support foot 1900 of FIGS. 19-22 is removably couplable to the third corner 120 of the base 100 of FIGS. 1-10. When the base attachment 1902 is coupled to the third corner 120 of the base 100, the upper surface 1904 of the base attachment 1902 faces toward, abuts, and/or engages the lower surface 1202 of the base 100, the first face 1906 of the base attachment 1902 faces toward, abuts, and/or engages an interior surface of the right side portion 154 of the third corner 120, the second face 1908 of the base attachment 1902 faces toward, abuts, and/or otherwise engages an interior surface of the rear portion 152 of the third corner 120, the fifth face 1910 of the base attachment 1902 faces toward, abuts, and/or engages an interior surface of the angled portion 156 of the third corner 120, and the seventh face 1912 of the base attachment 1902 faces toward, abuts, and/or engages an interior surface of the stepped portion 158 of the third corner 120. Coupling the base attachment 1902 to the third corner 120 of the base 100 further causes the tongue 1916 of the base attachment 1902 to be located within the groove 150 of the third corner 120, with lower surface 2008 of the tongue 1916 facing toward, abutting, and/or engaging the depressed upper surface 902 of the groove 150 of the third corner 120. Coupling the base attachment 1902 to the third corner 120 of the base 100 further causes the lip 1920 of the base attachment 1902 to be located adjacent the portion of the lower rim 114 of the base 100 that extends along the third corner 120, with upper surface 1922 of the lip 1920 facing toward, abutting, and/or engaging said portion of the lower rim 114 along the third corner 120.

The base attachment 1902 of the support foot 1900 of FIGS. 19-22 can be removably coupled to the third corner 120 of the base 100 of FIGS. 1-10 via a first fastener and a second fastener. When the base attachment 1902 is coupled to the third corner 120 of the base 100, the first fastener extends through the first peripheral opening 160 of the third corner 120 into the first peripheral opening 1924 of the base attachment 1902, and the second fastener extends through the second peripheral opening 206 of the third corner 120 into the second peripheral opening 1926 of the base attachment 1902. The base attachment 1902 can be coupled and/or attached to the third corner 120 of the base 100 by inserting the first and second fasteners through and/or into (and/or by securing the first and second fasteners within) the aforementioned peripheral openings once the tongue 1916 of the base attachment 1902 has been inserted into the groove 150 of the third corner 120. Conversely, the base attachment 1902 can be uncoupled and/or detached from the third corner 120 of the base 100 by removing the first and second fasteners from (and/or by unsecuring the first and second fasteners from within) the aforementioned peripheral openings, and then removing the tongue 1916 of the base attachment 1902 from the groove 150 of the third corner 120.

As yet another example, the base attachment 1902 of the support foot 1900 of FIGS. 19-22 is removably couplable to the fourth corner 122 of the base 100 of FIGS. 1-10. When the base attachment 1902 is coupled to the fourth corner 122 of the base 100, the upper surface 1904 of the base attachment 1902 faces toward, abuts, and/or engages the lower surface 1202 of the base 100, the first face 1906 of the base attachment 1902 faces toward, abuts, and/or engages an interior surface of the rear portion 164 of the fourth corner 122, the second face 1908 of the base attachment 1902 faces toward, abuts, and/or otherwise engages an interior surface of the left side portion 166 of the fourth corner 122, the fifth face 1910 of the base attachment 1902 faces toward, abuts, and/or engages an interior surface of the angled portion 168 of the fourth corner 122, and the eighth face 1914 of the base attachment 1902 faces toward, abuts, and/or engages an interior surface of the stepped portion 170 of the fourth corner 122. Coupling the base attachment 1902 to the fourth corner 122 of the base 100 further causes the tongue 1916 of the base attachment 1902 to be located within the groove 162 of the fourth corner 122, with lower surface 2008 of the tongue 1916 facing toward, abutting, and/or engaging a depressed upper surface (e.g., structured similar to the depressed upper surface 902 shown in FIGS. 9 and 10) of the groove 162 of the fourth corner 122. Coupling the base attachment 1902 to the fourth corner 122 of the base 100 further causes the lip 1920 of the base attachment 1902 to be located adjacent the portion of the lower rim 114 of the base 100 that extends along the fourth corner 122, with upper surface 1922 of the lip 1920 facing toward, abutting, and/or engaging said portion of the lower rim 114 along the fourth corner 122.

The base attachment 1902 of the support foot 1900 of FIGS. 19-22 can be removably coupled to the fourth corner 122 of the base 100 of FIGS. 1-10 via a first fastener and a second fastener. When the base attachment 1902 is coupled to the fourth corner 122 of the base 100, the first fastener extends through the first peripheral opening 208 of the fourth corner 122 into the first peripheral opening 1924 of the base attachment 1902, and the second fastener extends through the second peripheral opening 210 of the fourth corner 122 into the second peripheral opening 1926 of the base attachment 1902. The base attachment 1902 can be coupled and/or attached to the fourth corner 122 of the base 100 by inserting the first and second fasteners through and/or into (and/or by securing the first and second fasteners within) the aforementioned peripheral openings once the tongue 1916 of the base attachment 1902 has been inserted into the groove 162 of the fourth corner 122. Conversely, the base attachment 1902 can be uncoupled and/or detached from the fourth corner 122 of the base 100 by removing the first and second fasteners from (and/or by unsecuring the first and second fasteners from within) the aforementioned peripheral openings, and then removing the tongue 1916 of the base attachment 1902 from the groove 162 of the fourth corner 122.

The support foot 1900 of FIGS. 19-22 further includes an example sidewall 1928 terminating in an example lower rim 1930. The sidewall 1928 of the support foot 1900 of FIGS. 19-22 extends downwardly from the lower surface 2202 and/or from the lip 1920 of the base attachment 1902 of the support foot 1900. In the illustrated example of FIGS. 19-22, the sidewall 1928 of the support foot 1900 is integrally formed with and inseparable from the base attachment 1902 of the support foot 1900. In other examples, the support foot 1900 can instead be configured such that the sidewall 1928 of the support foot 1900 is removably couplable (e.g., via one or more fastener(s)) to the base attachment 1902 of the support foot 1900. As discussed above, the base attachment 1902 that forms part of the support foot 1900 of FIGS. 19-22 is configured to be removably coupled in an interchangeable manner to any corner (e.g., the first corner 116, the second corner 118, the third corner 120, or the fourth corner 122) of the base 100 of FIGS. 1-10. The support foot 1900 of FIGS. 19-22 is therefore also configured to be removably coupled in an interchangeable manner to any corner (e.g., the first corner 116, the second corner 118, the third corner 120, or the fourth corner 122) of the base 100 of FIGS. 1-10.

The support foot 1900 of FIGS. 19-22 is further configured such that a height of the support foot 1900 (e.g., measured from the top of the upper surface 1904 of the base attachment 1902 of the support foot 1900 to the bottom of the lower rim 1930 of the sidewall 1928 of the support foot 1900) matches and/or is substantially equal to a height of the first caster assembly 1500 of FIGS. 15 and 16 (e.g., measured from the top of the upper surface 1102 of the base attachment 1100 of the first caster assembly 1500 to the bottom of the wheel 1506 of the first caster assembly 1500), and/or a height of the second caster assembly 1700 of FIGS. 17 and 18 (e.g., measured from the top of the upper surface 1102 of the base attachment 1100 of the second caster assembly 1700 to the bottom of the wheel 1706 of the second caster assembly 1700). Multiple instances and/or various combinations of the first caster assembly 1500 of FIGS. 15 and 16, the second caster assembly 1700 of FIGS. 17 and 18, and/or the support foot 1900 of FIGS. 19-22 can therefore be coupled, concurrently, to respective ones of the first corner 116, the second corner 118, the third corner 120, and the fourth corner the base 100 of FIGS. 1-10 in a manner that causes the upper surface 102 of the base 100 to be maintained in a level state (e.g., parallel) relative to an underlying ground surface that is engaged by the respective ones of the first caster assembly 1500, the second caster assembly 1700, and/or the support foot 1900 when the corresponding base attachments of such structures are coupled to the base 100 and the resultant base assembly is placed on the underlying ground surface.

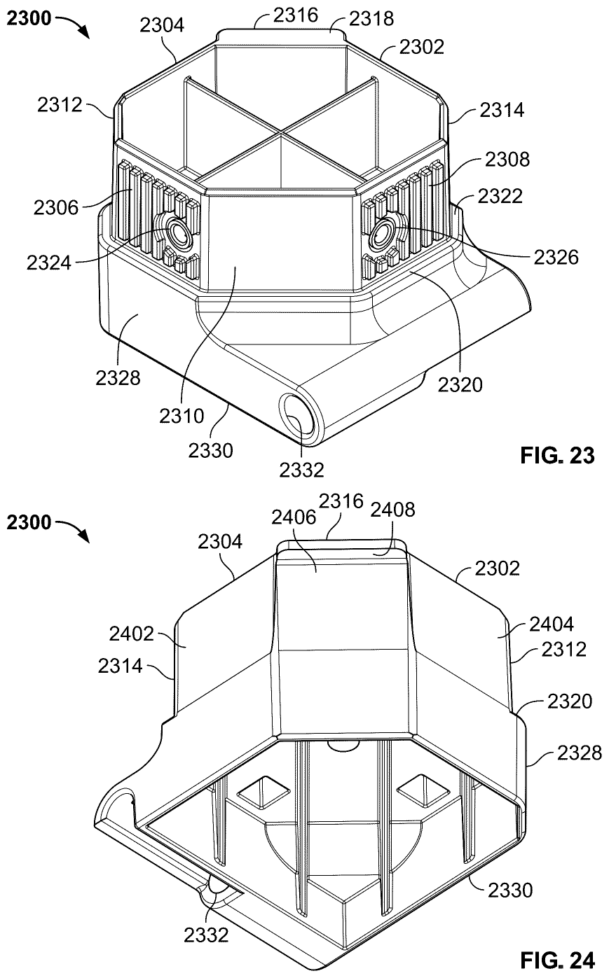

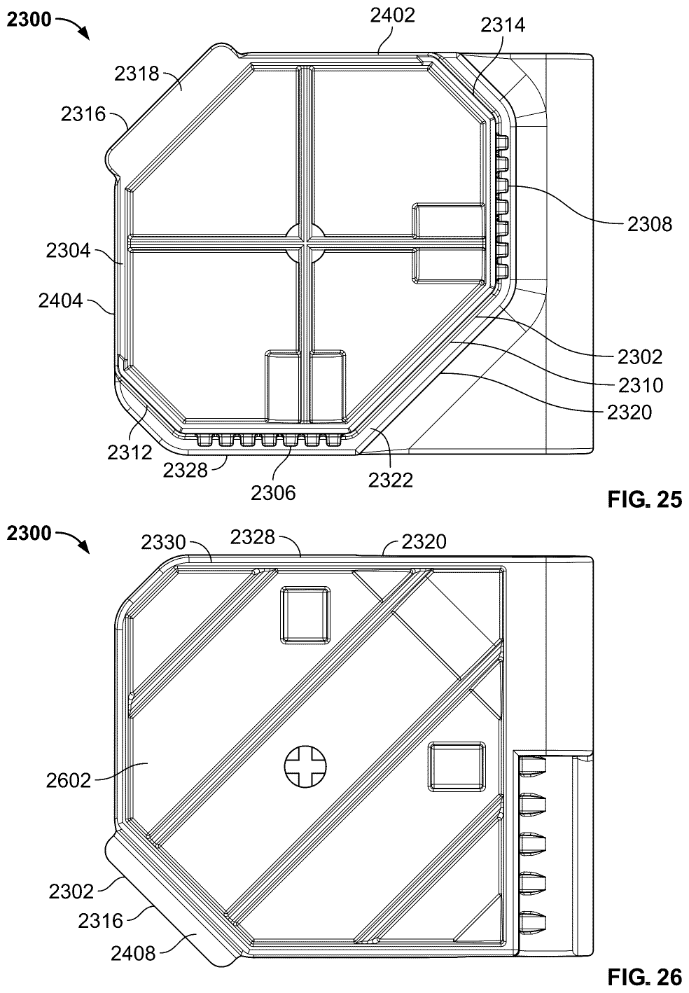

FIG. 23 is a first perspective view of an example first axle mount 2300 of a wheel assembly configured for use with and/or installation on the base 100 of FIGS. 1-10. FIG. 24 is a second perspective view of the first axle mount 2300 of FIG. 23. FIG. 25 is a top view of the first axle mount 2300 of FIGS. 23 and 24. FIG. 26 is a bottom view of the first axle mount 2300 of FIGS. 23-25. The first axle mount 2300 of FIGS. 23-26 include an example base attachment 2302. The base attachment 2302 of the first axle mount 2300 FIGS. 23-26 includes an example upper surface 2304 (e.g., an upper rim), an example lower surface 2602, an example first face 2306, an example second face 2308, an example third face 2402, an example fourth face 2404, an example fifth face 2310, an example sixth face 2406, an example seventh face 2312, and an example eighth face 2314. The upper surface 2304 of the base attachment 2302 of FIGS. 23-26 is configured to face toward, abut, and/or engage the lower surface 1202 of the base 100 of FIGS. 1-10 when the base attachment 2302 of the first axle mount 2300 is coupled to the base 100, as further described herein. The lower surface 2602 of the base attachment 2302 of the first axle mount 2300 FIGS. 23-26 is spaced apart from and located opposite to the upper surface 2304 of the base attachment 2302.

In the illustrated example of FIGS. 23-26, the base attachment 2302 of the first axle mount foot 2300 has an octagonal shape formed and/or defined by the first face 2306, the second face 2308, the third face 2402, the fourth face 2404, the fifth face 2310, the sixth face 2406, the seventh face 2312, and the eighth face 2314 of the base attachment 2302, with each such face generally extending between the upper surface 2304 and the lower surface 2602 of the base attachment 2302. In this regard, the second face 2308 of the base attachment 2302 of FIGS. 23-26 is perpendicular to the first face 2306 of the base attachment 2302. The third face 2402 of the base attachment 2302 of FIGS. 23-26 is spaced apart from and located opposite to the first face 2306 of the base attachment 2302, with the third face 2402 being parallel to the first face 2306 and perpendicular to the second face 2308 of the base attachment 2302. The fourth face 2404 of the base attachment 2302 of FIGS. 23-26 is spaced apart from and located opposite to the second face 2308 of the base attachment 2302, with the fourth face 2404 being parallel to the second face 2308 and perpendicular to both the first face 2306 and the third face 2402 of the base attachment 2302.

The fifth face 2310 of the base attachment 2302 of FIGS. 23-26 extends between the first face 2306 and the second face 2308 of the base attachment 2302, with the fifth face 2310 being oriented at an angle relative to both the first face 2306 and the second face 2308. In the illustrated example of FIGS. 23-26, the fifth face 2310 of the base attachment 2302 is oriented at an angle of approximately forty-five degrees relative to both the first face 2306 and the second face 2308 of the base attachment 2302. The sixth face 2406 of the base attachment 2302 of FIGS. 23-26 is spaced apart from and located opposite to the fifth face 2310 of the base attachment 2302, with the sixth face 2406 being parallel to the fifth face 2310. The sixth face 2406 of the base attachment 2302 extends between the third face 2402 and the fourth face 2404 of the base attachment 2302, with the sixth face 2406 being oriented at an angle relative to both the third face 2402 and the fourth face 2404. In the illustrated example of FIGS. 23-26, the sixth face 2406 of the base attachment 2302 is oriented at an angle of approximately forty-five degrees relative to both the third face 2402 and the fourth face 2404 of the base attachment 2302. The seventh face 2312 of the base attachment 2302 of FIGS. 23-26 is perpendicular to both the fifth face 2310 and the sixth face 2406 of the base attachment 2302. The seventh face 2312 of the base attachment 2302 extends between the first face 2306 and the fourth face 2404 of the base attachment 2302, with the seventh face 2312 being oriented at an angle relative to both the first face 2306 and the fourth face 2404. In the illustrated example of FIGS. 23-26, the seventh face 2312 of the base attachment 2302 is oriented at an angle of approximately forty-five degrees relative to both the first face 2306 and the fourth face 2404 of the base attachment 2302. The eighth face 2314 of the base attachment 2302 of FIGS. 23-26 is spaced apart from and located opposite to the seventh face 2312 of the base attachment 2302, with the eighth face 2314 being parallel to the seventh face 2312 and perpendicular to both the fifth face 2310 and the sixth face 2406 of the base attachment 2302. The eighth face 2314 of the base attachment 2302 extends between the second face 2308 and the third face 2402 of the base attachment 2302, with the eighth face 2314 being oriented at an angle relative to both the second face 2308 and the third face 2402. In the illustrated example of FIGS. 23-26, the eighth face 2314 of the base attachment 2302 is oriented at an angle of approximately forty-five degrees relative to both the second face 2308 and the third face 2402 of the base attachment 2302.

The base attachment 2302 of the first axle mount 2300 of FIGS. 23-26 further includes an example tongue 2316 located at and/or adjacent to the upper surface 2304 of the base attachment 2302 along the sixth face 2406 of the base attachment 2302, with the tongue 2316 projecting and/or extending outwardly from (e.g., away from) the sixth face 2406 of the base attachment 2302. The tongue 2316 includes an example upper surface 2318 and an example lower surface 2408, with the lower surface 2408 being located opposite to the upper surface 2318. In the illustrated example of FIGS. 23-26, the upper surface 2318 and the lower surface 2408 of the tongue 2316 are both parallel to the upper surface 2304 of the base attachment 2302, and perpendicular to the sixth face 2406 of the base attachment 2302. As further shown in FIGS. 23-26, the upper surface 2318 of the tongue 2316 is coplanar with the upper surface 2304 of the base attachment 2302. The tongue 2316 of the base attachment 2302 of FIGS. 23-26 is configured to be removably received within a groove of a corner (e.g., the first corner 116, or the fourth corner 122) of the base 100 of FIGS. 1-10, as further described herein. The tongue 2316 of the base attachment 2302 of FIGS. 23-26 is further configured such that the lower surface 2408 of the tongue 2316 is supported by a depressed upper surface of the groove of the corner of the base 100 when the base attachment 2302 is coupled to the base 100, as further described herein.

The base attachment 2302 of the first axle mount 2300 of FIGS. 23-26 further includes an example lip 2320 located at and/or adjacent to the lower surface 2602 of the base attachment 2302 along the first face 2306, the second face 2308, the fifth face 2310, the seventh face 2312, and the eighth face 2314 of the base attachment 2302, with the lip 2320 projecting and/or extending outwardly from (e.g., away from) each such face of the base attachment 2302. The lip 2320 includes an example upper surface 2322. In the illustrated example of FIGS. 23-26, the upper surface 2322 of the lip 2320 is parallel to the upper surface 2304 of the base attachment 2302, and perpendicular to the first face 2306, the second face 2308, the fifth face 2310, the seventh face 2312, and/or the eighth face 2314 of the base attachment 2302. The upper surface 2322 of the lip 2320 of the base attachment 2302 of FIGS. 23-26 is configured to face toward, abut, and/or engage a portion of the lower rim 114 of the base 100 of FIGS. 1-10 located at and/or along a corner (e.g., the first corner 116, or the fourth corner 122) of the base 100 when the base attachment 2302 is coupled to the base 100, as further described herein.

The base attachment 2302 of the first axle mount 2300 of FIGS. 23-26 further includes an example first peripheral opening 2324 and an example second peripheral opening 2326. The first peripheral opening 2324 of the base attachment 2302 is formed in and/or extends through the first face 2306 of the base attachment 2302. The second peripheral opening 2326 of the base attachment 2302 is formed in and/or extends through the second face 2308 of the base attachment 2302. In the illustrated example of FIGS. 23-26, the first peripheral opening 2324 and the second peripheral opening 2326 of the base attachment 2302 are respectively configured to receive corresponding ones of a first fastener and a second fastener, with the first fastener and the second fastener being configured to removably couple the base attachment 2302 to a corner (e.g., the first corner 116, or the fourth corner 122) of the base 100 of FIGS. 1-10, as further described herein. In some examples, the first peripheral opening 2324 and the second peripheral opening 2326 of the base attachment 2302 are implemented as threaded openings configured to receive corresponding ones of a first threaded fastener (e.g., a first screw) and a second threaded fastener (e.g., a second screw).

The faces (e.g., the first face 2306, the second face 2308, the third face 2402, the fourth face 2404, the fifth face 2310, the sixth face 2406, the seventh face 2312, and the eighth face 2314), the tongue 2316, the lip 2320, the first peripheral opening 2324, and the second peripheral opening 2326 of the base attachment 2302 of the first axle mount 2300 of FIGS. 23-26 are individually and/or collectively configured such that the base attachment 2302 of the first axle mount 2300 can advantageously be removably coupled in an interchangeable manner to two or more corners (e.g., the first corner 116, or the fourth corner 122) of the base 100 of FIGS. 1-10.

For example, the base attachment 2302 of the first axle mount 2300 FIGS. 23-26 is removably couplable to the first corner 116 of the base 100 of FIGS. 1-10. When the base attachment 2302 is coupled to the first corner 116 of the base 100, the upper surface 2304 of the base attachment 2302 faces toward, abuts, and/or engages the lower surface 1202 of the base 100, the first face 2306 of the base attachment 2302 faces toward, abuts, and/or engages an interior surface of the front portion 126 of the first corner 116, the second face 2308 of the base attachment 2302 faces toward, abuts, and/or otherwise engages an interior surface of the right side portion 128 of the first corner 116, the fifth face 2310 of the base attachment 2302 faces toward, abuts, and/or engages an interior surface of the angled portion 130 of the first corner 116, and the eighth face 2314 of the base attachment 2302 faces toward, abuts, and/or engages an interior surface of the stepped portion 132 of the first corner 116. Coupling the base attachment 2302 to the first corner 116 of the base 100 further causes the tongue 2316 of the base attachment 2302 to be located within the groove 124 of the first corner 116, with lower surface 2408 of the tongue 2316 facing toward, abutting, and/or engaging a depressed upper surface (e.g., structured similar to the depressed upper surface 902 shown in FIGS. 9 and 10) of the groove 124 of the first corner 116. Coupling the base attachment 2302 to the first corner 116 of the base 100 further causes the lip 2320 of the base attachment 2302 to be located adjacent the portion of the lower rim 114 of the base 100 that extends along the first corner 116, with upper surface 2322 of the lip 2320 facing toward, abutting, and/or engaging said portion of the lower rim 114 along the first corner 116.

The base attachment 2302 of the first axle mount 2300 of FIGS. 23-26 can be removably coupled to the first corner 116 of the base 100 of FIGS. 1-10 via a first fastener and a second fastener. When the base attachment 2302 is coupled to the first corner 116 of the base 100, the first fastener extends through the first peripheral opening 134 of the first corner 116 into the first peripheral opening 2324 of the base attachment 2302, and the second fastener extends through the second peripheral opening 136 of the first corner 116 into the second peripheral opening 2326 of the base attachment 2302. The base attachment 2302 can be coupled and/or attached to the first corner 116 of the base 100 by inserting the first and second fasteners through and/or into (and/or by securing the first and second fasteners within) the aforementioned peripheral openings once the tongue 2316 of the base attachment 2302 has been inserted into the groove 124 of the first corner 116. Conversely, the base attachment 2302 can be uncoupled and/or detached from the first corner 116 of the base 100 by removing the first and second fasteners from (and/or by unsecuring the first and second fasteners from within) the aforementioned peripheral openings, and then removing the tongue 2316 of the base attachment 2302 from the groove 124 of the first corner 116.

As another example, the base attachment 2302 of the first axle mount 2300 of FIGS. 23-26 is removably couplable to the fourth corner 122 of the base 100 of FIGS. 1-10. When the base attachment 2302 is coupled to the fourth corner 122 of the base 100, the upper surface 2304 of the base attachment 2302 faces toward, abuts, and/or engages the lower surface 1202 of the base 100, the first face 2306 of the base attachment 2302 faces toward, abuts, and/or engages an interior surface of the rear portion 164 of the fourth corner 122, the second face 2308 of the base attachment 2302 faces toward, abuts, and/or otherwise engages an interior surface of the left side portion 166 of the fourth corner 122, the fifth face 2310 of the base attachment 2302 faces toward, abuts, and/or engages an interior surface of the angled portion 168 of the fourth corner 122, and the eighth face 2314 of the base attachment 2302 faces toward, abuts, and/or engages an interior surface of the stepped portion 170 of the fourth corner 122. Coupling the base attachment 2302 to the fourth corner 122 of the base 100 further causes the tongue 2316 of the base attachment 2302 to be located within the groove 162 of the fourth corner 122, with lower surface 2408 of the tongue 2316 facing toward, abutting, and/or engaging a depressed upper surface (e.g., structured similar to the depressed upper surface 902 shown in FIGS. 9 and 10) of the groove 162 of the fourth corner 122. Coupling the base attachment 2302 to the fourth corner 122 of the base 100 further causes the lip 2320 of the base attachment 2302 to be located adjacent the portion of the lower rim 114 of the base 100 that extends along the fourth corner 122, with upper surface 2322 of the lip 2320 facing toward, abutting, and/or engaging said portion of the lower rim 114 along the fourth corner 122.

The base attachment 2302 of the first axle mount 2300 of FIGS. 23-26 can be removably coupled to the fourth corner 122 of the base 100 of FIGS. 1-10 via a first fastener and a second fastener. When the base attachment 2302 is coupled to the fourth corner 122 of the base 100, the first fastener extends through the first peripheral opening 208 of the fourth corner 122 into the first peripheral opening 2324 of the base attachment 2302, and the second fastener extends through the second peripheral opening 210 of the fourth corner 122 into the second peripheral opening 2326 of the base attachment 2302. The base attachment 2302 can be coupled and/or attached to the fourth corner 122 of the base 100 by inserting the first and second fasteners through and/or into (and/or by securing the first and second fasteners within) the aforementioned peripheral openings once the tongue 2316 of the base attachment 2302 has been inserted into the groove 162 of the fourth corner 122. Conversely, the base attachment 1902 can be uncoupled and/or detached from the fourth corner 122 of the base 100 by removing the first and second fasteners from (and/or by unsecuring the first and second fasteners from within) the aforementioned peripheral openings, and then removing the tongue 2316 of the base attachment 2302 from the groove 162 of the fourth corner 122.

The first axle mount 2300 of FIGS. 23-26 further includes an example sidewall 2328 terminating in an example lower rim 2330. The sidewall 2328 of the first axle mount 2300 of FIGS. 23-26 extends downwardly from the lower surface 2602 and/or from the lip 2320 of the base attachment 2302 of the first axle mount 2300. In the illustrated example of FIGS. 23-26, the sidewall 2328 of the first axle mount 2300 is integrally formed with and inseparable from the base attachment 2302 of the first axle mount 2300. In other examples, the first axle mount 2300 can instead be configured such that the sidewall 2328 of the first axle mount 2300 is removably couplable (e.g., via one or more fastener(s)) to the base attachment 2302 of the first axle mount 2300. As discussed above, the base attachment 2302 that forms part of the first axle mount 2300 of FIGS. 23-26 is configured to be removably coupled in an interchangeable manner to two or more corners (e.g., the first corner 116, or the fourth corner 122) of the base 100 of FIGS. 1-10. The first axle mount 2300 of FIGS. 23-26 is therefore also configured to be removably coupled in an interchangeable manner to two or more corners (e.g., the first corner 116, or the fourth corner 122) of the base 100 of FIGS. 1-10.

The first axle mount 2300 of FIGS. 23-26 further includes an example axle opening 2332 configured to receive an end (e.g., a first end) of an axle of a wheel assembly, as further described herein. In the illustrated example of FIGS. 23-26, the axle opening 2332 of the first axle mount 2300 is formed in and extends through the sidewall 2328 of the first axle mount 2300, with the axle opening 2332 extending in a horizontal direction that is parallel to and generally located along the second face 2308 of the base attachment 2302 of the first axle mount 2300.

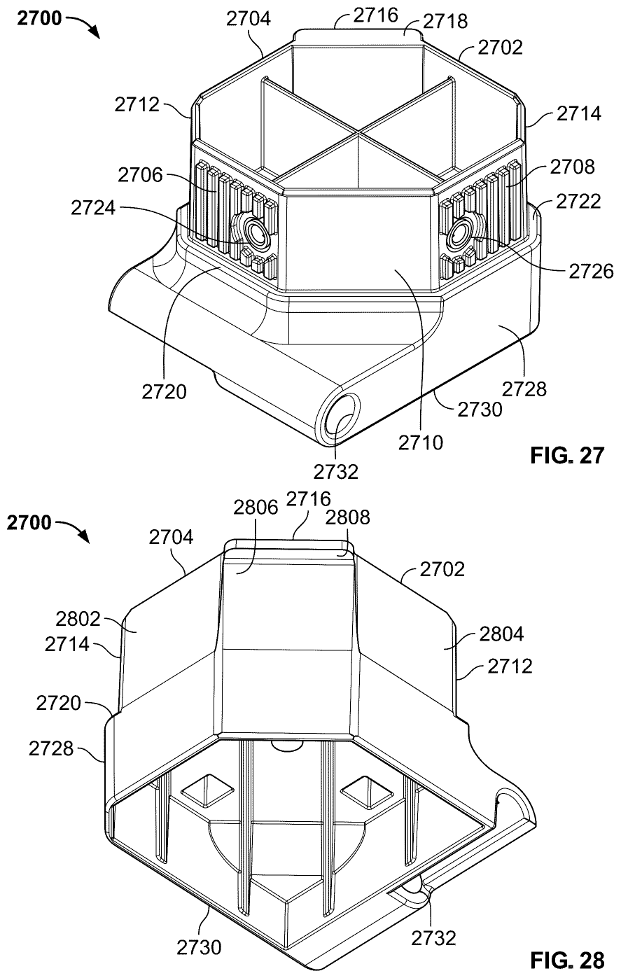

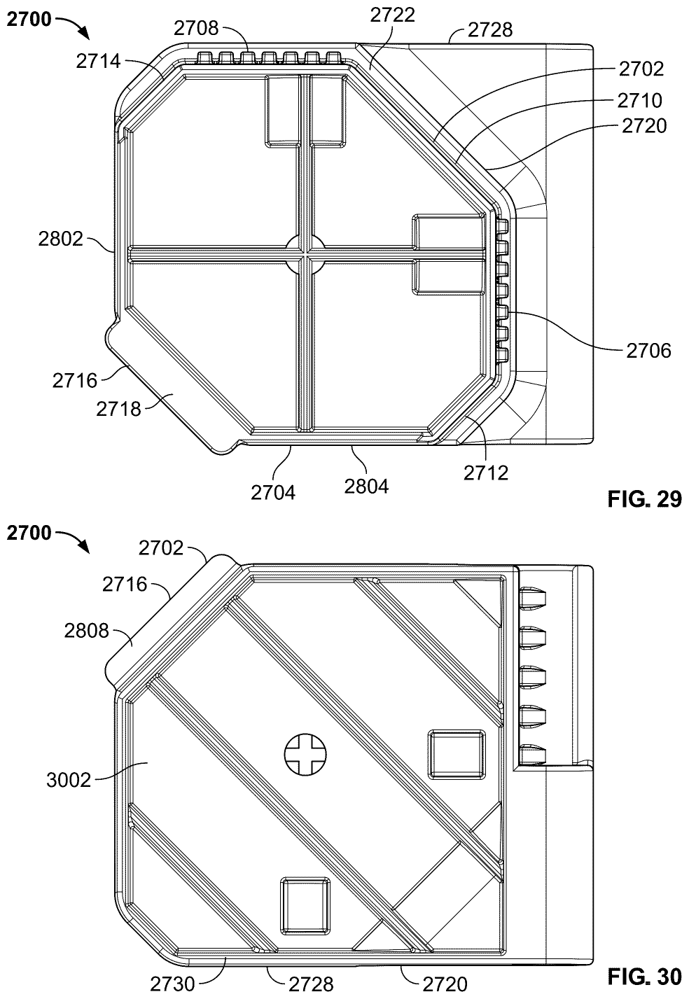

FIG. 27 is a first perspective view of an example second axle mount 2700 of a wheel assembly configured for use with and/or installation on the base 100 of FIGS. 1-10. FIG. 28 is a second perspective view of the second axle mount 2700 of FIG. 27. FIG. 29 is a top view of the second axle mount 2700 of FIGS. 27 and 28. FIG. 30 is a bottom view of the second axle mount 2700 of FIGS. 27-29. The second axle mount 2700 of FIGS. 27-30 include an example base attachment 2702. The base attachment 2702 of the second axle mount 2700 FIGS. 27-30 includes an example upper surface 2704 (e.g., an upper rim), an example lower surface 3002, an example first face 2706, an example second face 2708, an example third face 2802, an example fourth face 2804, an example fifth face 2710, an example sixth face 2806, an example seventh face 2712, and an example eighth face 2714. The upper surface 2704 of the base attachment 2702 of FIGS. 27-30 is configured to face toward, abut, and/or engage the lower surface 1202 of the base 100 of FIGS. 1-10 when the base attachment 2702 of the second axle mount 2700 is coupled to the base 100, as further described herein. The lower surface 3002 of the base attachment 2702 of the second axle mount 2700 FIGS. 27-30 is spaced apart from and located opposite to the upper surface 2704 of the base attachment 2702.

In the illustrated example of FIGS. 27-30, the base attachment 2702 of the second axle mount foot 2700 has an octagonal shape formed and/or defined by the first face 2706, the second face 2708, the third face 2802, the fourth face 2804, the fifth face 2710, the sixth face 2806, the seventh face 2712, and the eighth face 2714 of the base attachment 2702, with each such face generally extending between the upper surface 2704 and the lower surface 3002 of the base attachment 2702. In this regard, the second face 2708 of the base attachment 2702 of FIGS. 27-30 is perpendicular to the first face 2706 of the base attachment 2702. The third face 2802 of the base attachment 2702 of FIGS. 27-30 is spaced apart from and located opposite to the first face 2706 of the base attachment 2702, with the third face 2802 being parallel to the first face 2706 and perpendicular to the second face 2708 of the base attachment 2702. The fourth face 2804 of the base attachment 2702 of FIGS. 27-30 is spaced apart from and located opposite to the second face 2708 of the base attachment 2702, with the fourth face 2804 being parallel to the second face 2708 and perpendicular to both the first face 2706 and the third face 2802 of the base attachment 2702.

The fifth face 2710 of the base attachment 2702 of FIGS. 27-30 extends between the first face 2706 and the second face 2708 of the base attachment 2702, with the fifth face 2710 being oriented at an angle relative to both the first face 2706 and the second face 2708. In the illustrated example of FIGS. 27-30, the fifth face 2710 of the base attachment 2702 is oriented at an angle of approximately forty-five degrees relative to both the first face 2706 and the second face 2708 of the base attachment 2702. The sixth face 2806 of the base attachment 2702 of FIGS. 27-30 is spaced apart from and located opposite to the fifth face 2710 of the base attachment 2702, with the sixth face 2806 being parallel to the fifth face 2710. The sixth face 2806 of the base attachment 2702 extends between the third face 2802 and the fourth face 2804 of the base attachment 2702, with the sixth face 2806 being oriented at an angle relative to both the third face 2802 and the fourth face 2804. In the illustrated example of FIGS. 27-30, the sixth face 2806 of the base attachment 2702 is oriented at an angle of approximately forty-five degrees relative to both the third face 2802 and the fourth face 2804 of the base attachment 2702. The seventh face 2712 of the base attachment 2702 of FIGS. 27-30 is perpendicular to both the fifth face 2710 and the sixth face 2806 of the base attachment 2702. The seventh face 2712 of the base attachment 2702 extends between the first face 2706 and the fourth face 2804 of the base attachment 2702, with the seventh face 2712 being oriented at an angle relative to both the first face 2706 and the fourth face 2804. In the illustrated example of FIGS. 27-30, the seventh face 2712 of the base attachment 2702 is oriented at an angle of approximately forty-five degrees relative to both the first face 2706 and the fourth face 2804 of the base attachment 2702. The eighth face 2714 of the base attachment 2702 of FIGS. 27-30 is spaced apart from and located opposite to the seventh face 2712 of the base attachment 2702, with the eighth face 2714 being parallel to the seventh face 2712 and perpendicular to both the fifth face 2710 and the sixth face 2806 of the base attachment 2702. The eighth face 2714 of the base attachment 2702 extends between the second face 2708 and the third face 2802 of the base attachment 2702, with the eighth face 2714 being oriented at an angle relative to both the second face 2708 and the third face 2802. In the illustrated example of FIGS. 27-30, the eighth face 2714 of the base attachment 2702 is oriented at an angle of approximately forty-five degrees relative to both the second face 2708 and the third face 2802 of the base attachment 2702.

The base attachment 2702 of the second axle mount 2700 of FIGS. 27-30 further includes an example tongue 2716 located at and/or adjacent to the upper surface 2704 of the base attachment 2702 along the sixth face 2806 of the base attachment 2702, with the tongue 2716 projecting and/or extending outwardly from (e.g., away from) the sixth face 2806 of the base attachment 2702. The tongue 2716 includes an example upper surface 2718 and an example lower surface 2808, with the lower surface 2808 being located opposite to the upper surface 2718. In the illustrated example of FIGS. 27-30, the upper surface 2718 and the lower surface 2808 of the tongue 2716 are both parallel to the upper surface 2704 of the base attachment 2702, and perpendicular to the sixth face 2806 of the base attachment 2702. As further shown in FIGS. 27-30, the upper surface 2718 of the tongue 2716 is coplanar with the upper surface 2704 of the base attachment 2702. The tongue 2716 of the base attachment 2702 of FIGS. 27-30 is configured to be removably received within a groove of a corner (e.g., the second corner 118, or the third corner 120) of the base 100 of FIGS. 1-10, as further described herein. The tongue 2716 of the base attachment 2702 of FIGS. 27-30 is further configured such that the lower surface 2808 of the tongue 2716 is supported by a depressed upper surface of the groove of the corner of the base 100 when the base attachment 2702 is coupled to the base 100, as further described herein.

The base attachment 2702 of the second axle mount 2700 of FIGS. 27-30 further includes an example lip 2720 located at and/or adjacent to the lower surface 3002 of the base attachment 2702 along the first face 2706, the second face 2708, the fifth face 2710, the seventh face 2712, and the eighth face 2714 of the base attachment 2702, with the lip 2720 projecting and/or extending outwardly from (e.g., away from) each such face of the base attachment 2702. The lip 2720 includes an example upper surface 2722. In the illustrated example of FIGS. 27-30, the upper surface 2722 of the lip 2720 is parallel to the upper surface 2704 of the base attachment 2702, and perpendicular to the first face 2706, the second face 2708, the fifth face 2710, the seventh face 2712, and/or the eighth face 2714 of the base attachment 2702. The upper surface 2722 of the lip 2720 of the base attachment 2702 of FIGS. 27-30 is configured to face toward, abut, and/or engage a portion of the lower rim 114 of the base 100 of FIGS. 1-10 located at and/or along a corner (e.g., the second corner 118, or the third corner 120) of the base 100 when the base attachment 2702 is coupled to the base 100, as further described herein.

The base attachment 2702 of the second axle mount 2700 of FIGS. 27-30 further includes an example first peripheral opening 2724 and an example second peripheral opening 2726. The first peripheral opening 2724 of the base attachment 2702 is formed in and/or extends through the first face 2706 of the base attachment 2702. The second peripheral opening 2726 of the base attachment 2702 is formed in and/or extends through the second face 2708 of the base attachment 2702. In the illustrated example of FIGS. 27-30, the first peripheral opening 2724 and the second peripheral opening 2726 of the base attachment 2702 are respectively configured to receive corresponding ones of a first fastener and a second fastener, with the first fastener and the second fastener being configured to removably couple the base attachment 2702 to a corner (e.g., the second corner 118, or the third corner 120) of the base 100 of FIGS. 1-10, as further described herein. In some examples, the first peripheral opening 2724 and the second peripheral opening 2726 of the base attachment 2702 are implemented as threaded openings configured to receive corresponding ones of a first threaded fastener (e.g., a first screw) and a second threaded fastener (e.g., a second screw).

The faces (e.g., the first face 2706, the second face 2708, the third face 2802, the fourth face 2804, the fifth face 2710, the sixth face 2806, the seventh face 2712, and the eighth face 2714), the tongue 2716, the lip 2720, the first peripheral opening 2724, and the second peripheral opening 2726 of the base attachment 2702 of the second axle mount 2700 of FIGS. 27-30 are individually and/or collectively configured such that the base attachment 2702 of the second axle mount 2700 can advantageously be removably coupled in an interchangeable manner to two or more corners (e.g., the second corner 118, or the third corner 120) of the base 100 of FIGS. 1-10.

For example, the base attachment 2702 of the second axle mount 2700 FIGS. 27-30 is removably couplable to the second corner 118 of the base 100 of FIGS. 1-10. When the base attachment 2702 is coupled to the second corner 118 of the base 100, the upper surface 2704 of the base attachment 2702 faces toward, abuts, and/or engages the lower surface 1202 of the base 100, the first face 2706 of the base attachment 2702 faces toward, abuts, and/or engages an interior surface of the left side portion 142 of the second corner 118, the second face 2708 of the base attachment 2702 faces toward, abuts, and/or otherwise engages an interior surface of the front portion 140 of the second corner 118, the fifth face 2710 of the base attachment 2702 faces toward, abuts, and/or engages an interior surface of the angled portion 144 of the second corner 118, and the seventh face 2712 of the base attachment 2702 faces toward, abuts, and/or engages an interior surface of the stepped portion 146 of the second corner 118. Coupling the base attachment 2702 to the second corner 118 of the base 100 further causes the tongue 2716 of the base attachment 2702 to be located within the groove 138 of the second corner 118, with lower surface 2808 of the tongue 2716 facing toward, abutting, and/or engaging a depressed upper surface (e.g., structured similar to the depressed upper surface 902 shown in FIGS. 9 and 10) of the groove 138 of the second corner 118. Coupling the base attachment 2702 to the second corner 118 of the base 100 further causes the lip 2720 of the base attachment 2702 to be located adjacent the portion of the lower rim 114 of the base 100 that extends along the second corner 118, with upper surface 2722 of the lip 2720 facing toward, abutting, and/or engaging said portion of the lower rim 114 along the second corner 118.

The base attachment 2702 of the second axle mount 2700 of FIGS. 27-30 can be removably coupled to the second corner 118 of the base 100 of FIGS. 1-10 via a first fastener and a second fastener. When the base attachment 2702 is coupled to the second corner 118 of the base 100, the first fastener extends through the first peripheral opening 204 of the second corner 118 into the first peripheral opening 2724 of the base attachment 2702, and the second fastener extends through the second peripheral opening 148 of the second corner 118 into the second peripheral opening 2726 of the base attachment 2702. The base attachment 2702 can be coupled and/or attached to the second corner 118 of the base 100 by inserting the first and second fasteners through and/or into (and/or by securing the first and second fasteners within) the aforementioned peripheral openings once the tongue 2716 of the base attachment 2702 has been inserted into the groove 138 of the second corner 118. Conversely, the base attachment 2702 can be uncoupled and/or detached from the second corner 118 of the base 100 by removing the first and second fasteners from (and/or by unsecuring the first and second fasteners from within) the aforementioned peripheral openings, and then removing the tongue 2716 of the base attachment 2702 from the groove 138 of the second corner 118.

As another example, the base attachment 2702 of the second axle mount 2700 FIGS. 27-30 is removably couplable to the third corner 120 of the base 100 of FIGS. 1-10. When the base attachment 2702 is coupled to the third corner 120 of the base 100, the upper surface 2704 of the base attachment 2702 faces toward, abuts, and/or engages the lower surface 1202 of the base 100, the first face 2706 of the base attachment 2702 faces toward, abuts, and/or engages an interior surface of the right side portion 154 of the third corner 120, the second face 2708 of the base attachment 2702 faces toward, abuts, and/or otherwise engages an interior surface of the rear portion 152 of the third corner 120, the fifth face 2710 of the base attachment 2702 faces toward, abuts, and/or engages an interior surface of the angled portion 156 of the third corner 120, and the seventh face 2712 of the base attachment 2702 faces toward, abuts, and/or engages an interior surface of the stepped portion 158 of the third corner 120. Coupling the base attachment 2702 to the third corner 120 of the base 100 further causes the tongue 2716 of the base attachment 2702 to be located within the groove 150 of the third corner 120, with lower surface 2808 of the tongue 2716 facing toward, abutting, and/or engaging the depressed upper surface 902 of the groove 150 of the third corner 120. Coupling the base attachment 2702 to the third corner 120 of the base 100 further causes the lip 2720 of the base attachment 2702 to be located adjacent the portion of the lower rim 114 of the base 100 that extends along the third corner 120, with upper surface 2722 of the lip 2720 facing toward, abutting, and/or engaging said portion of the lower rim 114 along the third corner 120.

The base attachment 2702 of the second axle mount 2700 of FIGS. 27-30 can be removably coupled to the third corner 120 of the base 100 of FIGS. 1-10 via a first fastener and a second fastener. When the base attachment 2702 is coupled to the third corner 120 of the base 100, the first fastener extends through the first peripheral opening 160 of the third corner 120 into the first peripheral opening 2724 of the base attachment 2702, and the second fastener extends through the second peripheral opening 206 of the third corner 120 into the second peripheral opening 2726 of the base attachment 2702. The base attachment 2702 can be coupled and/or attached to the third corner 120 of the base 100 by inserting the first and second fasteners through and/or into (and/or by securing the first and second fasteners within) the aforementioned peripheral openings once the tongue 2716 of the base attachment 2702 has been inserted into the groove 150 of the third corner 120. Conversely, the base attachment 2702 can be uncoupled and/or detached from the third corner 120 of the base 100 by removing the first and second fasteners from (and/or by unsecuring the first and second fasteners from within) the aforementioned peripheral openings, and then removing the tongue 2716 of the base attachment 2702 from the groove 150 of the third corner 120.

The second axle mount 2700 of FIGS. 27-30 further includes an example sidewall 2728 terminating in an example lower rim 2730. The sidewall 2728 of the second axle mount 2700 of FIGS. 27-30 extends downwardly from the lower surface 3002 and/or from the lip 2720 of the base attachment 2702 of the second axle mount 2700. In the illustrated example of FIGS. 27-30, the sidewall 2728 of the second axle mount 2700 is integrally formed with and inseparable from the base attachment 2702 of the second axle mount 2700. In other examples, the second axle mount 2700 can instead be configured such that the sidewall 2728 of the second axle mount 2700 is removably couplable (e.g., via one or more fastener(s)) to the base attachment 2702 of the second axle mount 2700. As discussed above, the base attachment 2702 that forms part of the second axle mount 2700 of FIGS. 27-30 is configured to be removably coupled in an interchangeable manner to two or more corners (e.g., the second corner 118, or the third corner 120) of the base 100 of FIGS. 1-10. The second axle mount 2700 of FIGS. 27-30 is therefore also configured to be removably coupled in an interchangeable manner to two or more corners (e.g., the second corner 118, or the third corner 120) of the base 100 of FIGS. 1-10.

The second axle mount 2700 of FIGS. 27-30 further includes an example axle opening 2732 configured to receive an end (e.g., a second end) of an axle of a wheel assembly, as further described herein. In the illustrated example of FIGS. 27-30, the axle opening 2732 of the second axle mount 2700 is formed in and extends through the sidewall 2728 of the second axle mount 2700, with the axle opening 2732 extending in a horizontal direction that is parallel to and generally located along the first face 2706 of the base attachment 2702 of the second axle mount 2700.

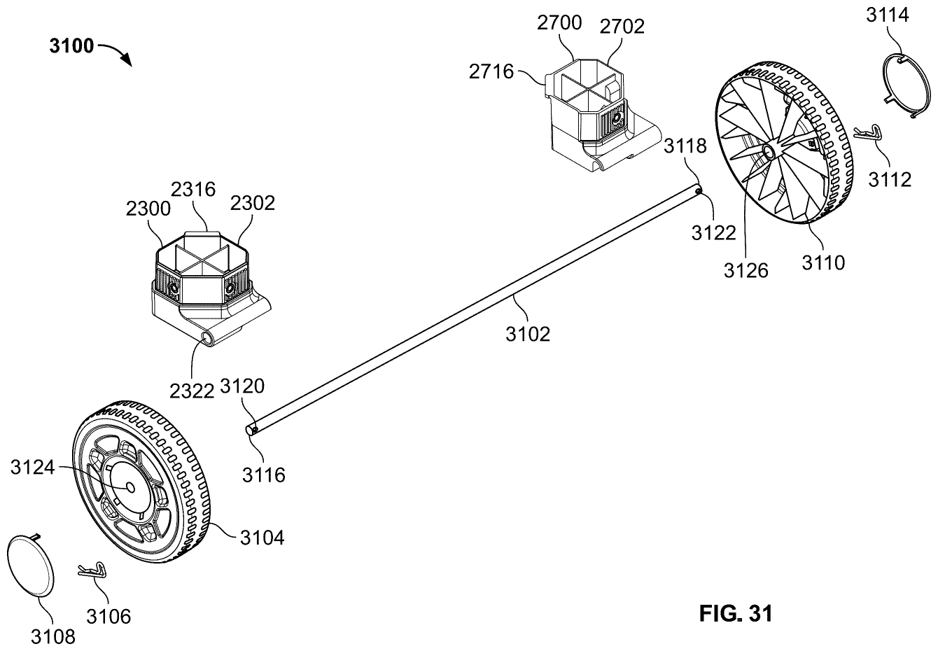

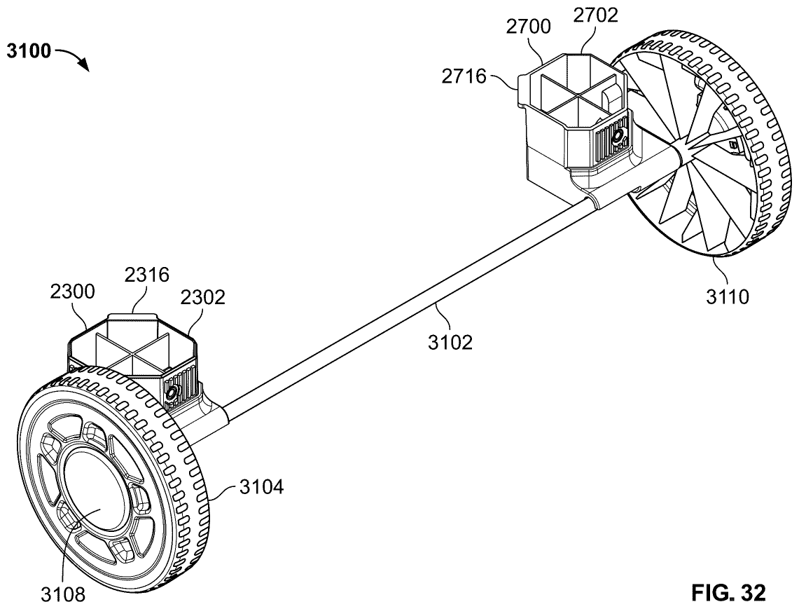

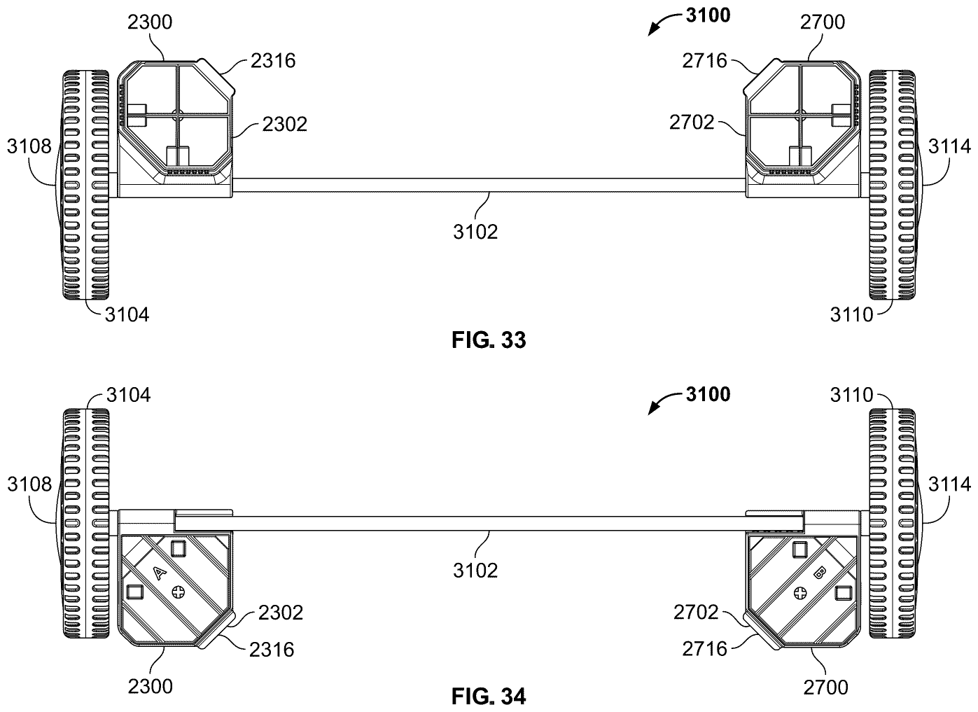

FIG. 31 is an exploded view of an example wheel assembly 3100 including the first axle mount 2300 of FIGS. 23-26 and the second axle mount 2700 of FIGS. 27-30, and configured for use with an/or installation on the base 100 of FIGS. 1-10. FIG. 32 is a perspective view of the wheel assembly 3100 of FIG. 31, with the wheel assembly 3100 shown in an assembled state. FIG. 33 is a top view of the wheel assembly 3100 of FIG. 32. FIG. 34 is a bottom view of the wheel assembly 3100 of FIGS. 32 and 33. The wheel assembly 3100 of FIGS. 31-34 includes the first axle mount 2300, the second axle mount 2700, an example wheel axle 3102, an example first all-terrain wheel 3104, an example first cotter pin 3106, an example first hub cover 3108, an example second all-terrain wheel 3110, an example second cotter pin 3112, and an example second hub cover 3114. The wheel axle 3102 of the wheel assembly 3100 includes an example first end 3116, an example second end 3118 located opposite to the first end 3116, an example first cotter pin opening 3120 located proximate to the first end 3116, and an example second cotter pin opening 3122 located proximate to the second end 3118. The first cotter pin opening 3120 and the second cotter pin opening 3122 extend radially through the wheel axle 3102 and are respectively configured to receive corresponding ones of the first cotter pin 3106 and the second cotter pin 3112, as further described herein.

When the wheel assembly 3100 of FIGS. 31-34 is in the assembled state (e.g., as shown in FIGS. 32-34), the first end 3116 of the wheel axle 3102 extends through the axle opening 2332 of the base attachment 2302 of the first axle mount 2300, and further extends through an example axial opening 3124 formed in the first all-terrain wheel 3104. The first all-terrain wheel 3104 and the first axle mount 2300 are secured on the wheel axle 3102 via insertion of the first cotter pin 3106 through the first cotter pin opening 3120 of the wheel axle 3102. The first cotter pin 3106 is shielded and/or covered via attachment (e.g., snap fit attachment) of the first hub cover 3108 to a hub of the first all-terrain wheel 3104, as shown in FIGS. 32-34. Similarly, when the wheel assembly 3100 of FIGS. 31-34 is in the assembled state (e.g., as shown in FIGS. 32-34), the second end 3118 of the wheel axle 3102 extends through the axle opening 2732 of the base attachment 2702 of the second axle mount 2700, and further extends through an example axial opening 3126 formed in the second all-terrain wheel 3110. The second all-terrain wheel 3110 and the second axle mount 2700 are secured on the wheel axle 3102 via insertion of the second cotter pin 3112 through the second cotter pin opening 3122 of the wheel axle 3102. The second cotter pin 3112 is shielded and/or covered via attachment (e.g., snap fit attachment) of the second hub cover 3114 to a hub of the second all-terrain wheel 3110, as shown in FIGS. 32-34.

When the wheel assembly 3100 of FIGS. 31-34 is in the assembled state (e.g., as shown in FIGS. 32-34), the wheel assembly is removably couplable to one of two sets of the corners of the base 100 of FIGS. 1-10. For example, the wheel assembly 3100 of FIGS. 31-34 is removably couplable to the first corner 116 and the third corner 120 of the base 100 of FIGS. 1-10 such that the wheel assembly 3100 generally extends along and/or is generally located along the right side surface 108 of the base 100 (e.g., a right side configuration of the wheel assembly 3100). When the wheel assembly 3100 is coupled to the first corner 116 and the third corner 120 of the base 100, the base attachment 2302 of the first axle mount 2300 of FIGS. 23-26 and 31-34 is coupled to the first corner 116 of the base 100, and the base attachment 2702 of the second axle mount 2700 of FIGS. 27-30 and FIGS. 31-34 is coupled to the third corner 120 of the base 100, both as described above. As another example, the wheel assembly 3100 of FIGS. 31-34 is removably couplable to the second corner 118 and the fourth corner 122 of the base 100 of FIGS. 1-10 such that the wheel assembly 3100 generally extends along and/or is generally located along the left side surface 110 of the base 100 (e.g., a left side configuration of the wheel assembly 3100). When the wheel assembly 3100 is coupled to the second corner 118 and the fourth corner 122 of the base 100, the base attachment 2302 of the first axle mount 2300 of FIGS. 23-26 and 31-34 is coupled to the fourth corner 122 of the base 100, and the base attachment 2702 of the second axle mount 2700 of FIGS. 27-30 and FIGS. 31-34 is coupled to the second corner 118 of the base 100, both as described above.

The wheel assembly 3100 of FIGS. 31-34 is further configured such that a height of the wheel assembly 3100 (e.g., measured from the top of the upper surface 2304 of the base attachment 2302 of the first axle mount 2300 to the bottom of the first all-terrain wheel 3104 of the wheel assembly 3100, or alternatively measured from the top of the upper surface 2704 of the base attachment 2702 of the second axle mount 2700 to the bottom of the second all-terrain wheel 3110 of the wheel assembly 3100) matches and/or is substantially equal to a height of the first caster assembly 1500 of FIGS. 15 and 16 (e.g., measured from the top of the upper surface 1102 of the base attachment 1100 of the first caster assembly 1500 to the bottom of the wheel 1506 of the first caster assembly 1500), a height of the second caster assembly 1700 of FIGS. 17 and 18 (e.g., measured from the top of the upper surface 1102 of the base attachment 1100 of the second caster assembly 1700 to the bottom of the wheel 1706 of the second caster assembly 1700), and/or a height of the support foot 1900 of FIGS. 19-22 (e.g., measured from the top of the upper surface 1904 of the base attachment 1902 of the support foot 1900 to the bottom of the lower rim 1930 of the sidewall 1928 of the support foot 1900). Multiple instances and/or various combinations of the first caster assembly 1500 of FIGS. 15 and 16, the second caster assembly 1700 of FIGS. 17 and 18, the support foot 1900 of FIGS. 19-22, and/or the wheel assembly 3100 of FIGS. 31-34 can therefore be coupled, concurrently, to respective ones of the first corner 116, the second corner 118, the third corner 120, and the fourth corner the base 100 of FIGS. 1-10 in a manner that causes the upper surface 102 of the base 100 to be maintained in a level state (e.g., parallel) relative to an underlying ground surface that is engaged by the respective ones of the first caster assembly 1500, the second caster assembly 1700, the support foot 1900, and/or the wheel assembly 3100 when the corresponding base attachments of such structures are coupled to the base 100 and the resultant base assembly is placed on the underlying ground surface.

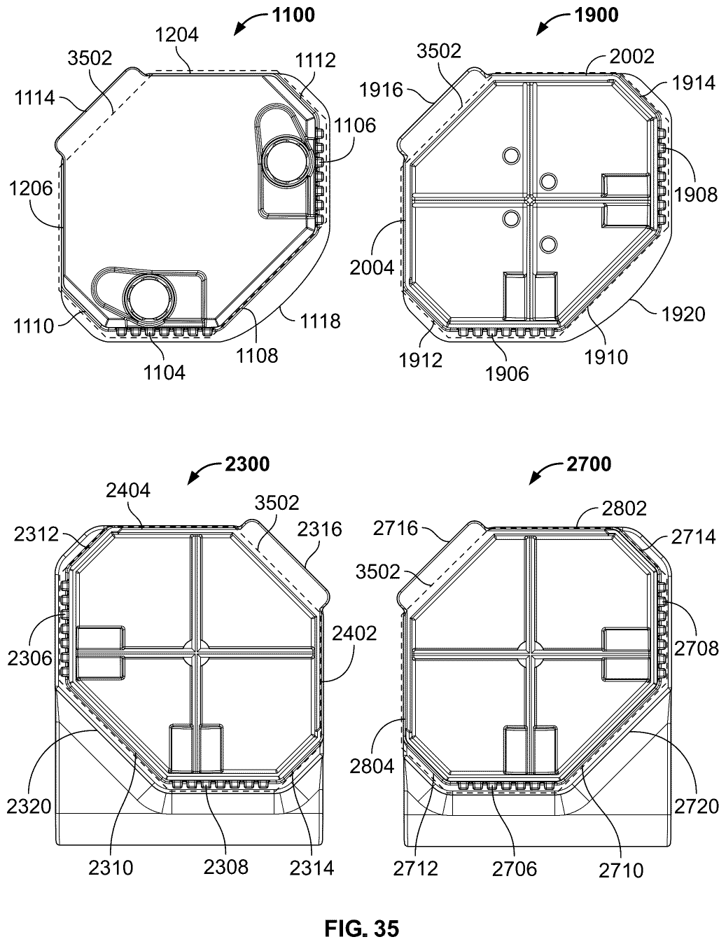

FIG. 35 provides top views of the base attachment 1100 of FIGS. 11-14, the support foot 1900 of FIGS. 19-22, the first axle mount 2300 of FIGS. 23-26, and the second axle mount 2700 of FIGS. 27-30. As shown in FIG. 35 and further described above, the base attachment 1100 of FIGS. 11-14, the base attachment 1902 of the support foot 1900 of FIGS. 19-22, the base attachment 2302 of the first axle mount 2300 of FIGS. 23-26, and the base attachment 2702 of the second axle mount 2700 of FIGS. 27-30 each have a substantially identical and/or matching example octagonal shape 3502 (e.g., defined by the eight faces of each such base attachment) that enables respective ones of the base attachment 1100 of FIGS. 11-14, the support foot 1900 of FIGS. 19-22, and the wheel assembly 3100 of FIGS. 31-34 to be removably coupled to the base 100 of FIGS. 1-10 in an interchangeable manner. Modular base assemblies including the base 100 of FIGS. 1-10 and different numbers and/or different combinations of the base attachment 1100 of FIGS. 11-14, the support foot 1900 of FIGS. 19-22, and/or the wheel assembly 3100 of FIGS. 31-34 can therefore be formed, as further described herein. The modular and/or interchangeable nature of the aforementioned components advantageously provides a user with the ability to customize the base assembly of a cart of a grill to suit the intended use case for the grill (e.g., a cart placed on smooth pavement, a cart placed on rough and/or uneven terrain, etc.) and/or the desires of the user in relation thereto. For example, the user may desire for the cart of the grill to include: (a) one or more non-locking caster(s); (b) one or more locking caster(s); (c) one or more support foot/feet; and/or (d) one or more all-terrain wheel assembly/assemblies.

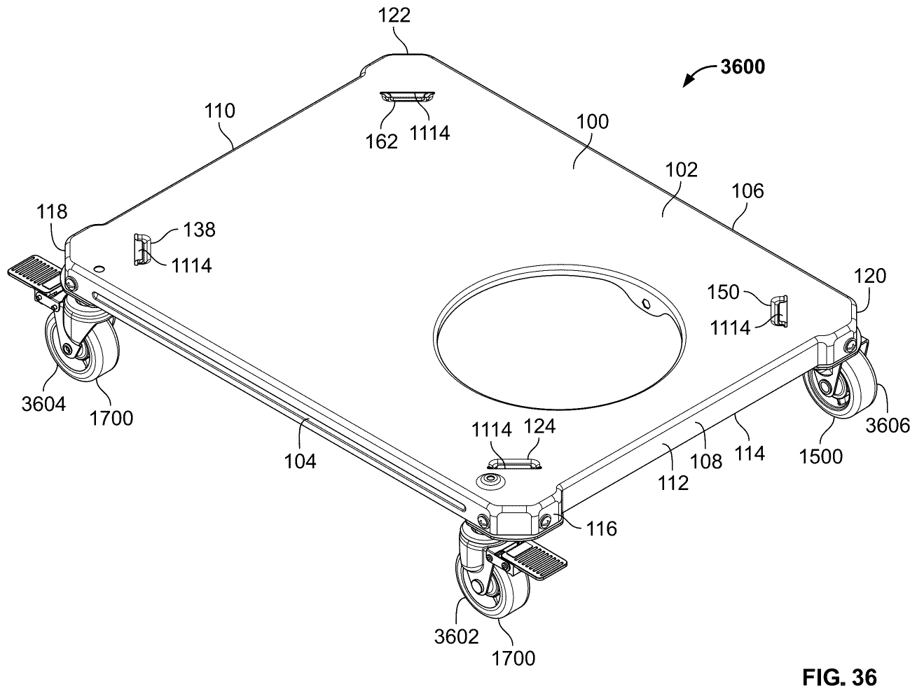

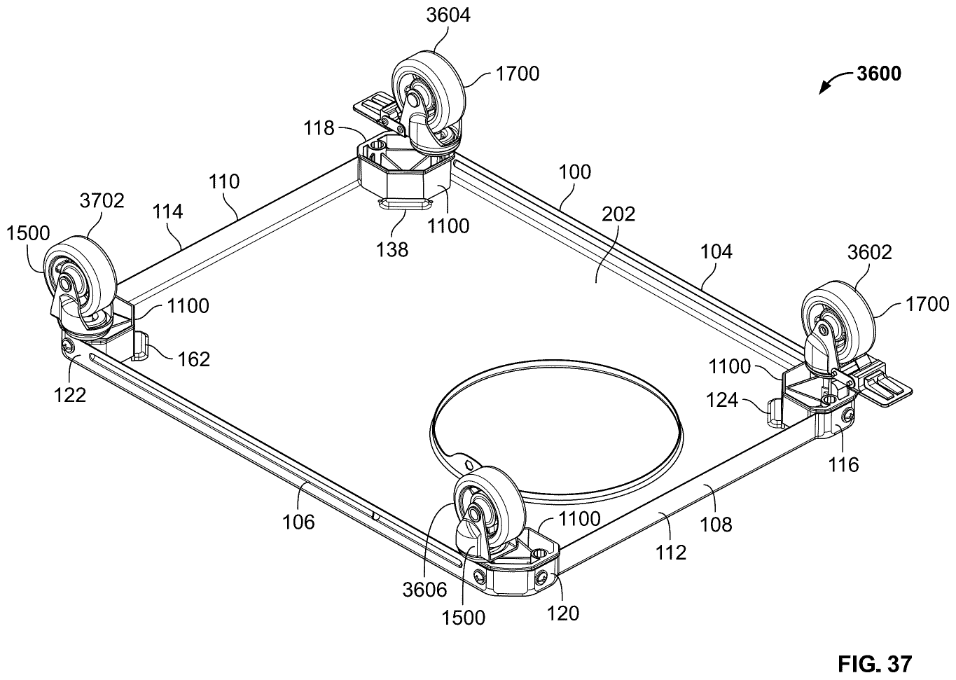

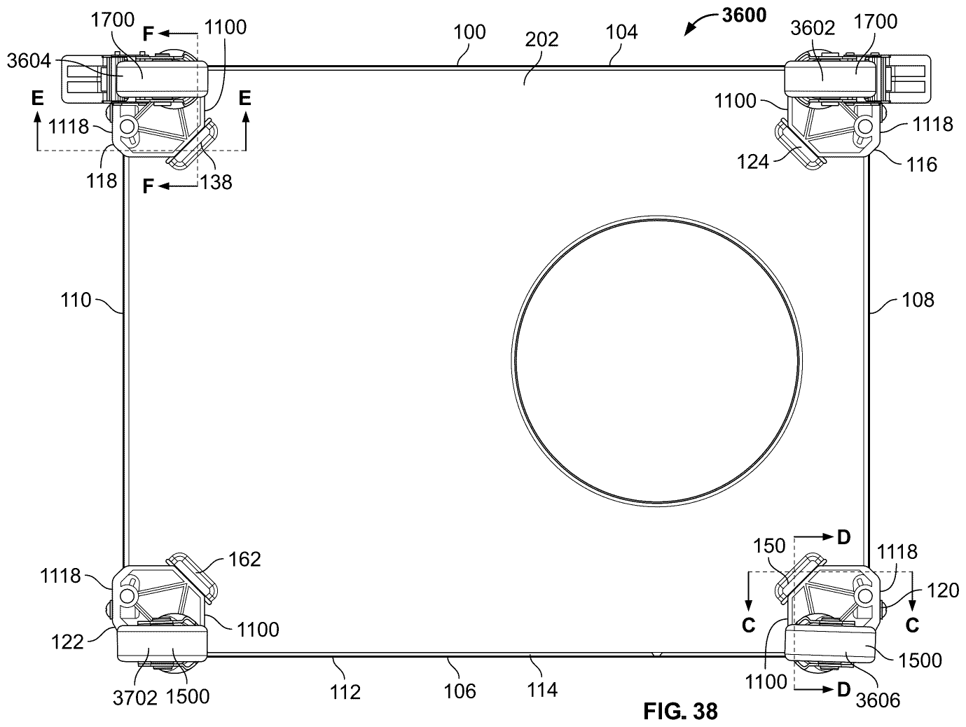

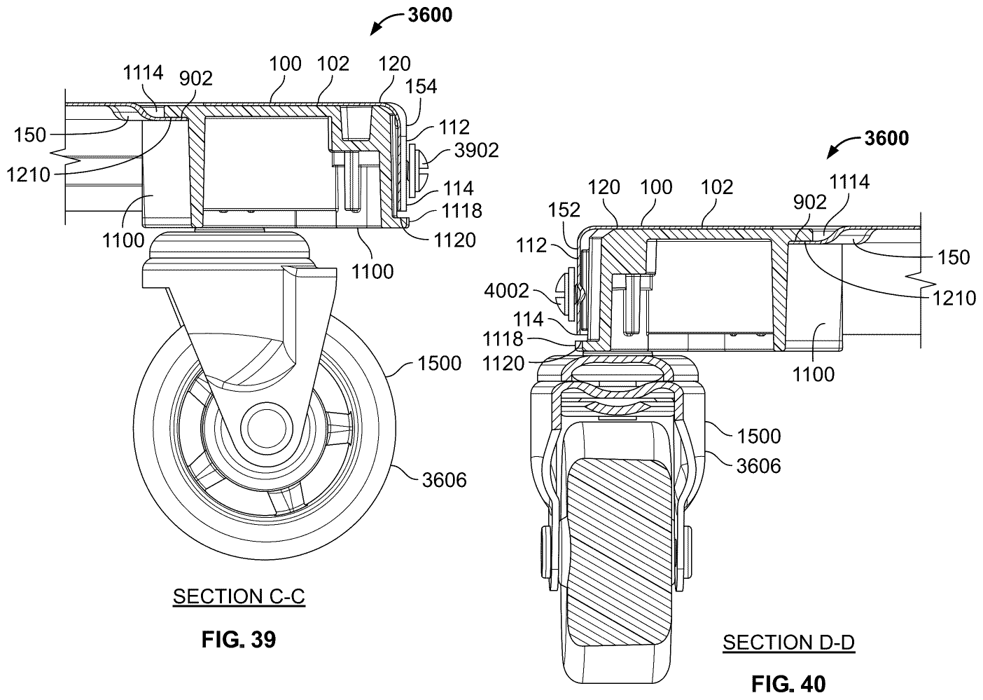

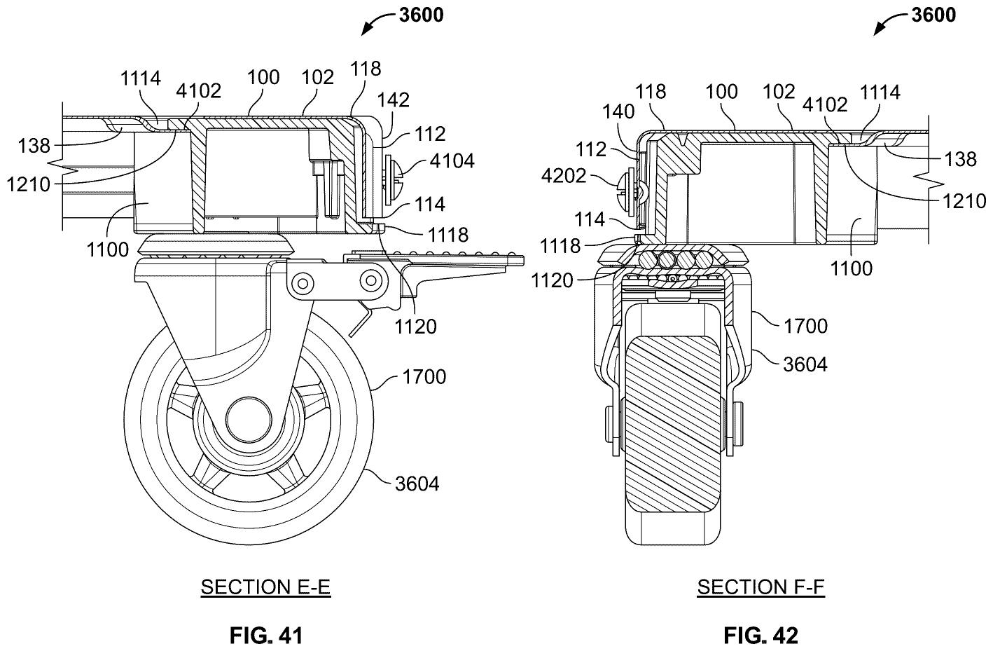

FIG. 36 is a first perspective view of an example first base assembly 3600. FIG. 37 is a second perspective view of the first base assembly 3600 of FIG. 36. FIG. 38 is a bottom view of the first base assembly 3600 of FIGS. 36 and 37. FIG. 39 is a cross-sectional view of the first base assembly 3600 of FIGS. 36-38, taken along section C-C of FIG. 38. FIG. 40 is a cross-sectional view of the first base assembly 3600 of FIGS. 36-39, taken along section D-D of FIG. 38. FIG. 41 is a cross-sectional view of the first base assembly 3600 of FIGS. 36-40, taken along section E-E of FIG. 38. FIG. 42 is a cross-sectional view of the first base assembly 3600 of FIGS. 36-41, taken along section F-F of FIG. 38. In the illustrated example of FIGS. 36-42, the first base assembly 3600 includes the base 100 of FIGS. 1-10, an example first instance 3602 of the second caster assembly 1700 of FIGS. 17 and 18 coupled to the first corner 116 of the base 100, an example second instance 3604 of the second caster assembly 1700 of FIGS. 17 and 18 coupled to the second corner 118 of the base 100, an example first instance 3606 of the first caster assembly 1500 of FIGS. 15 and 16 coupled to the third corner 120 of the base 100, and an example second instance 3702 of the first caster assembly 1500 of FIGS. 15 and 16 coupled to the fourth corner 122 of the base 100.

In other examples, the first base assembly 3600 of FIGS. 36-42 can instead include a different arrangement of the same components. For example, the first instance 3602 and the second instance 3604 of the second caster assembly 1700 can instead be respectively coupled to the third corner 120 and the fourth corner 122 of the base 100, and the first instance 3606 and the second instance 3702 of the first caster assembly 1500 can instead be respectively coupled to the first corner 116 and the second corner 118 of the base 100. As another example, the first instance 3602 and the second instance 3604 of the second caster assembly 1700 can instead be respectively coupled to the first corner 116 and the third corner 120 of the base 100, and the first instance 3606 and the second instance 3702 of the first caster assembly 1500 can instead be respectively coupled to the second corner 118 and the fourth corner 122 of the base 100. As yet another example, the first instance 3602 and the second instance 3604 of the second caster assembly 1700 can instead be respectively coupled to the second corner 118 and the fourth corner 122 of the base 100, and the first instance 3606 and the second instance 3702 of the first caster assembly 1500 can instead be respectively coupled to the first corner 116 and the third corner 120 of the base 100.

In still other examples, the first base assembly 3600 of FIGS. 36-42 can instead include different numbers of the same components. For example, the first base assembly 3600 can instead include four instances of the first caster assembly 1500 of FIGS. 15 and 16 coupled to respective ones of the four corners (e.g., the first corner 116, the second corner 118, the third corner 120, and the fourth corner 122) of the base 100, and no instances of the second caster assembly 1700 of FIGS. 17 and 18. As another example, the first base assembly 3600 can instead include four instances of the second caster assembly 1700 of FIGS. 17 and 18 coupled to respective ones of the four corners (e.g., the first corner 116, the second corner 118, the third corner 120, and the fourth corner 122) of the base 100, and no instances of the first caster assembly 1500 of FIGS. 15 and 16.

In still other examples, the first base assembly 3600 of FIGS. 36-42 can instead include different components relative to one or more of the components shown in FIGS. 36-42. For example, the first base assembly 3600 can instead include one or more instances of the support foot 1900 of FIGS. 19-22 coupled to a corresponding one or more of the four corners (e.g., the first corner 116, the second corner 118, the third corner 120, and the fourth corner 122) of the base 100 in place of a corresponding one or more of the above-described first instance 3602 and second instance 3604 of the second caster assembly 1700 and/or the above-described first instance 3606 and second instance 3702 of the first caster assembly 1500. As another example, the first base assembly 3600 can instead include an instance of the wheel assembly 3100 of FIGS. 31-34 coupled to a two of the four corners (e.g., either the first corner 116 and the third corner 120, or the second corner 118 and the fourth corner 122) of the base 100 in place of the first instance 3602 of the second caster assembly 1700 and the first instance 3606 of the first caster assembly 1500, or in place of the second instance 3604 of the second caster assembly 1700 and the second instance 3702 of the first caster assembly 1500.

The first base assembly 3600 of FIGS. 36-42 is formed and/or assembled by coupling the first instance 3602 of the second caster assembly 1700 to the first corner 116 of the base 100, coupling the second instance 3604 of the second caster assembly 1700 to the second corner 118 of the base 100, coupling the first instance 3606 of the first caster assembly 1500 to the third corner 120 of the base 100, and coupling the second instance 3702 of the first caster assembly 1500 to the fourth corner 122 of the base 100. The coupling of each caster assembly to its corresponding corner is accomplished by inserting the tongue of the base attachment of each caster assembly into the groove of the corresponding corner, and then inserting first and second fasteners through the corresponding first and second peripheral openings of the peripheral edge of the corner and into the corresponding first and second peripheral openings of the corresponding first and second faces of the base attachment of each caster assembly, as further described above.

FIGS. 39 and 40 further illustrate the first instance 3606 of the first caster assembly 1500 of the first base assembly 3600 coupled to the third corner 120 of the base 100 of the first base assembly 3600. As shown in FIGS. 39 and 40, the tongue 1114 of the base attachment 1100 of the first instance 3606 of the first caster assembly 1500 is located within the groove 150 of the third corner 120, with the lower surface 1210 of the tongue 1114 facing toward, abutting, and/or engaging the depressed upper surface 902 of the groove 150. An example first fastener 3902 (e.g., a first screw) extends through the first peripheral opening 160 of the peripheral edge 112 of the third corner 120 and into the first peripheral opening 1122 of the base attachment 1100 of the first instance 3606 of the first caster assembly 1500. An example second fastener 4002 (e.g., a second screw) extends through the second peripheral opening 206 of the peripheral edge 112 of the third corner 120 and into the second peripheral opening 1124 of the base attachment 1100 of the first instance 3606 of the first caster assembly 1500.

FIGS. 41 and 42 further illustrate the second instance 3604 of the second caster assembly 1700 of the first base assembly 3600 coupled to the second corner 118 of the base 100 of the first base assembly 3600. As shown in FIGS. 41 and 42, the tongue 1114 of the base attachment 1100 of second instance 3604 of the second caster assembly 1700 is located within the groove 138 of the second corner 118, with the lower surface 1210 of the tongue 1114 facing toward, abutting, and/or engaging an example depressed upper surface 4102 of the groove 138. An example first fastener 4104 (e.g., a first screw) extends through the first peripheral opening 204 of the peripheral edge 112 of the second corner 118 and into the first peripheral opening 1122 of the base attachment 1100 of the second instance 3604 of the second caster assembly 1700. An example second fastener 4202 (e.g., a second screw) extends through the second peripheral opening 148 of the peripheral edge 112 of the second corner 118 and into the second peripheral opening 1124 of the base attachment 1100 of the second instance 3604 of the second caster assembly 1700.

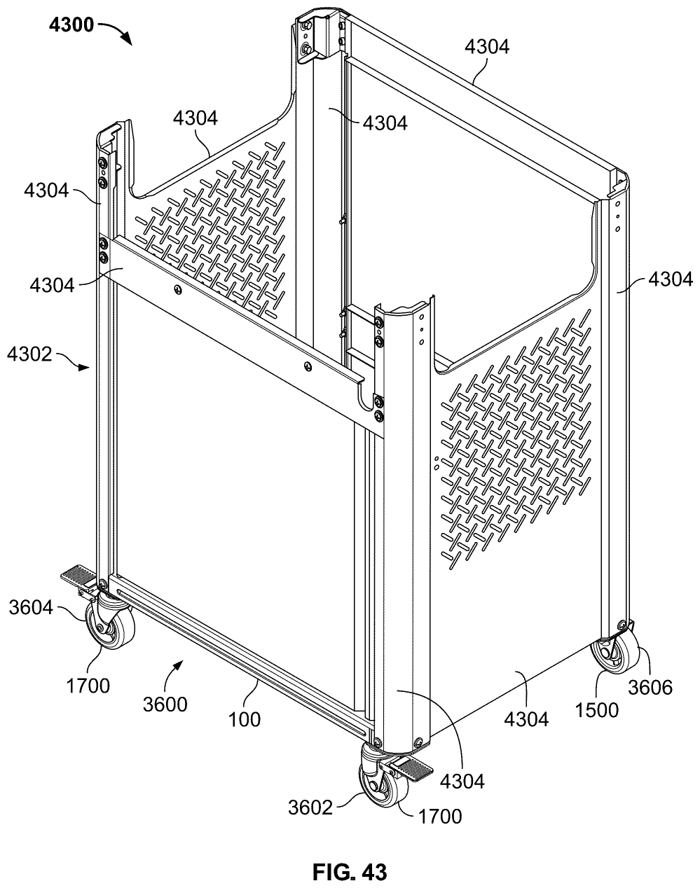

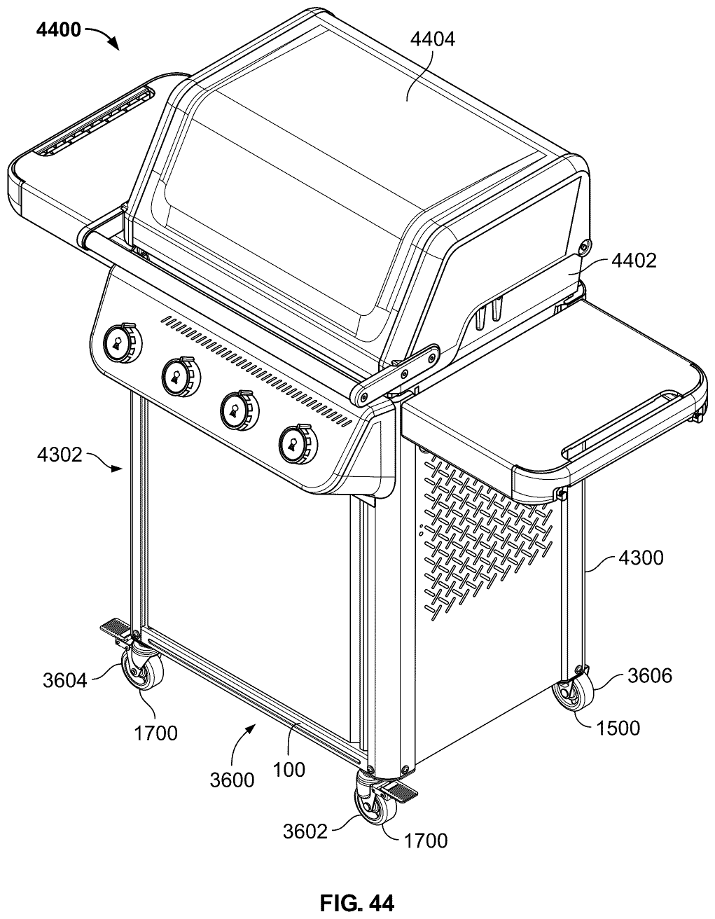

FIG. 43 is a perspective view of an example cart 4300 including the first base assembly 3600 of FIGS. 36-42. The cart 4300 of FIG. 43 includes an example frame 4302 coupled to and extending upward from the base 100 of the first base assembly 3600. In the illustrated example of FIG. 43, the frame 4302 includes one or more example support member(s) 4304 (e.g., one or more panel(s), bar(s), rod(s), post(s), leg(s), etc.) configured to support a cookbox of a grill. FIG. 44 is a perspective view of an example grill 4400 including the cart 4300 of FIG. 43. In the illustrated example of FIG. 44, the grill 4400 includes an example cookbox 4402 and an example lid 4404. The cookbox 4402 is coupled to and/or otherwise supported by one or more of the support member(s) 4304 of the cart 4300. The lid 4404 is pivotally coupled to the cookbox 4402 such that the lid is movable between a closed position (e.g., a lowered position) that generally prevents access to a cooking chamber of the grill 4400, and an open position (e.g., a raised position) that generally enables access to the cooking chamber of the grill 4400. As shown in FIG. 44, the grill 4400 is a gas grill including one or more burner tube(s) configured to generate heat (e.g., in response to a combustion of gas passing through the burner tube(s)) within the cooking chamber of the grill 4400. In other examples, the grill 4400 can instead be configured as a different type of grill including a different type of heat-generating component (e.g., a pellet grill including a burn pot configured to combust wood pellets, an electric grill including one or more electric heating element(s) configured to generate heat in response to electrical current supplied to the electric heating element(s), a charcoal grill including a fuel grate configured to support combustible charcoal, etc.).

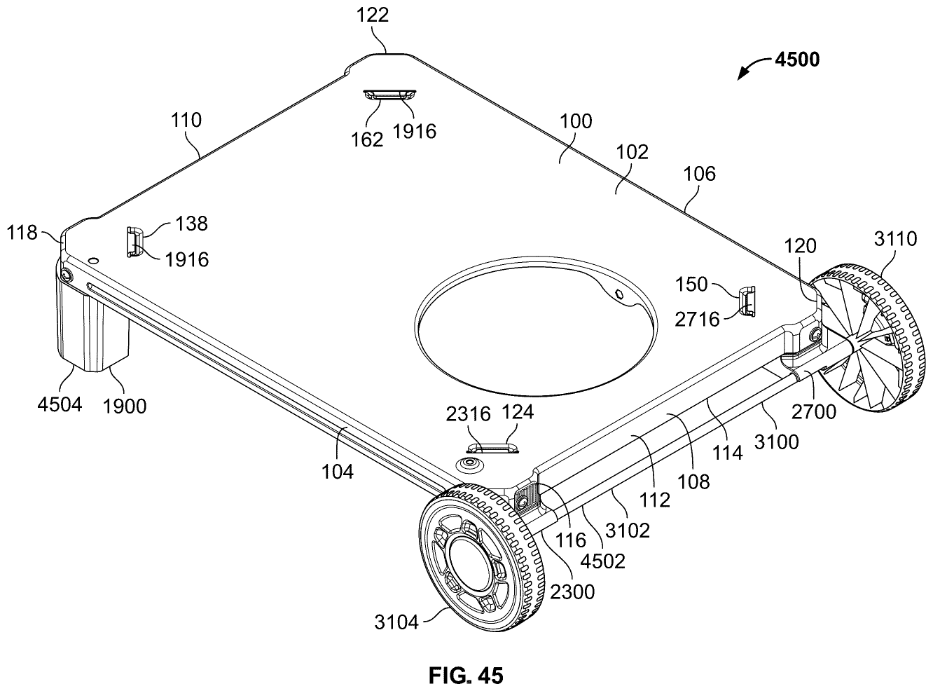

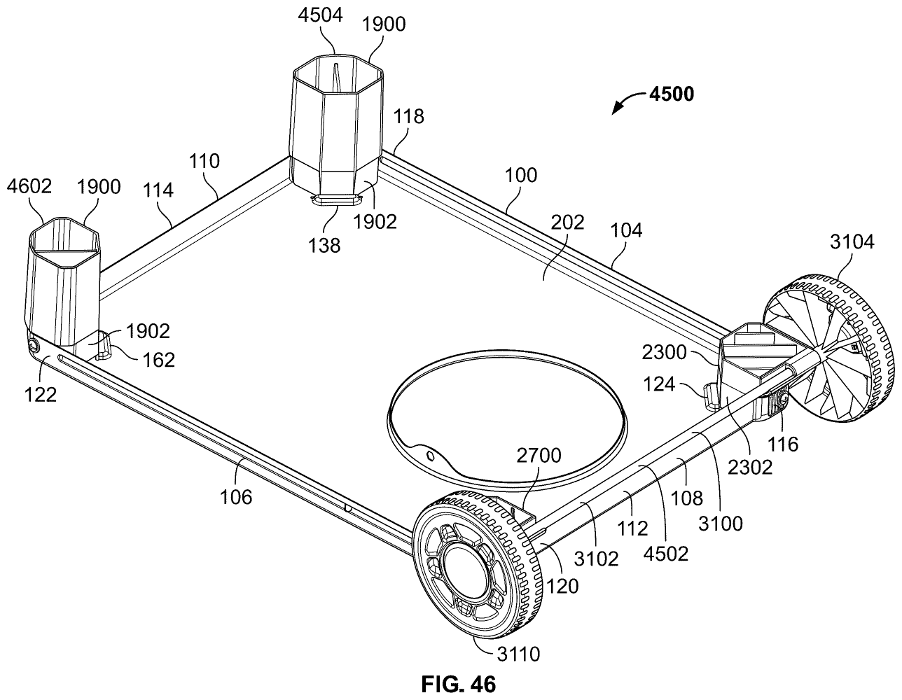

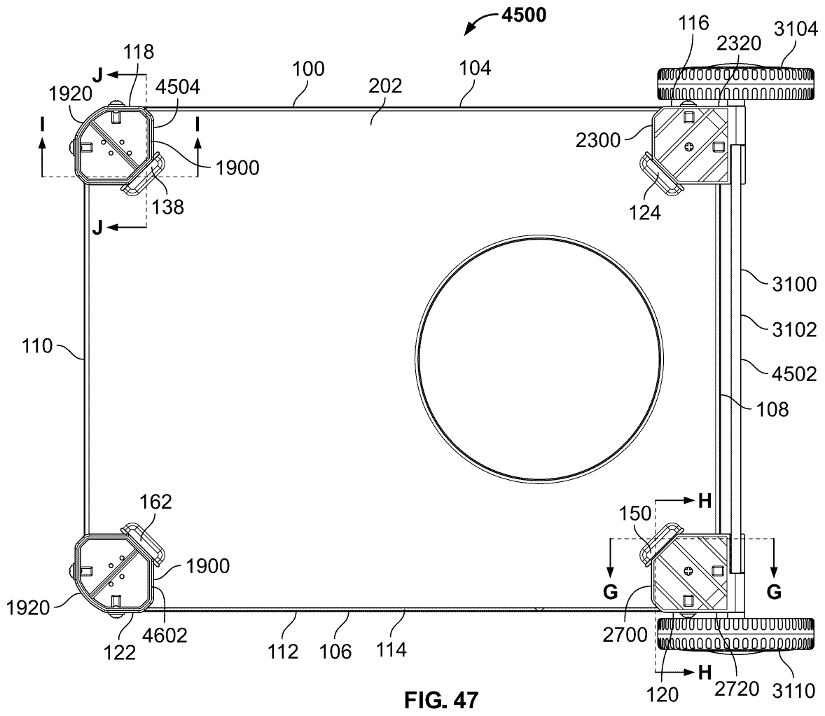

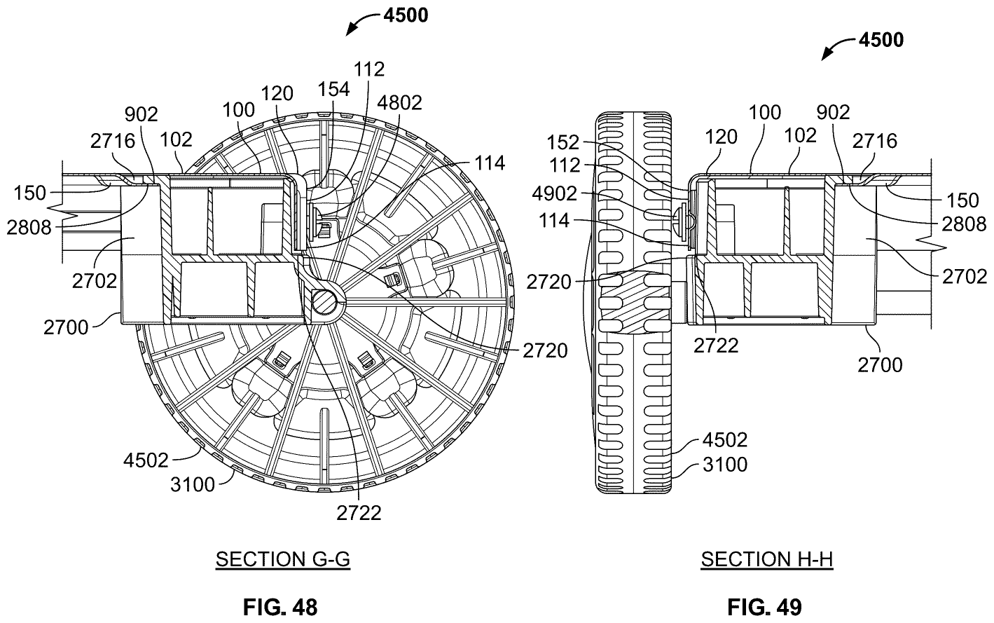

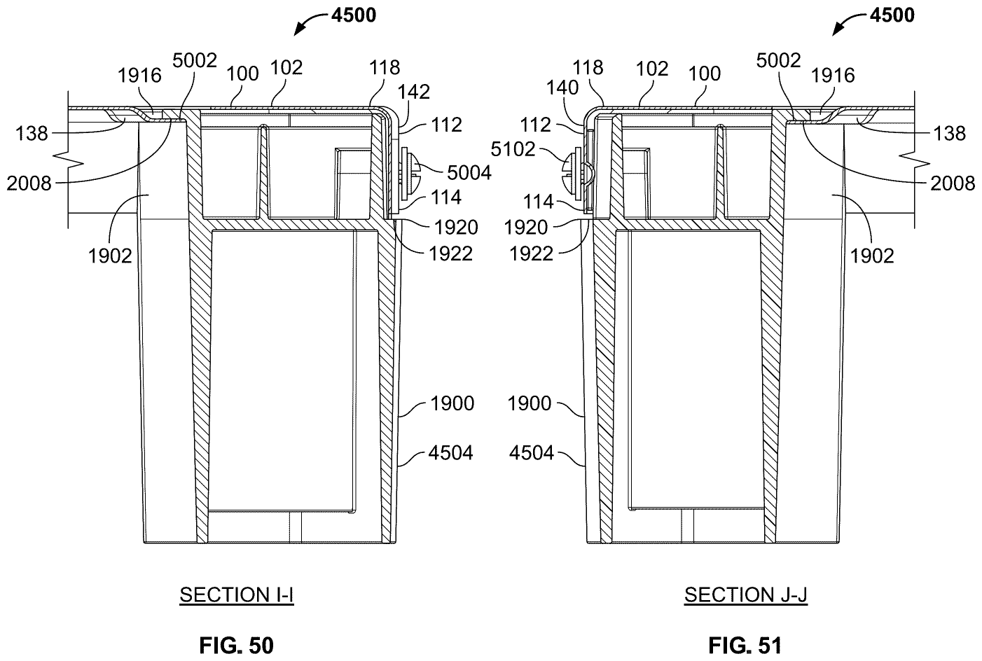

FIG. 45 is a first perspective view of an example second base assembly 4500. FIG. 46 is a second perspective view of the second base assembly 4500 of FIG. 45. FIG. 47 is a bottom view of the second base assembly 4500 of FIGS. 45 and 46. FIG. 48 is a cross-sectional view of the second base assembly 4500 of FIGS. 45-47, taken along section G-G of FIG. 47. FIG. 49 is a cross-sectional view of the second base assembly 4500 of FIGS. 45-48, taken along section H-H of FIG. 47. FIG. 50 is a cross-sectional view of the second base assembly 4500 of FIGS. 45-49, taken along section I-I of FIG. 47. FIG. 51 is a cross-sectional view of the second base assembly 4500 of FIGS. 45-50, taken along section J-J of FIG. 47. In the illustrated example of FIGS. 45-51, the second base assembly 4500 includes the base 100 of FIGS. 1-10, an example instance 4502 of the wheel assembly 3100 of FIGS. 31-34 coupled to the first corner 116 and the third corner 120 of the base 100, an example first instance 4504 of the support foot 1900 of FIGS. 19-22 coupled to the second corner 118 of the base 100, and an example second instance 4602 of the support foot 1900 of FIGS. 19-22 coupled to the fourth corner 122 of the base 100.

In other examples, the second base assembly 4500 of FIGS. 45-51 can instead include a different arrangement of the same components. For example, the instance 4502 of the wheel assembly 3100 can instead be coupled to the second corner 118 and the fourth corner 122 of the base 100, and the first instance 4504 and the second instance 4602 of the support foot 1900 can instead be respectively coupled to the first corner 116 and the third corner 120 of the base 100. In still other examples, the second base assembly 4500 of FIGS. 45-51 can instead include different numbers of the same components. For example, the second base assembly 4500 can instead include two instances of the wheel assembly 3100 of FIGS. 31-34 coupled to respective ones of the four corners (e.g., the first corner 116, the second corner 118, the third corner 120, and the fourth corner 122) of the base 100, and no instances of the support foot 1900 of FIGS. 19-22. As another example, the second base assembly 4500 can instead include four instances of the support foot 1900 of FIGS. 19-22 coupled to respective ones of the four corners (e.g., the first corner 116, the second corner 118, the third corner 120, and the fourth corner 122) of the base 100, and no instances of the wheel assembly 3100 of FIGS. 31-34.

In still other examples, the second base assembly 4500 of FIGS. 45-51 can instead include different components relative to one or more of the components shown in FIGS. 45-51. For example, the second base assembly 4500 can instead include two instances of either the first caster assembly 1500 of FIGS. 15 and 16 or the second caster assembly 1700 of FIGS. 17 and 18 coupled to a corresponding two of the four corners (e.g., the first corner 116 and the third corner 120) of the base 100 in place of the above-described instance 4502 of the wheel assembly 3100. As another example, the second base assembly 4500 can instead include two instances of either the first caster assembly 1500 of FIGS. 15 and 16 or the second caster assembly 1700 of FIGS. 17 and 18 coupled to a corresponding two of the four corners (e.g., the second corner 118 and the fourth corner 122) of the base 100 in place of the above-described first instance 4504 and second instance 4602 of the support foot 1900.

The second base assembly 4500 of FIGS. 45-51 is formed and/or assembled by coupling the first axle mount 2300 of the instance 4502 of the wheel assembly 3100 to the first corner 116 of the base 100, coupling the second axle mount 2700 of the instance 4502 of the wheel assembly 3100 to the third corner 120 of the base 100, coupling the first instance 4504 of the support foot 1900 to the second corner 118 of the base 100, and coupling the second instance 4602 of the support foot 1900 to the fourth corner 122 of the base 100. The coupling of each axle mount and/or each support foot to its corresponding corner is accomplished by inserting the tongue of the base attachment of each axle mount and/or each support foot into the groove of the corresponding corner, and then inserting first and second fasteners through the corresponding first and second peripheral openings of the peripheral edge of the corner and into the corresponding first and second peripheral openings of the corresponding first and second faces of the base attachment of each axle mount and/or each support foot, as further described above.

FIGS. 48 and 49 further illustrate the second axle mount 2700 of the instance 4502 of the wheel assembly 3100 of the second base assembly 4500 coupled to the third corner 120 of the base 100 of the second base assembly 4500. As shown in FIGS. 48 and 49, the tongue 2716 of the base attachment 2702 of the second axle mount 2700 of the instance 4502 of the wheel assembly 3100 is located within the groove 150 of the third corner 120, with the lower surface 2808 of the tongue 2716 facing toward, abutting, and/or engaging the depressed upper surface 902 of the groove 150. An example first fastener 4802 (e.g., a first screw) extends through the first peripheral opening 160 of the peripheral edge 112 of the third corner 120 and into the first peripheral opening 2724 of the base attachment 2702 of the second axle mount 2700 of the instance 4502 of the wheel assembly 3100. An example second fastener 4902 (e.g., a second screw) extends through the second peripheral opening 206 of the peripheral edge 112 of the third corner 120 and into the second peripheral opening 2726 of the base attachment 2702 of the instance 4502 of the wheel assembly 3100.

FIGS. 50 and 51 further illustrate the first instance 4504 of the support foot 1900 of the second base assembly 4500 coupled to the second corner 118 of the base 100 of the second base assembly 4500. As shown in FIGS. 50 and 51, the tongue 1916 of the base attachment 1902 of the first instance 4504 of the support foot 1900 is located within the groove 138 of the second corner 118, with the lower surface 2008 of the tongue 1916 facing toward, abutting, and/or engaging an example depressed upper surface 5002 of the groove 138. An example first fastener 5004 (e.g., a first screw) extends through the first peripheral opening 204 of the peripheral edge 112 of the second corner 118 and into the first peripheral opening 1924 of the base attachment 1902 of the first instance 4504 of the support foot 1900. An example second fastener 5102 (e.g., a second screw) extends through the second peripheral opening 148 of the peripheral edge 112 of the second corner 118 and into the second peripheral opening 1926 of the base attachment 1902 of the first instance 4504 of the support foot 1900.

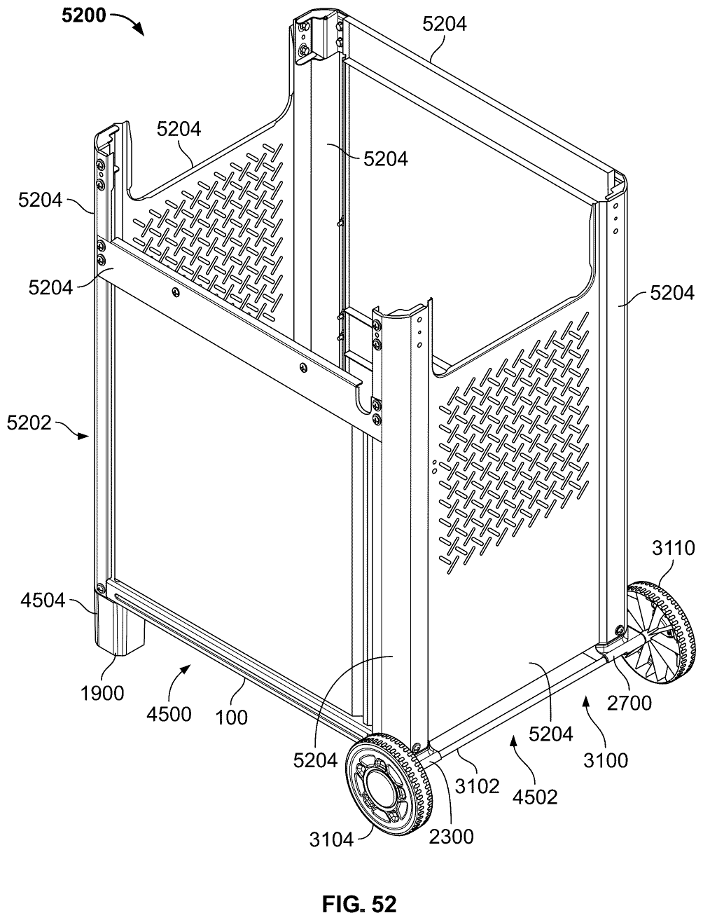

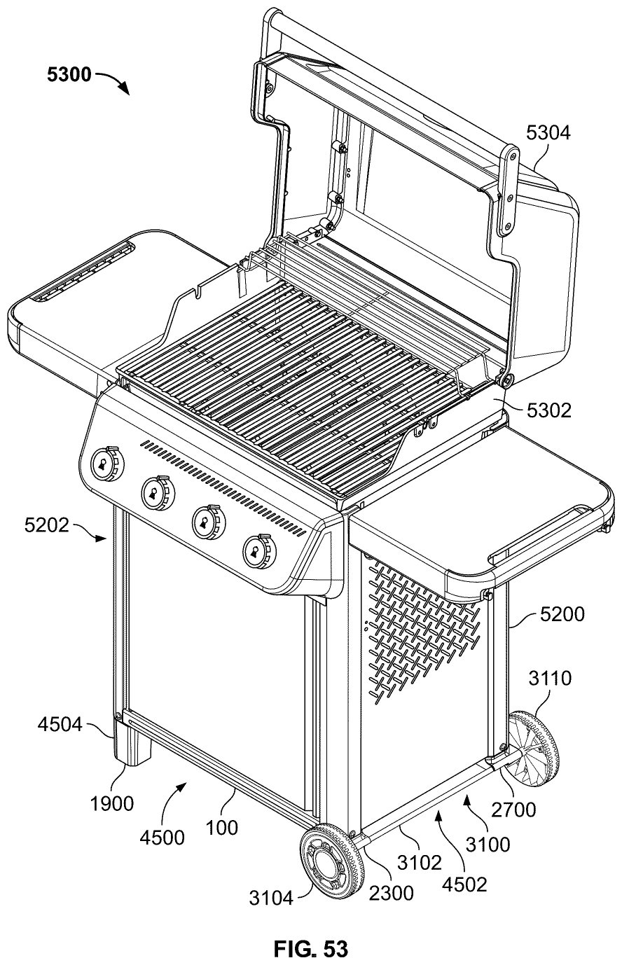

FIG. 52 is a perspective view of an example cart 5200 including the second base assembly 4500 of FIGS. 45-51. The cart 5200 of FIG. 52 includes an example frame 5202 coupled to and extending upward from the base 100 of the second base assembly 4500. In the illustrated example of FIG. 52, the frame 5202 includes one or more example support member(s) 5204 (e.g., one or more panel(s), bar(s), rod(s), post(s), leg(s), etc.) configured to support a cookbox of a grill. FIG. 53 is a perspective view of an example grill 5300 including the cart 5200 of FIG. 52. In the illustrated example of FIG. 53, the grill 5300 includes an example cookbox 5302 and an example lid 5304. The cookbox 5302 is coupled to and/or otherwise supported by one or more of the support member(s) 5204 of the cart 5200. The lid 5304 is pivotally coupled to the cookbox 5302 such that the lid is movable between a closed position (e.g., a lowered position) that generally prevents access to a cooking chamber of the grill 5300, and an open position (e.g., a raised position) that generally enables access to the cooking chamber of the grill 5300. As shown in FIG. 53, the grill 5300 is a gas grill including one or more burner tube(s) configured to generate heat (e.g., in response to a combustion of gas passing through the burner tube(s)) within the cooking chamber of the grill 5300. In other examples, the grill 5300 can instead be configured as a different type of grill including a different type of heat-generating component (e.g., a pellet grill including a burn pot configured to combust wood pellets, an electric grill including one or more electric heating element(s) configured to generate heat in response to electrical current supplied to the electric heating element(s), a charcoal grill including a fuel grate configured to support combustible charcoal, etc.).

The following paragraphs provide various examples in relation to the disclosed grill carts including modular base assemblies.

Example 1 includes a base assembly for a cart of a grill. In Example 1, the base assembly comprises a base and a base attachment. The base includes a groove. The base attachment is removably couplable to the base. The base attachment includes a tongue configured to be located within the groove of the base when the base attachment is coupled to the base.

Example 2 includes the base assembly of Example 1. In Example 2, the groove extends through an upper surface of the base. The groove includes a depressed upper surface that is lowered relative to the upper surface of the base. The tongue includes a lower surface configured to be supported by the depressed upper surface of the groove when the base attachment is coupled to the base.

Example 3 includes the base assembly of Example 1. In Example 3, the base attachment has an octagonal shape defined by eight faces of the base attachment. The tongue projects outwardly from at least one of the eight faces of the base attachment.

Example 4 includes the base assembly of Example 3. In Example 4, the base attachment further includes a lip. The lip projects outwardly from at least one of the eight faces of the base attachment. The lip includes an upper surface configured to face toward a lower rim of a peripheral edge of the base when the base attachment is coupled to the base.

Example 5 includes the base assembly of Example 1. In Example 5, the groove is associated with a corner of the base. The groove is spaced inwardly from a peripheral edge of the corner. The corner includes a first peripheral opening and a second peripheral opening extending through the peripheral edge of the corner. The base attachment includes a first peripheral opening and a second peripheral opening formed in corresponding ones of a first face and a second face of the base attachment. The second face is perpendicular to the first face. In Example 5, the base assembly further includes a first fastener and a second fastener. The first fastener is configured to be inserted through the first peripheral opening of the corner and into the first peripheral opening of the base attachment. The second fastener is configured to be inserted through the second peripheral opening of the corner and into the second peripheral opening of the base attachment.

Example 6 includes the base assembly of Example 1. In Example 6, the base attachment is part of a caster assembly that includes a caster.

Example 7 includes the base assembly of Example 1. In Example 7, the base attachment is part of a wheel assembly that includes an all-terrain wheel.

Example 8 includes the base assembly of Example 1. In Example 8, the base attachment is part of a support foot.

Example 9 includes a base assembly for a cart of a grill. In Example 9, the base assembly comprises a base, a first base attachment, and a second base attachment. The base includes a groove. The first base attachment is removably couplable to the base. The first base attachment includes a first tongue configured to be located within the groove of the base when the first base attachment is coupled to the base. The second base attachment is removably couplable to the base. The second base attachment includes a second tongue configured to be located within the groove of the base when the second base attachment is coupled to the base. In Example 9, the first base attachment and the second base attachment are interchangeably removably couplable to the base.

Example 10 includes the base assembly of Example 9. In Example 10, the groove extends through an upper surface of the base. The groove includes a depressed upper surface that is lowered relative to the upper surface of the base. The first tongue includes a first lower surface configured to be supported by the depressed upper surface of the groove when the first base attachment is coupled to the base. The second tongue includes a second lower surface configured to be supported by the depressed upper surface of the groove when the second base attachment is coupled to the base.

Example 11 includes the base assembly of Example 9. In Example 11, the first base attachment has a first octagonal shape defined by eight faces of the first base attachment. The first tongue projects outwardly from at least one of the eight faces of the first base attachment. The second base attachment has a second octagonal shape defined by eight faces of the second base attachment. The second tongue projects outwardly from at least one of the eight faces of the second base attachment. In Example 11, the second octagonal shape is substantially identical to the first octagonal shape.

Example 12 includes the base assembly of Example 11. In Example 12, the first base attachment further includes a first lip. The first lip projects outwardly from at least one of the eight faces of the first base attachment. The first lip includes an upper surface configured to face toward a lower rim of a peripheral edge of the base when the first base attachment is coupled to the base. The second base attachment further includes a second lip. The second lip projects outwardly from at least one of the eight faces of the second base attachment. The second lip includes an upper surface configured to face toward the lower rim of the peripheral edge of the base when the second base attachment is coupled to the base.

Example 13 includes the base assembly of Example 9. In Example 13, the first base attachment is part of a first caster assembly that includes a non-locking caster, and the second base attachment is part of a second caster assembly that includes a locking caster. The locking caster includes a brake configured to lock a wheel of the locking caster.

Example 14 includes the base assembly of Example 9. In Example 14, the first base attachment is part of a wheel assembly that includes an all-terrain wheel, and the second base attachment is part of a support foot.

Example 15 includes the base assembly of Example 9. In Example 15, the first base attachment is part of a caster assembly, and the second base attachment is part of a support foot.

Example 16 includes the base assembly of Example 9. In Example 16, the first base attachment is part of a caster assembly, and the second base attachment is part of a wheel assembly that includes an all-terrain wheel.

Example 17 includes a base assembly for a cart of a grill. In Example 17, the base assembly comprises a base, a first base attachment, and a second base attachment. The base includes a first groove and a second groove. The second groove is spaced apart from the first groove. The first base attachment is removably couplable to the base. The first base attachment includes a first tongue configured to be interchangeably located within either the first groove or the second groove of the base when the first base attachment is coupled to the base. The second base attachment is removably couplable to the base. The second base attachment includes a second tongue configured to be interchangeably located within either the first groove or the second groove of the base when the second base attachment is coupled to the base. In Example 17, the first base attachment and the second base attachment are interchangeably removably couplable to the base such that (a) the first tongue of the first base attachment is located within the first groove of the base and the second tongue of the second base attachment is located within the second groove of the base when the first base attachment and the second base attachment are both coupled to the base in a first configuration, and (b) the first tongue of the first base attachment is located within the second groove of the base and the second tongue of the second base attachment is located within the first groove of the base when the first base attachment and the second base attachment are both coupled to the base in a second configuration.

Example 18 includes the base assembly of Example 17. In Example 18, the first groove and the second groove each extend through an upper surface of the base. The first groove and the second groove each include a depressed upper surface that is lowered relative to the upper surface of the base. The first tongue includes a first lower surface configured to be supported by the depressed upper surface of the first groove when the first base attachment is coupled to the base in the first configuration, and to be supported by the depressed upper surface of the second groove when the first base attachment is coupled to the base in the second configuration. The second tongue includes a second lower surface configured to be supported by the depressed upper surface of the second groove when the second base attachment is coupled to the base in the first configuration, and to be supported by the depressed upper surface of the first groove when the second base attachment is coupled to the base in the second configuration.

Example 19 includes the base assembly of Example 17. In Example 19, the first base attachment has a first octagonal shape defined by eight faces of the first base attachment. The first tongue projects outwardly from at least one of the eight faces of the first base attachment. The second base attachment has a second octagonal shape defined by eight faces of the second base attachment. The second tongue projects outwardly from at least one of the eight faces of the second base attachment. The second octagonal shape is substantially identical to the first octagonal shape.

Example 20 includes the base assembly of Example 19. In Example 20, the first base attachment further includes a first lip. The first lip projects outwardly from at least one of the eight faces of the first base attachment. The first lip includes an upper surface configured to face toward a lower rim of a peripheral edge of the base when the first base attachment is coupled to the base. The second base attachment further includes a second lip. The second lip projects outwardly from at least one of the eight faces of the second base attachment. The second lip includes an upper surface configured to face toward the lower rim of the peripheral edge of the base when the second base attachment is coupled to the base.

Example 21 includes the base assembly of Example 17. In Example 21, the first base attachment is part of a first caster assembly that includes a non-locking caster, and the second base attachment is part of a second caster assembly that includes a locking caster. The locking caster includes a brake configured to lock a wheel of the locking caster.

Example 22 includes the base assembly of Example 17. In Example 22, the first base attachment is part of a wheel assembly that includes an all-terrain wheel, and the second base attachment is part of a support foot.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A base assembly for a cart of a grill, the base assembly comprising:
a base including a groove; and
a base attachment removably couplable to the base, the base attachment including a tongue configured to be located within the groove of the base when the base attachment is coupled to the base.

2. The base assembly of claim 1, wherein the groove extends through an upper surface of the base, the groove including a depressed upper surface that is lowered relative to the upper surface of the base, the tongue including a lower surface configured to be supported by the depressed upper surface of the groove when the base attachment is coupled to the base.

3. The base assembly of claim 1, wherein the base attachment has an octagonal shape defined by eight faces of the base attachment, wherein the tongue projects outwardly from at least one of the eight faces of the base attachment.

4. The base assembly of claim 3, wherein the base attachment further includes a lip, the lip projecting outwardly from at least one of the eight faces of the base attachment, the lip including an upper surface configured to face toward a lower rim of a peripheral edge of the base when the base attachment is coupled to the base.

5. The base assembly of claim 1, wherein the groove is associated with a corner of the base, the groove spaced inwardly from a peripheral edge of the corner, the corner including a first peripheral opening and a second peripheral opening extending through the peripheral edge of the corner, the base attachment including a first peripheral opening and a second peripheral opening formed in corresponding ones of a first face and a second face of the base attachment, the second face being perpendicular to the first face, the base assembly further including a first fastener and a second fastener, the first fastener configured to be inserted through the first peripheral opening of the corner and into the first peripheral opening of the base attachment, the second fastener configured to be inserted through the second peripheral opening of the corner and into the second peripheral opening of the base attachment.

6. The base assembly of claim 1, wherein the base attachment is part of a caster assembly that includes a caster.

7. The base assembly of claim 1, wherein the base attachment is part of a wheel assembly that includes an all-terrain wheel.

8. The base assembly of claim 1, wherein the base attachment is part of a support foot.

9. A base assembly for a cart of a grill, the base assembly comprising:
a base including a groove;
a first base attachment removably couplable to the base, the first base attachment including a first tongue configured to be located within the groove of the base when the first base attachment is coupled to the base; and
a second base attachment removably couplable to the base, the second base attachment including a second tongue configured to be located within the groove of the base when the second base attachment is coupled to the base, wherein the first base attachment and the second base attachment are interchangeably removably couplable to the base.

10. The base assembly of claim 9, wherein the groove extends through an upper surface of the base, the groove including a depressed upper surface that is lowered relative to the upper surface of the base, the first tongue including a first lower surface configured to be supported by the depressed upper surface of the groove when the first base attachment is coupled to the base, the second tongue including a second lower surface configured to be supported by the depressed upper surface of the groove when the second base attachment is coupled to the base.

11. The base assembly of claim 9, wherein the first base attachment has a first octagonal shape defined by eight faces of the first base attachment, wherein the first tongue projects outwardly from at least one of the eight faces of the first base attachment, wherein the second base attachment has a second octagonal shape defined by eight faces of the second base attachment, wherein the second tongue projects outwardly from at least one of the eight faces of the second base attachment, wherein the second octagonal shape is substantially identical to the first octagonal shape.

12. The base assembly of claim 11, wherein the first base attachment further includes a first lip, the first lip projecting outwardly from at least one of the eight faces of the first base attachment, the first lip including an upper surface configured to face toward a lower rim of a peripheral edge of the base when the first base attachment is coupled to the base, wherein the second base attachment further includes a second lip, the second lip projecting outwardly from at least one of the eight faces of the second base attachment, the second lip including an upper surface configured to face toward the lower rim of the peripheral edge of the base when the second base attachment is coupled to the base.

13. The base assembly of claim 9, wherein the first base attachment is part of a first caster assembly that includes a non-locking caster, and the second base attachment is part of a second caster assembly that includes a locking caster, the locking caster including a brake configured to lock a wheel of the locking caster.

14. The base assembly of claim 9, wherein the first base attachment is part of a wheel assembly that includes an all-terrain wheel, and the second base attachment is part of a support foot.

15. The base assembly of claim 9, wherein the first base attachment is part of a caster assembly, and the second base attachment is part of a support foot.

16. The base assembly of claim 9, wherein the first base attachment is part of a caster assembly, and the second base attachment is part of a wheel assembly that includes an all-terrain wheel.

17. A base assembly for a cart of a grill, the base assembly comprising:
a base including a first groove and a second groove, the second groove spaced apart from the first groove;
a first base attachment removably couplable to the base, the first base attachment including a first tongue configured to be interchangeably located within either the first groove or the second groove of the base when the first base attachment is coupled to the base; and
a second base attachment removably couplable to the base, the second base attachment including a second tongue configured to be interchangeably located within either the first groove or the second groove of the base when the second base attachment is coupled to the base, wherein the first base attachment and the second base attachment are interchangeably removably couplable to the base such that (a) the first tongue of the first base attachment is located within the first groove of the base and the second tongue of the second base attachment is located within the second groove of the base when the first base attachment and the second base attachment are both coupled to the base in a first configuration, and (b) the first tongue of the first base attachment is located within the second groove of the base and the second tongue of the second base attachment is located within the first groove of the base when the first base attachment and the second base attachment are both coupled to the base in a second configuration.

18. The base assembly of claim 17, wherein the first groove and the second groove each extend through an upper surface of the base, the first groove and the second groove each including a depressed upper surface that is lowered relative to the upper surface of the base, the first tongue including a first lower surface configured to be supported by the depressed upper surface of the first groove when the first base attachment is coupled to the base in the first configuration, and to be supported by the depressed upper surface of the second groove when the first base attachment is coupled to the base in the second configuration, the second tongue including a second lower surface configured to be supported by the depressed upper surface of the second groove when the second base attachment is coupled to the base in the first configuration, and to be supported by the depressed upper surface of the first groove when the second base attachment is coupled to the base in the second configuration.

19. The base assembly of claim 17, wherein the first base attachment has a first octagonal shape defined by eight faces of the first base attachment, wherein the first tongue projects outwardly from at least one of the eight faces of the first base attachment, wherein the second base attachment has a second octagonal shape defined by eight faces of the second base attachment, wherein the second tongue projects outwardly from at least one of the eight faces of the second base attachment, wherein the second octagonal shape is substantially identical to the first octagonal shape.

20. The base assembly of claim 19, wherein the first base attachment further includes a first lip, the first lip projecting outwardly from at least one of the eight faces of the first base attachment, the first lip including an upper surface configured to face toward a lower rim of a peripheral edge of the base when the first base attachment is coupled to the base, wherein the second base attachment further includes a second lip, the second lip projecting outwardly from at least one of the eight faces of the second base attachment, the second lip including an upper surface configured to face toward the lower rim of the peripheral edge of the base when the second base attachment is coupled to the base.

21. The base assembly of claim 17, wherein the first base attachment is part of a first caster assembly that includes a non-locking caster, and the second base attachment is part of a second caster assembly that includes a locking caster, the locking caster including a brake configured to lock a wheel of the locking caster.

22. The base assembly of claim 17, wherein the first base attachment is part of a wheel assembly that includes an all-terrain wheel, and the second base attachment is part of a support foot.
